(19) United States
(12) Patent Application Publication
(10) Pub. No.: US 2010/0172509 A1
(43) Pub. Date: Jul. 8, 2010

(54) Electromagnetically-countered piezo speaker systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 12/318,671

(22) Filed: Jan. 6, 2009

(51) Int. Cl. G10K 11/16

(52) U.S. Cl. 381/71.1

(57) ABSTRACT

The present invention relates to an electromagnetically-countered system including at least one wave source irradiating harmful electromagnetic waves and at least one counter unit emitting counter electromagnetic waves by countering the harmful waves by such counter waves. More particularly, the present invention relates to generic counter units for electromagnetically-countered piezoelectric speaker systems and to various mechanisms for countering the harmful waves by such counter units by, e.g., matching configurations of the counter units with those of the wave sources, matching such counter waves with wavefronts of the harmful waves, and the like. The present invention relates to various methods of countering the harmful waves with the counter waves by such source matching or wave matching and various methods of providing the counter units as well as counter waves. The present invention further relates to various processes for providing such systems, such counter units thereof, and the like. The present invention relates to various electric shields and/or magnetic shields which may be used alone or in conjunction with the counter units to minimize irradiation of the harmful waves from the system.

### CROSS-REFERENCES TO RELATED APPLICATIONS

The present application claims an earlier filing date of the U.S. Utility Patent Application which is entitled “Generic electromagnetically-countered systems and methods,” which was filed on Aug. 28, 2006, and which bears the Ser. No. 11/510,667, an entire portion of which is incorporated herein by reference. The present application also claims an earlier invention date of the Disclosure Document which is entitled the same, which was deposited in the U.S. Patent and Trademark Office (the “Office”) on Jan. 23, 2007 under the Disclosure Document Deposit Program (“DDDP”) of the Office, and which bears the Ser. No. 611,332 an entire portion of which is incorporated herein by reference.

### FIELD OF THE INVENTION

The present invention relates to an electromagnetically-countered system including at least one wave source irradiating harmful electromagnetic waves and at least one counter unit emitting counter electromagnetic waves by countering the harmful waves by such counter waves. More particularly, the present invention relates to generic counter units for electromagnetically-countered piezoelectric speaker systems and to various mechanisms for countering the harmful waves by such counter units by, e.g., matching configurations of the counter units with those of the wave sources, matching such counter waves with wavefronts of the harmful waves, and the like. The present invention relates to various methods of countering the harmful waves with the counter waves by such source matching or wave matching and various methods of providing the counter units as well as counter waves. The present invention further relates to various processes for providing such systems, such counter units thereof, and the like. The present invention relates to various electric shields and/or magnetic shields which may be used alone or in conjunction with the counter units to minimize irradiation of the harmful waves from the system.

### BACKGROUND OF THE INVENTION

It is now well established in the scientific community that electromagnetic waves with varying frequencies irradiated by various devices may be hazardous to human health. In some cases, such electromagnetic waves in mega- and giga-hertz range may be the main culprit, whereas the 60-hertz electromagnetic waves may be the main health concern in other cases. It cannot be too emphasized that it is very difficult to shield against magnetic waves of the 60-hertz electromagnetic waves which have wavelengths amounting to thousands of kilometers and that such 60-hertz magnetic waves are omnipresent in any corner of the current civilization.

However, intensity of such electromagnetic waves typically decreases inversely proportional to a square of a distance from a source of such waves to a target. Accordingly, potentially adverse effects from such electromagnetic waves may be minimized by maintaining a safe distance from such a source. Some electrical devices, however, are intended to be used in a close proximity to an user, where typical examples of such devices are hair dryers, hair curlers, electric mattresses or blankets, heating pads, earphones, headphones, mobile phones, razors, toothbrushes, and the like. However, all prior art devices have failed to provide remedies to such potential hazards. For example, various prior art electric blankets and mattresses and their shortcomings have been provided in the U.S. Utility Patent Application of this Applicant which is entitled “Electromagnetically-Shielded Air Heating Systems and Methods” and bears the Serial Number U.S. Ser. No. 11/313,921, and various radiative heaters and the shortcomings have been summarized in another U.S. Utility Patent Application of this Applicant which is entitled “Electromagnetically-Shielded Radiative Heating Systems and Methods” and bears the Serial Number U.S. Ser. No. 11/403,899.

Conventional speakers operate with electric currents of amplitudes lot less than those flowing in the above devices. However, some speakers included in earphones, headphones, cellular phones, and handsets of regular phones are to be disposed close to an ear of an user. Accordingly, although these speakers may irradiate the electromagnetic waves having less amplitudes, these speakers tend to irradiate such waves directly to brain cells in a close proximity thereto. In particular, the earphones are to be disposed into an ear canal of the ear so that the electromagnetic waves irradiated therefrom may reach brain cells at a less distance and, therefore, with greater strengths. It is appreciated that the irradiation of such undesirable waves may not be prevented by operating such speakers on a DC current, for such speakers generate the sounds through fluctuating electric currents which inevitably irradiate such electromagnetic waves. It is also appreciated that conventional piezoelectric speakers tend to replace century-old coil-drive speakers, in particular, in mobile phones, earphones, and other small portable devices. These piezoelectric speakers typically include more components than the coil-drive speakers and constructed in more complicated structures.

Therefore, there is an urgent need for counter units capable of being incorporated into various prior art piezoelectric speakers and then converting such speakers into electromagnetically-countered piezoelectric speaker systems, and there is a need for the electromagnetically-countered piezoelectric speaker systems for effectively reducing irradiation of the harmful waves from their speakers without affecting the sounds. There also is a need to provide the counter units to counter the harmful waves irradiated by various wave sources which define different shapes and sizes and which are disposed in various arrangements. There also is a need for the simple counter units for countering the harmful waves irradiated by the piezoelectric speakers without compromising their performances and without complicating their configurations. In addition, there is a need for electric and magnetic shields for such piezoelectric speaker systems capable of shielding users from the electric and magnetic waves of the harmful waves. There further is a need for the piezoelectric speaker systems equipped with multiple mechanisms to shield the users from the EM waves irradiated by their speakers.

### SUMMARY OF THE INVENTION

The present invention relates to an electromagnetically-countered system including at least one wave source irradiating harmful electromagnetic waves and at least one counter unit emitting counter electromagnetic waves for countering the harmful waves by the counter waves, e.g., by canceling at least a portion of the harmful waves in a target space by the counter waves and by suppressing the harmful waves from propagating to the target space. More particularly, the present invention relates to generic counter units for electromagnetically-countered piezoelectric speaker systems and various mechanisms for countering the harmful waves irradiated by various base units of the wave sources by the counter waves. Accordingly, the counter unit may be shaped, sized, and/or arranged to match its configuration with configuration of the base units of the wave source, thereby emitting the counter waves automatically matching of such harmful waves. In the alternative, such a counter unit may be shaped, sized, and/or disposed in an arrangement which is defined along one or more wavefronts of the harmful waves, thereby emitting the counter waves automatically matching the harmful waves. The present invention also relates to various counter units which are provided as analogs of the base units of the wave source, where the analog may approximate the base units which are more complex than the counter unit, where the three- or two-dimensional base units may be approximated as a two- or one-dimensional analog, and the like. The present invention relates to multiple counter units which are simpler than the base units but disposed in an arrangement which approximates the shape and/or arrangement of such base units. The present invention relates to the counter unit which are shaped and/or sized based upon the configuration of the base units and/or dispositions thereof. The present invention relates to various countering modes where a single counter unit counters a single base unit, at least two but not all of multiple base units, and/or all of the base units, where multiple counter units counter a single base unit, more base units or less multiple units, and the like. The present invention relates to various electric and/or magnetic shields which may be used alone or in conjunction with the counter units to minimize irradiation of the harmful waves from the system.

The present invention also relates to various methods of countering the harmful waves by the counter waves through source matching or wave matching. More particularly, the present invention relates to various methods of forming the counter unit as an analog of the base units and emitting the counter waves matching the harmful waves, various methods of approximating the base units by the simpler counter unit for the countering, various methods of approximating such base units by multiple simpler counter units, and the like. The present invention relates to various methods of disposing the counter unit along the wavefronts of the harmful waves and emitting the counter waves for matching such wavefronts of the harmful waves, various methods of disposing multiple counter units along the wavefronts of the harmful waves and emitting the counter waves with the counter units for matching such wavefronts, and the like. The present invention also relates to various methods of manipulating the wavefronts of such counter waves by disposing the counter unit closer to or farther away from the target space with respect to the base unit, various methods of controlling radii of curvature of the wavefronts of the counter waves by incorporating one or multiple counter units emitting such counter waves of the same or opposite phase angles, various methods of manipulating the wavefronts of the counter waves by disposing one or multiple counter units of the shapes similar to or different from the shapes of the base units, and the like. The present invention relates to various methods of countering the harmful waves irradiated by one or multiple base units by the counter waves emitted by the single or multiple counter units. Accordingly, the present invention relates to various methods of emitting the counter waves from a single counter unit for the harmful waves irradiated by one or more base units, various methods of emitting such counter waves by two or more counter units for the harmful waves irradiated by a single or multiple base units, and the like. The present invention also relates to various methods of minimizing irradiation of the harmful waves by incorporating such electric and/or magnetic shields, by incorporating one or both of such shields in conjunction with the above counter units, and the like.

The present invention further relates to various processes for providing various counter units and various electromagnetically-countered piezoelectric speaker systems incorporating one or multiple counter units therein. More particularly, the present invention relates to various processes for forming such counter units to emit the counter waves having the wavefronts similar to (or different from) the shapes of the counter units, various processes for forming the counter units as the above analogs of the base units, various processes for providing the counter units emitting the counter waves defining the similar or opposite phase angles, various processes for providing such counter units defining the wavefronts shaped similar to the harmful waves, various processes for disposing the counter units in a preset arrangement and emitting therefrom the counter waves which have the wavefronts similar to such an arrangement, and the like. The present invention relates to various processes for assigning a single counter unit to counter the harmful waves irradiated by a single base unit for local countering or to counter such harmful waves from multiple base units for a global countering, various processes for assigning multiple counter units to counter such harmful waves irradiated by a single base unit for the global countering or to counter the harmful waves from multiple base units for the local countering or global countering depending on numbers of the counter and base units. The present invention further relates to various processes for incorporating such electric and/or magnetic shields for minimizing the irradiation of the harmful waves, and various processes for minimizing the irradiation of such harmful waves by employing such shields as well as the above counter units.

Accordingly, a primary objective of the present invention is to provide an electromagnetically-countered piezoelectric speaker system (to be abbreviated as an “EMC speaker system,” as an “EMC system,” as a “speaker system,” or simply as a “system” hereinafter) which is capable of minimizing the irradiation of the harmful waves by multiple base units of at least one wave source by countering the harmful waves by the counter waves. Therefore, a related objective of this invention is to provide a system which can counter the harmful waves by canceling at least a portion of the harmful waves by the counter waves and/or by suppressing such harmful waves from propagating toward a preset direction by the counter waves. Another related objective of this invention is to counter such harmful waves by the counter waves not all around such base units of the EMC system but only in the target space (or area) which is to be defined on only one side of the system. In general, the target space is defined between at least one of such base units and an user of the system or a specific body part of the user. Another related objective of this invention is to manipulate such counter waves to have the phase angles at least partially opposite to those of the harmful waves so that the counter waves can cancel and/or suppress such harmful waves when propagated to the target space. Another related objective of this invention is to arrange the counter waves to define the phase angles at least partially similar to those of the harmful waves such that the counter waves can cancel and/or suppress such harmful waves when propagated to the target space from an opposite side of at least one of the base units. Another related objective of this invention is to emit such counter waves from the same side or opposite side of the base units with respect to the target space while manipulating their phase angles so that the counter waves from different counter units counter the harmful waves in the target space.

Another objective of the present invention is to provide such an EMC system with at least one counter unit capable of emitting such counter waves. Therefore, a related objective of this invention is to match at least one feature or configuration (e.g., each meaning a shape, a size, an arrangement, and the like) of the counter unit with the feature or configuration of the base units so that the counter waves emitted from the counter unit match the harmful waves irradiated from the base units. Another related objective of this invention is to match the shape of a single counter unit defining the shape of a single base unit such that the counter waves emitted by the counter unit match the harmful waves by the base unit. Another related objective of this invention is to match the shape of a single counter unit with an arrangement of multiple base units such that the counter waves emitted from the counter unit match a sum of the harmful waves irradiated by multiple base units. Another related objective of this invention is to dispose multiple counter units in an arrangement which match the shape of a single base unit so that a sum of such counter waves emitted from multiple counter units match the harmful waves by the base unit. Another related objective of this invention is to arrange multiple counter units in an arrangement which matches another arrangement of multiple base units such that a sum of the counter waves emitted by multiple counter units match another sum of the harmful waves by multiple base units. Another related objective of this invention is to provide such counter units while using the least amount of electrically conductive, semiconductive, and/or insulative materials, while minimizing a total volume or a size of the counter units, while minimizing a total mass of such counter units, and the like. Another related objective of this invention is to emit the counter waves by the counter units while using the least electrical energy, while drawing the least amount of electric current or voltage from the base units or other parts of the EMC system, and the like.

Another objective of the present invention is to provide an EMC system which includes therein at least one counter unit matching the shape of at least one base unit. Accordingly, a related objective of this invention is to form the counter unit as an one-, two- or three-dimensional analog of the three-dimensional base unit and to counter the single or multiple base units by the single or multiple analogs. Another related objective of this invention is to provide the counter unit as an one- or two-dimensional analog of the three-dimensional base unit and to counter the single or multiple base units by the single or multiple analogs. Another related objective of this invention is to provide the counter unit as an one- or two-dimensional analog of the two-dimensional base unit and then to counter the single or multiple base units with the single or multiple analogs. Another related objective of this invention is to form the counter unit as an one-dimensional analog of the two-dimensional base unit and to counter the single or multiple base units by the single or multiple analogs. Another related objective of this invention is to provide the counter unit as an one-dimensional analog of an one-dimensional base unit and to counter the single or multiple base units using the single or multiple analogs. Another related objective of this invention is to provide such counter units as one-, two-, and/or three-dimensional analogs of an one-, two-, and/or three-dimensional base units and then to counter the base units of the mixed dimension by the counter units of the mixed dimension. In these objectives, such counter units emit the counter waves capable of matching the harmful waves irradiated by the base units. Another related objective of this invention is to form the counter unit conforming to the shape of the base units for matching the harmful waves with the counter waves emitted thereby. Another related objective of this invention is to form the counter unit which does not conform to the shape of the base units but which is disposed in an arrangement for matching the harmful waves by such counter waves emitted thereby. Another related objective of this invention is to form the counter unit in a shape of one or multiple wires, strips, sheets, tubes, coils, spirals, meshes, mixtures thereof, combinations thereof, and/or arrays thereof so as to match the shape of the base units and to emit the counter waves matching the harmful waves. Another related objective of this invention is to dispose any of the above counter units within a preset distance from the base units in order to match at least some wavefronts of the counter waves emitted thereby to at least some wavefronts of the harmful waves. Another related objective of this invention is to dispose any of the above counter units in a preset arrangement with respect to the base units so as to match at least some wavefronts of the counter waves with at least some of the harmful waves.

Another objective of the present invention is to provide an EMC system which includes therein at least one counter unit having a size which operatively matches a size of the base unit for matching the harmful waves irradiated by the base unit with the counter waves emitted thereby. Accordingly, a related objective of this invention is to provide the counter unit larger, wider, and/or longer than the base unit, where such a counter unit is preferably disposed between the base unit and target space (to be referred to as a “front arrangement” hereinafter) for such matching. Another related objective of this invention is to form the counter unit defining a size, a width, and/or a length similar (or identical) to those of the base unit, where the counter unit is preferably disposed laterally or side by side to the base unit with respect to the target space (to be referred to as a “lateral arrangement” hereinafter) for the matching. Another related objective of this invention is to form the counter unit smaller, narrower, and/or shorter than the base unit, where the counter unit is preferably disposed on an opposite side of the target space relative to the base unit (to be referred to as a “rear arrangement” hereinafter) for the matching. Another related objective of this invention is to enclose at least a portion of the counter unit by the base unit or, in the alternative, to enclose at least a portion of the base unit by the counter unit (to be referred to as a “concentric arrangement” hereinafter) for such matching. Another related objective of this invention is to dispose multiple counter units in such a front, lateral, rear or concentric arrangement with respect to the single base unit for such matching. Another related objective of this invention is to form the single or multiple counter units disposed in the front, lateral, rear or concentric arrangement with respect to multiple base units for such matching. Another related objective of this invention is to define multiple counter units all of which are disposed in only one of such front, lateral, rear, and concentric arrangements with respect to all of multiple base units or at least two of which are disposed in different (or mixed) arrangements with respect to at least two of multiple base units for such matching.

Another objective of the present invention is to provide an EMC system which incorporates at least one counter unit in a disposition (e.g., an orientation, an alignment, and a distance) matching that of the base unit. Thus, a related objective of this invention is to orient the counter unit in a direction of propagation of the harmful waves, in another direction in which the current flows in the base unit, in another direction in which the voltage is applied across the base unit, in a direction of the longitudinal axis of the base unit, and/or in a direction of the short axis thereof for the matching. Another related objective of this invention is to form multiple counter units all of which are oriented in one of the same directions or axes, at least two of which are oriented along different directions and/or axes, and all of which are oriented in different directions or axes for such matching. Another related objective of this invention is to axially align the counter unit with respect to the base unit (to be referred to as an “axial alignment” hereinafter) so that the counter waves emitted by the counter unit are to axially align with such harmful waves which are irradiated by the base unit for the matching. Another related objective of this invention is to axially misalign the counter unit with the base unit (to be referred to as an “off-axis alignment” hereinafter) but to dispose the counter unit in a preset arrangement for such matching. Another related objective of this invention is to provide multiple counter units disposed in such an axial or off-axis alignment with respect to the single base unit for such matching. Another related objective of this invention is to provide the single or multiple counter units which are disposed in the axial or off-axis alignment with respect to multiple base units for such matching. Another related objective of this invention is to define multiple counter units all of which are disposed in the axial or off-axis alignment with respect to all of multiple base units or at least two of which are disposed in different (or mixed) alignments relative to at least two of multiple base units for the matching. Another related objective of this invention is to dispose the counter unit at a preset distance from the base unit such that at least some wavefronts of the counter waves from the counter unit match at least some wavefronts of the harmful waves from the base unit for such matching. Another related objective of this invention is to dispose the single counter unit at preset distances from each (or at least two) of multiple base units for such matching. Another related objective of this invention is to dispose multiple counter units at preset distances from the single base unit or, alternatively, at preset distances from each (or at least two) of multiple base units for the matching.

Another objective of the present invention is to provide an EMC system which includes therein at least one counter unit for emitting the counter waves which have amplitudes matching those of the harmful waves. Therefore, a related objective of this invention is to provide the counter unit emitting the counter waves with amplitudes greater than those of the harmful waves, where this counter unit is preferably disposed farther away from the target space compared with the base unit or in the rear arrangement for such matching. Another related objective of this invention is to form the counter unit emitting the counter waves with amplitudes similar (or identical) to those of the harmful waves, where such a counter unit is preferably disposed side by side with the base unit relative to the target space or in the lateral arrangement for the matching. Another related objective of this invention is to form the counter unit emitting the counter waves with amplitudes less than those of the harmful waves, where this counter unit is preferably disposed closer to such a target space than the base unit or in the front arrangement for the matching. Another related objective of this invention is to provide multiple counter units emitting the counter waves a sum of which may define the amplitudes greater than, similar to or less than those of the single base unit, those of all of multiple base units, those of at least two but not all of multiple counter units, and the like.

Another objective of the present invention is to provide such an EMC system including at least one counter unit capable of emitting the counter waves which match at least a portion of the harmful waves and, therefore, counter the harmful waves. Therefore, a related objective of this invention is to provide the counter unit for emitting such counter waves defining multiple wavefronts which match at least one of of the wavefronts of the harmful waves in the target space. Another related objective of this invention is to dispose the counter unit along at least a portion of at least one of the wavefronts of the harmful waves and to emit the counter waves matching such a portion of the wavefront of the harmful waves. Another related objective of this invention is to dispose multiple counter units along at least a portion of at least one of the wavefronts of the harmful waves and to emit the counter waves a sum of which then matches such a portion of the wavefront of the harmful waves. Another related objective of this invention is to dispose the counter unit across at least two of such wavefronts of the harmful waves but to emit the counter waves capable of matching at least a portion of at least one of the wavefronts of the harmful waves. Another related objective of this invention is to provide multiple counter units at least two of which are disposed across at least two of the wavefronts of the harmful waves but to emit the counter waves capable of matching the portion of the wavefront of the harmful waves. Another related objective of this invention is to shape and size such a counter unit in order to emit the counter waves with radii of curvature which match those of at least a portion of the harmful waves. Another related objective of this invention is to dispose the counter unit in a preset position or at a preset distance from the base unit in which the counter waves emitted thereby define the radii of curvature which match those of at least a portion of the harmful waves. Another related objective of this invention is to shape and size multiple counter units emitting such counter waves a sum of which define the radii of curvature matching the harmful waves irradiated by the single base unit or multiple base units. Another related objective of this invention is to provide the counter unit in a shape of one or multiple wires, strips, sheets, tubes, coils, spirals, meshes, mixtures thereof, combinations thereof, and/or arrays thereof and to emit the counter waves capable of matching at least a portion of at least one wavefront of the harmful waves from the base unit. Another related objective of this invention is to fabricate the counter unit into a solid shape without forming any openings or holes thereacross for the matching. Another related objective of this invention is to fabricate the counter units as the arrays defining multiple holes or openings thereacross for such matching.

Another objective of the present invention is to provide an EMC system which includes therein at least one counter unit for emitting the counter waves and for locally countering the harmful waves irradiated from the base unit. Accordingly, a related objective of this invention is to provide the single counter unit for locally countering the harmful waves from the single base unit by the counter waves emitted thereby. Another related objective of this invention is to provide multiple counter units each of which locally counters the harmful waves from only one of the same (or less) number of base units with the counter waves emitted from each of multiple counter units. Another related objective of this invention is to provide the single counter unit (or multiple counter units) which defines the feature (or configuration) similar (or identical) to that of the single base unit (or multiple base units) for such local countering. Another related objective of this invention is to provide the single counter unit (or multiple counter units) emitting the counter waves which define the wavefronts matching at least one of the wavefronts of the harmful waves irradiated from the single base unit (or multiple base units) for such local countering. Another related objective of this invention is to provide multiple counter units at least one of which defines the feature (or configuration) similar (or identical) to that of the base unit and at least another of which defines the wavefronts matching at least one of the wavefronts of the harmful waves from the base unit for such local countering.

Another objective of the present invention is to provide an EMC system which includes therein at least one counter unit for emitting the counter waves and for globally countering the harmful waves irradiated from the base unit. Therefore, a related objective of this invention is to form one or multiple counter units each emitting the counter waves for globally matching the harmful waves irradiated from one or a less number of base units. Another related objective of this invention is to provide the single counter unit for globally countering a sum of the harmful waves irradiated by multiple base units by the counter waves emitted thereby. Another related objective of this invention is to form multiple counter units each of which globally counters the harmful waves irradiated by at least two base units by the counter waves emitted by each of multiple counter units. Another related objective of this invention is to define the single counter unit (or multiple counter units) which defines the feature (or configuration) which is similar (or identical) to those of at least two (or a greater number of) base units for the global countering. Another related objective of this invention is to provide the single counter unit (or multiple counter units) emitting the counter waves which define the wavefronts matching at least one of the wavefronts of the harmful waves irradiated from at least two (or a greater number of) base units for the global countering. Another related objective of this invention is to provide multiple counter units at least one of which defines the feature (or configuration) similar (or identical) to those of at least two base units and at least another of which defines the wavefronts matching at least one wavefront of the harmful waves irradiated by at least two of other base units for such local countering.

Another objective of the present invention is to provide an EMC system which includes therein at least one counter unit which is disposed in a preset position or location defined relative to the base unit and/or target space. Therefore, a related objective of this invention is to dispose the counter unit on (or over) an exterior surface of the base unit, to dispose the counter unit on (or below) an interior surface of the base unit, to embed at least a portion of the counter unit inside the base unit, and so on. Another related objective of this invention is to provide the system with a case member and to dispose the counter unit on (or over) an exterior surface of the case member, to dispose such a counter unit on (or below) an interior surface of the case member, to embed at least a portion of the counter unit inside the case member, to dispose the counter unit between the case member and base unit, and the like. Another related objective of this invention is to dispose the counter unit in a preset relation to the case member such as, e.g., exposing at least a (or entire) portion of the counter unit through the case member, enclosing the entire portion of the counter unit inside the case member, and the like.

Another objective of the present invention is to provide an EMC system which includes therein at least one counter unit emitting the counter waves propagating along preset directions. Therefore, a related objective of this invention is to arrange the counter unit to emit the counter waves always in a fixed direction with respect to the base unit such that the counter waves propagate along a direction defined based on a preset relation to a direction of propagation of the harmful waves, e.g., parallel to the harmful waves, perpendicular to the harmful waves, at a preset angle with respect to the harmful waves, and so on. Another related objective of this invention is to arrange the counter unit to emit the counter waves in variable directions with respect to a direction of propagation of the harmful waves, where such a counter unit is arranged to change its arrangement and/or orientation and/or to receive the current and/or voltage along variable directions for changing the direction of such counter waves. Another related objective of this invention is to arrange the counter unit to emit the counter waves in a direction which is adaptively determined by variable directions of propagation of the harmful waves, where such a counter unit may change the direction of the counter waves as described hereinabove. Therefore, such a counter unit may change an extent of countering based on its arrangement and/or orientation. Another related objective of this invention is to synchronize a propagation direction of the counter waves with that of such harmful waves based on the preset relation disclosed hereinabove. Another related objective of this invention is to arrange the counter unit to manipulate the amplitudes of the counter waves in various mechanisms similar to those for manipulating the directions thereof.

Another objective of the present invention is to provide an EMC system with at least one of the above counter units and to supply the electric current or voltage thereto for countering such harmful waves by such counter waves emitted thereby. Accordingly, a related objective of this invention is to provide the counter unit with the electric current or voltage which is supplied to the above base unit or at least one of multiple base units. Another related objective of this invention is to provide the counter unit with at least a portion but not an entire portion of the electric current or voltage supplied to such a base unit or at least one of multiple base units. Another related objective of this invention is to provide the counter unit with such a portion of the current or voltage of which the amplitudes and/or direction are modified before being supplied thereto. In all of these examples, the current or voltage supplied to the counter unit is automatically synchronized with such current or voltage supplied to the base unit or at least one of multiple base units. Another related objective of this invention is to supply the counter unit with electric current or voltage which is not the current or voltage supplied to the base unit or at least one of multiple base units but which is at least partially synchronized with the current or voltage supplied to such base units. Another related objective of this invention is to manipulate the amplitudes or directions of the current or voltage depending upon configuration and/or disposition of the counter unit. Another related objective of this invention is to electrically couple the counter unit with the base unit in a parallel, series or hybrid mode. Another related objective of this invention is to supply such electric current or voltage based upon various sequences such as, e.g., first to the base unit and then to the counter unit, first to the counter unit then to the counter unit, first to one of multiple counter units and then to the rest of the counter units or base unit, first to one of multiple base units and then to the rest of the base units or counter unit, simultaneously to the counter and base units, and the like.

It is to be understood in all of such objectives that the counter units are preferably arranged to not adversely affect other intended operations of the systems. For example, the counter units of the EMC speaker systems may effectively counter the harmful waves irradiated by their sound generating base units but may not adversely affect quality and/or quantity of acoustic sounds produced thereby. It is also appreciated in all of such objectives that the counter units are preferably arranged to emit the counter waves defining the phase angles at least partially opposite to those of the harmful waves for such countering but that the counter units may also emit the counter waves defining the phase angles at least partially similar to those of the harmful waves when disposed on an opposite side of the base unit with respect to the target space or, alternatively, when the system includes multiple counter units and when it is desirable to modify the radii of curvature of the wavefronts of the counter waves.

The basic principle of the counter units of the generic electromagnetically-countered systems of this invention is to emit the counter waves which form the wavefronts similar (or identical) to those of the harmful waves but define the phase angles at least partially opposite to those of such harmful waves. Therefore, by propagating such counter waves to the target space, the counter waves can effectively counter the harmful waves in the target space by, e.g., canceling at least a portion of such harmful waves therein and/or suppressing the harmful waves from propagating theretoward. To this end, the counter units are arranged to emit the counter waves which define the wavefronts matching those of the harmful waves by various mechanisms. In one example, such counter units are shaped similar (or identical) to the base units of the waves sources, or arranged similar (or identical) to such base units and, therefore, emit the counter waves which can counter the harmful waves in the target space. In another example, such counter units are disposed along one or more of the wavefronts of the harmful waves and emit the counter waves which are similar (or identical) to the harmful waves and, accordingly, counter the harmful waves in the target space. In these two examples, the counter units are to emit the counter waves with the wavefronts which are similar (or identical) to the shapes of such counter units themselves, and such counter waves are to define the phase angles which are at least partially opposite to the phase angles of the harmful waves. In another example, the counter units are shaped differently from the base units, but are rather disposed in an arrangement in which the counter waves emitted therefrom may match such harmful waves in the target space. In another example, the counter units are disposed across different wavefronts of the harmful waves but are to emit the counter waves which are similar (or identical) to the harmful waves and, therefore, counter the harmful waves in the target space. In the last two examples, the counter units may be arranged to emit the counter waves with the wavefronts may or may not be similar (or identical) to the shapes of the counter units themselves, while the counter waves are to define the phase angles which are at least partially opposite to those of the harmful waves.

The basic principle of the counter units of various EMC systems may also be applied to various conventional devices. For example, the counter units may be included in any base units of electrically conductive wires, coils, and/or sheets or, in the alternative, into any electrically semiconductive and/or insulative wires, coils, and/or sheets for minimizing the irradiation of the harmful waves by countering such harmful waves by the counter waves, e.g., by canceling at least a portion of the harmful waves in the target space and/or suppressing the harmful waves from propagating toward the target space, where the counter units may be made of and/or include at least one electrically conductive, insulative or semiconductive material. The counter units may be implemented into any of such base units which define the shapes which may be formed by incorporating one or multiple wires, coils, and/or sheets, by modifying the shapes of one or multiple wires, coils, and/or sheets, where a few examples of the modified shapes may include a solenoid and toroid each formed by modifying the shape of such a coil. Therefore and in one example, such counter units may be implemented into various speakers such as cone-drive speakers, electrostatic speakers, and piezoelectric speakers for minimizing the irradiation of the harmful waves. Accordingly, any prior art devices including the electromagnetically-countered speakers such as earphones, headphones, wired phones, mobile phones, and audiovisual devices may be converted into the electromagnetically countered systems. Similarly, the counter units may be implemented into various microphones which are inverse examples of such speakers, and any prior art devices including such electromagnetically-countered microphones such as wired phones, mobile phones, audio and/or audiovisual sound systems, and an assembly of the earphone and microphone may be converted into the electromagnetically countered systems.

It is appreciated that various counter units of the generic EMC systems of this invention may be incorporated into any electrical and/or electronic devices each of which may include at least one base unit and, accordingly, may irradiate the harmful waves including electric waves (to be abbreviated as “EWs” hereinafter) and magnetic waves (to be abbreviated as “MWs” hereinafter) having frequencies of about 50 to 60 Hz and/or other EWs and MWs of higher frequencies. It is also appreciated that the generic EMC systems of this invention may also be incorporated into any portable or stationary electric and/or electronic devices which include at least one base unit detailed examples of which have been provided heretofore and will be provided hereinafter. It is further appreciated that such counter units may be provided in a micron-scale and incorporated to semiconductor chips and circuits such as LSI and VLSI devices and that such counter units may be provided in a nano-scale and incorporated into various nano devices including at least one base unit which in this case may be a single molecule or a compound or may be a cluster of multiple molecules or compounds.

Various system, method, and/or process aspects of such EMC speaker systems and various embodiments thereof are now enumerated. It is to be understood, however, that following system, method, and/or process aspects of this invention may be embodied in many other different forms and, accordingly, should not be limited to such aspects and/or their embodiments which are to be set forth herein. Rather, various exemplary aspects and their embodiments described hereinafter are provided such that this disclosure will be thorough and complete, and fully convey the scope of this invention to one of ordinary skill in the relevant art.

In one aspect of the present invention, a speaker system may be provided to counter harmful electromagnetic waves irradiated by multiple base units of at least one wave source by canceling the harmful waves in a target space and/or suppressing the harmful waves from propagating toward the target space, where the base units are arranged to include only portions of the wave source which are responsible for irradiating the harmful waves and also for affecting paths of the harmful waves therethrough and where the target space is defined between the system and at least one body part of an user.

In one exemplary embodiment of this aspect of the invention, a speaker system may include at least one piezoelectric plate, at least two electrodes, at least one metal plate, and at least one counter unit. Such a piezoelectric plate is arranged to convert electric energy supplied thereto into mechanical vibration thereof while serving as one of the base units, where this piezoelectric plate will be referred to as the “first piezoelectric plate” or simply as the “first piezo plate” hereinafter. Such electrodes are arranged to electrically couple with two different portions of such a first piezo plate and to supply the energy across the first piezo plate while emitting the harmful waves and while serving as another of the base units, where these electrodes are to be referred to as the “first electrodes” hereinafter. The metal plate is arranged to be coupled to one of the electrodes, to receive the energy, and to supply the energy to such one of the electrodes while serving as yet another of the base units, where this metal plate is to be referred to as the “first metal plate” hereinafter. The counter unit is arranged to define a configuration which is similar (or identical) to that of at least one of the base units and to emit counter electromagnetic waves. Whereby the counter waves are arranged to define phase angles at least partially opposite to those of the harmful waves, to have wave characteristics at least partially similar to those of the harmful waves due to the configuration and, therefore, to counter the harmful waves in the target space due to the phase angles. Such counter waves are referred to as the “first counter waves” hereinafter.

In another exemplary embodiment of this aspect of the invention, such a speaker system may include at least one first piezo plate, at least two first electrodes, at least one first metal plate, and a single counter unit In one example, the counter unit is arranged to have a configuration for an 1-D, 2-D or 3-D analog of at least one of such base units and then to emit the first counter waves. In another example, the counter unit is arranged to have a configuration of an 1-D (or 2-D, 3-D) analog of at least two of the base units and to emit the first counter waves.

In another exemplary embodiment of this aspect of the invention, such a speaker system may also have at least one first piezo plate, at least two first electrodes, at least one first metal plate, and multiple counter units. In one example, at least two of multiple counter units are arranged to define a configuration corresponding to an 1-D, 2-D or 3-D analog of at least one of the base units and to emit the first counter waves. In another example, at least two of the counter units are arranged to define configurations of 1-D, 2-D or 3-D analogs of at least two of the base units and to emit the first counter waves.

In another aspect of the present invention, a speaker system may be provided for countering harmful electromagnetic waves irradiated by multiple base units of at least one wave source through matching a shape and/or an arrangement of at least one of the base units with another shape and/or arrangement of at least one portion of the system and through canceling the harmful waves in a target space and/or suppressing the harmful waves from propagating toward the target space, where such base units are arranged to include only those portions of the wave source responsible for irradiating the harmful waves and/or affecting paths of the harmful waves therethrough, and where the target space is defined between the system and at least one body part of an user of the system.

In one exemplary embodiment of this aspect of the invention, a speaker system may include at least one first piezo plate, at least two first electrodes, at least one first metal plate, and at least one counter unit which is arranged to have a shape similar (or identical, conforming) to that of at least one of the base units, and then to emit counter electromagnetic waves which are arranged to have phase angles at least partially opposite to those of the harmful waves, to have wave characteristics at least partially similar to those of the harmful waves due to such a shape and, accordingly, to counter such harmful waves in the target space due to such phase angles. These counter waves will be referred to as the “second counter waves” hereinafter.

In another exemplary embodiment of this aspect of the invention, such a speaker system may include at least one first piezo plate, at least two first electrodes, at least one first metal plate, and at least one counter unit which is arranged to have a shape different from (or not conforming to) that of at least one of the base units, to be in a preset arrangement, and then to emit counter electromagnetic waves. Whereby, the counter waves are arranged to define phase angles at least partially opposite to those of the harmful waves, to have wave characteristics at least partially similar to those of such harmful waves due to such an arrangement and, therefore, to counter the harmful waves in the target space due to such phase angles, where these counter waves will be referred to as the “third counter waves” hereinafter.

In another exemplary embodiment of this aspect of the invention, a speaker system may have at least one first piezo plate, at least two first electrodes, at least one first metal plate, and at least one counter unit. In one example, the counter unit is arranged to define a shape of an 1-D analog of the 1-D, 2-D or 3-D base units and then to emit the second counter waves. In another example, the counter unit is arranged to have a shape of at least one 1-D analog of at least two of the 1-D, 2-D or 3-D base units and to emit the second counter waves. In another example, the counter unit is arranged to have a shape of a 2-D analog of such 1-D, 2-D or 3-D base units and to emit the second counter waves. In another example, the counter unit is arranged to define a shape of at least one 2-D analog of at least two of the 1-D, 2-D or 3-D base units and to emit the second counter waves. In another example, the counter unit is instead arranged to have a shape of a 3-D analog of the 1-D, 2-D or 3-D base units and to emit the second counter waves. In another example, the counter unit is arranged to define a shape of at least one 3-D analog of at least two of the 1-D, 2-D or 3-D base units and then to emit the second counter waves.

In another exemplary embodiment of this aspect of the invention, a speaker system may have at least one first piezo plate, at least two first electrodes, at least one first metal plate, and at least one counter unit. In one example, the counter unit is arranged to have a shape which matches a shape of one of such base units and to emit the second counter waves. In another example, the counter unit is arranged to define a shape matching shapes of at least two of the base units and to emit the second counter waves. In another example, the system includes multiple counter units which are arranged to form an overall shape matching a shape of only one of the base units and to emit the second counter waves. In another example, multiple counter units are arranged to form an overall shape matching an overall shape of at least two of the base units and to emit the second counter waves.

In another exemplary embodiment of this aspect of the invention, a speaker system may have at least one first piezo plate, at least two first electrodes, at least one first metal plate, and at least one counter unit. In one example, the counter unit is arranged to be disposed between the target space and at least two of the base units, to define a dimension longer than dimensions of the base units (or than a dimension of an arrangement of the base units), and to emit counter electromagnetic waves. In another example, the counter unit is arranged to be disposed on an opposite side of the target space with respect to the base units, to have a dimension shorter than dimensions of the base units (or than a dimension of an arrangement of the base units), and then to emit counter electromagnetic waves. In another example, the system has multiple counter units which are arranged to be disposed between at least two of the base units and target space, to be disposed in an arrangement forming a dimension which is longer than dimensions of the base units (or than a dimension of an arrangement of the base units), and to emit counter electromagnetic waves. In another example, the system includes multiple counter units which are arranged to be disposed on an opposite side of the target space with respect to at least one of the base units, to be disposed in an arrangement defining a dimension shorter than dimensions of the base units (or than a dimension of an arrangement of the base units), and to emit counter electromagnetic waves. Whereby and in each of these examples, such counter waves are arranged to have phase angles which are at least partially opposite to those of the harmful waves, to have wave characteristics at least partially similar to those of the harmful waves due to the dimension and, accordingly, to counter the harmful waves in the target space due to the opposite phase angles.

In another exemplary embodiment of this aspect of the invention, a speaker system may have at least one first piezo plate, at least two first electrodes, at least one first metal plate, and at least one counter unit. In one example, the counter unit is arranged to define a shape of a wire, a strip, a sheet, a tube, a coil, a spiral, a mesh, a mixture thereof, a combination thereof, and/or an array thereof while conforming its shape to that of at least one of the base units, and to emit the second counter waves. In another example, the counter unit is arranged to have a shape of a wire, a strip, a sheet, a tube, a coil, a spiral, a mesh, a mixture thereof, a combination thereof, and/or an array thereof while at least partially conforming its shape to a shape of an arrangement of at least two of such base units, and to emit the second counter waves.

In another exemplary embodiment of this aspect of the invention, a speaker system may have at least one first piezo plate, at least two first electrodes, at least one first metal plate, and at least one counter unit which is arranged to be disposed in an arrangement which is similar to (or different from) an arrangement of the base units and to emit the third counter waves.

In another exemplary embodiment of this aspect of the invention, a speaker system may have at least one first piezo plate, at least two first electrodes, at least one first metal plate, and at least one counter unit. In one example, the counter unit is arranged to be disposed between at least two of the base units and target space, to have a size which is larger than a size of each of at least two of such base units, and then to emit counter electromagnetic waves. In another example, such a counter unit is arranged to be disposed on an opposite side of the target space with respect to such base units, to define a size which is smaller than a size of each of at least two of such base units, and then to emit counter electromagnetic waves. Whereby and in each of the above examples, such counter waves are arranged to define phase angles at least partially opposite to those of the harmful waves, to have wave characteristics at least partially similar to those of the harmful waves based upon the size and, therefore, to counter the harmful waves in the target space due to the phase angles.

In another aspect of the present invention, a speaker system may be provided for countering harmful electromagnetic waves irradiated by multiple base units of at least one wave source through matching dispositions of the base units with a disposition of at least one part of the system and also through canceling the harmful waves in a target space and/or suppressing such harmful waves from propagating toward the target space, where the base units are arranged to represent only portions of the wave source which are responsible for irradiating the harmful waves and affecting paths of the harmful waves therethrough and where the target space is defined between the system and at least one body part of an user of the system.

In one exemplary embodiment of this aspect of the invention, a speaker system may include at least one first piezo plate, at least two first electrodes, at least one first metal plate, and at least one counter unit which is arranged to be disposed in an alignment matching a direction of propagation of the harmful waves, a direction of electric current flowing along at least one of the base units, another direction of electric voltage applied across at least one of the base units, yet another direction along a longitudinal axis of at least one of the base units, and/or a direction of a short axis thereof normal to the longitudinal axis, and then to emit counter electromagnetic waves. Whereby, such counter waves are arranged to define phase angles at least partially opposite to those of the harmful waves, to have wave characteristics at least partially similar to those of such harmful waves due the alignment and, therefore, to counter the harmful waves in the target space due to the phase angles.

In another exemplary embodiment of this aspect of the invention, a speaker system may have at least one first piezo plate, at least two first electrodes, at least one first metal plate, and at least one counter unit. In one example, the counter unit is arranged to be disposed in a position between such a target space and base units and to emit counter electromagnetic waves of amplitudes less than those of such harmful waves. In another example, the counter unit is arranged to be disposed in a position defined on an opposite side of such a target space with respect to the base units and to emit counter electromagnetic waves defining amplitudes greater than those of the harmful waves. Whereby and in both examples, such counter waves are arranged to define phase angles at least partially opposite to those of the harmful waves, to have wave characteristics which are at least partially similar to those of the harmful waves due to the position and, accordingly, to counter the harmful waves in the target space due to the phase angles.

In another exemplary embodiment of this aspect of the invention, a speaker system may have at least one first piezo plate, at least two first electrodes, at least one first metal plate, and at least one counter unit. In one example, such a counter unit is arranged to be in a disposition enclosing therein at least a (or an entire) portion of at least one of the base units and then to emit counter electromagnetic waves. In another example, the counter unit is arranged to be in a disposition enclosed by at least a (or an entire) portion of at least one of the base units and to emit counter electromagnetic waves. In another example, the counter unit is arranged to be in a disposition lateral to (or side by side with) at least one of the base units and to emit counter electromagnetic waves. Whereby and in each of such examples, the counter waves are arranged to define phase angles at least partially opposite to those of the harmful waves, to define wave characteristics at least partially similar to those of such harmful waves due the disposition and, therefore, to counter the harmful waves in the target space due to the phase angles.

In another exemplary embodiment of this aspect of the invention, a speaker system may have at least one first piezo plate, at least two first electrodes, at least one first metal plate, and at least one counter unit which is arranged to be in a disposition symmetric (or asymmetric) to at least a portion of at least one of the base units and to emit counter electromagnetic waves. Accordingly, such counter waves are arranged to define phase angles at least partially opposite to those of the harmful waves, to have wave characteristics which are at least partially similar to those of the harmful waves due the disposition and, therefore, to counter the harmful waves in the target space due to the phase angles.

In another exemplary embodiment of this aspect of the invention, a speaker system may have at least one first piezo plate, at least two first electrodes, at least one first metal plate, and at least one counter unit which is arranged to be in a stationary disposition with respect to at least one of the base units and then to emit counter electromagnetic waves. Therefore, the counter waves are arranged to have phase angles which are at least partially opposite to those of the harmful waves, to have wave characteristics at least partially similar to those of such harmful waves while staying in the disposition and, therefore, to counter the harmful waves in the target space due to the phase angles.

In another exemplary embodiment of this aspect of the invention, a speaker system may have at least one first piezo plate, at least two first electrodes, at least one first metal plate, and at least one counter unit which is arranged to be in a mobile disposition with respect to at least one of such base units and to emit counter electromagnetic waves. Accordingly, such counter waves are arranged to define phase angles at least partially opposite to the harmful waves, to have wave characteristics at least partially similar to those of such harmful waves while moving with respect to the base unit and, therefore, to counter the harmful waves in the target space due to the phase angles.

In another aspect of the present invention, a speaker system may also be provided for emitting counter electromagnetic waves and countering harmful electromagnetic waves which are irradiated by multiple base units of at least one wave source of the system with the counter waves by matching at least one wavefront of such harmful waves with the counter waves and further by canceling the harmful waves by the counter waves in a target space and/or suppressing the harmful waves by the counter waves from propagating to the target space, where the base units are arranged to represent only portions of the wave source responsible for irradiating the harmful waves and affecting paths of the harmful waves therethrough and where the target space is defined between such a system and at least one body part of an user of the system.

In one exemplary embodiment of this aspect of the invention, a speaker system may include at least one first piezo plate, at least two first electrodes, at least one first metal plate, and at least one counter unit which is arranged to be in a preset arrangement along at least one of the wavefronts and to emit the counter waves. Accordingly, such counter waves are arranged to have phase angles at least partially opposite to those of the harmful waves, to at least partially match the wavefronts of the harmful waves due to such an arrangement and, therefore, to counter the harmful waves in the target space due to the phase angles in the target space, where these counter waves will be referred to as the “fourth counter waves” hereinafter.

In another exemplary embodiment of this aspect of the invention, such a speaker system may include at least one first piezo plate, at least two first electrodes, at least one first metal plate, and at least one counter unit. In one example, the system includes a single counter unit which is arranged to be disposed in a front arrangement and along at least one of such wavefronts, and to emit the fourth counter waves defining amplitudes less than those of the harmful waves, where the counter unit is disposed between the target space and at least two of the base units in such a front arrangement. In another example, the system includes multiple counter units each of which is arranged to be disposed in such a front arrangement and along at least one of the wavefronts, and to emit such fourth counter waves with amplitudes less than those of the harmful waves, where the counter units are disposed between the target space and at least two of the base units in such a front arrangement.

In another exemplary embodiment of this aspect of the invention, such a speaker system may include at least one first piezo plate, at least two first electrodes, at least one first metal plate, and at least one counter unit. In one example, the system includes a single counter unit which is arranged to be disposed in a rear arrangement and to emit the fourth counter waves with amplitudes greater than those of the harmful waves, where such a counter unit is disposed on an opposite side of the target space with respect to the base unit in the rear arrangement. In another example, the system includes multiple counter units each of which is arranged to be disposed in a rear arrangement and to emit the fourth counter waves having amplitudes greater than those of the harmful waves, where the counter units are disposed on an opposite side of the target space with respect to the base units in the rear arrangement.

In another aspect of the present invention, a speaker system may also be provided for emitting counter electromagnetic waves and countering harmful electromagnetic waves which are irradiated by multiple base units of at least one wave source of the system with the counter waves by matching at least one of multiple wavefronts of the harmful waves with such counter waves and by canceling the harmful waves by the counter waves in a target space and/or suppressing such harmful waves from propagating to the target space with the counter waves, where such base units are arranged to represent only portions of the wave source which are responsible for irradiating the harmful waves and affecting paths of the harmful waves therethrough, while the target space is formed between the system and at least one body part of an user thereof.

In another exemplary embodiment of this aspect of the invention, such a speaker system may include at least one first piezo plate, at least two first electrodes, at least one first metal plate, and at least one counter unit. In one example, the system includes a single counter unit which is arranged to be disposed closer to the target space than such base units, to be aligned along only one (or at least two) of the wavefronts, and to emit the counter waves. In another example, such a system includes multiple counter units at least two of which are arranged to be disposed closer to such a target space than the base units, to be arranged along only one (or at least two) of the wavefronts, and to emit the fourth counter waves. In another example, the system has a single counter unit which is arranged to be disposed farther away from the target space than at least one of such base units, to be disposed based upon an arrangement inverse to only one (or at least two) of the wavefronts, and to emit such fourth counter waves. In another example, the system includes multiple counter units at least two of which are arranged to be disposed farther from the target space than the base units, to be disposed in an arrangement inverse to only one (or at least two) of the wavefronts, and then to emit the fourth counter waves.

In another exemplary embodiment of this aspect of the invention, a speaker system may have at least one first piezo plate, at least two first electrodes, at least one first metal plate, and at least one counter unit. In one example, the system includes a single counter unit which is arranged to define a dimension larger (or smaller) than a dimension of at least one of the base units, to be also disposed between the target space and at least one of the base units in an arrangement matching only one (or at least two) of the wavefronts, and then to emit such fourth counter waves. In another example, the system includes multiple counter units at least two of which are arranged to define dimensions which is larger (or smaller) than a dimension of at least one of such base units, to be disposed between at least one of the base units and target space in an arrangement matching only one (or at least two) of the wavefronts, and to emit the fourth counter waves.

In another exemplary embodiment of this aspect of the invention, a speaker system may have at least one first piezo plate, at least two first electrodes, at least one first metal plate, and at least one counter unit. In one example, the system has a single counter unit which is disposed between at least two of the base units and target space in an arrangement similar (or identical, conforming) to only one (or at least two) of the wavefronts, and to emit the fourth counter waves. In another example, such a system includes a single counter unit which is arranged to be incorporated on an opposite side of the target space with respect to the base units in an arrangement similar (or identical, conforming) to only one (or at least two) of the wavefronts, and to emit such fourth counter waves. In another example, the system includes multiple counter units at least two of which are arranged to be disposed between the target space and at least two of the base units in an arrangement similar (or identical, conforming) to only one (or at least two) of the wavefronts, and then to emit the fourth counter waves. In another example, the system includes multiple counter units at least two of which are arranged to be disposed on an opposite side of the target space with respect to such base units in an arrangement similar (or identical, conforming) to only one (or at least two) of such wavefronts, and to emit the fourth counter waves.

In another exemplary embodiment of this aspect of the invention, such a speaker system may have at least one first piezo plate, at least two first electrodes, at least one first metal plate, as well as at least one counter unit. In one example, such a counter unit is arranged to have a shape similar (or identical, conforming) to that of at least one of the wavefronts, to be disposed between such a target space and at least two of such base units in an arrangement which is not similar (or not identical, not conforming) to at least one of the wavefronts and then to emit the fourth counter waves. In another example, the counter unit is arranged to define a shape similar (or identical, conforming) to that of at least one of the wavefronts, to be disposed on an opposite side of the target space with respect to at least two of the base units based on an arrangement not similar (or not identical, not conforming) to at least one of the wavefronts, and to emit such fourth counter waves. In another example, the counter unit is arranged to define a shape not similar (or not identical, not conforming) to that of at least one of such wavefronts, to be disposed between the target space and at least two of such base units in an arrangement not similar (or not identical, not conforming) to at least one of the wavefronts, and to emit the fourth counter waves. In another example, such a counter unit is arranged to define a shape not similar (or not identical, not conforming) to that of at least one of the wavefronts, to be disposed on an opposite side of the target space with respect to at least two of the base units in an arrangement not similar (or not identical, not conforming) to at least one of the wavefronts, and then to emit the fourth counter waves.

In another exemplary embodiment of this aspect of the invention, a speaker system may have at least one first piezo plate, at least two first electrodes, at least one first metal plate, and at least one counter unit. In one example, the counter unit is arranged to be disposed in an arrangement enclosing only one (or at least two) of the wavefronts therein and to emit the fourth counter waves. In another example, the counter unit is arranged to be disposed in an arrangement enclosed by at least a (or an entire) portion of only one (or at least two) of the wavefronts, and to emit such fourth counter waves. In another example, the counter unit is arranged to be disposed in a lateral arrangement (or a side-by-side arrangement) with respect to at least a (or an entire) portion of only one (or at least two) of the wavefronts, and to emit the fourth counter waves.

In another exemplary embodiment of this aspect of the invention, a speaker system may have at least one first piezo plate, at least two first electrodes, at least one first metal plate, and at least one counter unit. In one example, such a counter unit is arranged to emit the fourth counter waves while being disposed along only one (at least two) of the wavefronts in an arrangement of a wire, a strip, a sheet, a tube, a coil, a spiral, a mesh, a mixture thereof, a combination thereof, and/or an array thereof and also disposed between at least one of the base units and target space. In another example, the counter unit is arranged to emit the counter waves while being disposed along only one (at least two) of the wavefronts in another arrangement of a wire, a strip, a sheet, a tube, a coil, a spiral, a mesh, a mixture thereof, a combination thereof, and/or an array thereof and also disposed on an opposite side of the target space with respect to the base unit.

In another exemplary embodiment of this aspect of the invention, such a speaker system may include at least one first piezo plate, at least two first electrodes, at least one first metal plate, and at least two counter units each of which is arranged to disposed in an arrangement defined on a far side of the target space with respect to at least one of such base units and to emit the fourth counter waves such that a sum of the counter waves individually emitted by the counter units forms multiple wavefronts of greater radii of curvature than the wavefronts of the individual counter waves.

In another aspect of the present invention, a speaker system may also be provided for emitting counter electromagnetic waves and countering harmful electromagnetic waves irradiated by multiple base units of at least one wave source with the counter waves and also define multiple wavefronts by matching at least one of the wavefronts of the harmful waves with the counter waves and also by canceling the harmful waves in a target space by the counter waves and/or suppressing the harmful waves from propagating toward the target space with the counter waves, where the base units are arranged to represent only portions of the wave source responsible for irradiating the harmful waves and for affecting paths of the harmful waves therethrough, while the target space is defined between the system and at least one body part of an user.

In another exemplary embodiment of this aspect of the invention, a speaker system may have at least one first piezo plate, at least two first electrodes, at least one first metal plate, and at least one counter unit. In one example, the system includes a single counter unit which is arranged to define a configuration matching that of only one of the base units and to emit counter electromagnetic waves. In another example, the system includes multiple counter units disposed in an arrangement matching a configuration of only one of the base units and to emit counter electromagnetic waves. Whereby and in both examples, the counter waves are arranged to define phase angles at least partially opposite to those of the harmful waves, to at least partially match at least a portion of such harmful waves due to the configuration, and to counter the harmful waves in the target space due to the phase angles.

In another exemplary embodiment of this aspect of the invention, a speaker system may have at least one first piezo plate, at least two first electrodes, at least one first metal plate, and at least one counter unit. In one example, the system includes a single counter unit which is arranged to define a configuration which matches an arrangement of at least two but not all of such base units and then to emit counter electromagnetic waves. In another example, the system has a single counter unit which is arranged to define a configuration which matches an arrangement of all of the base units and then to emit counter electromagnetic waves. In another example, the system includes multiple counter units at least two (or all) of which are arranged to be in an arrangement which matches an arrangement of at least two but not all of such base units and then to emit counter electromagnetic waves. In another example, the system includes multiple counter units at least two (or all) of which are arranged to be in an arrangement matching an arrangement of all of the base units and to emit counter electromagnetic waves. Whereby and in each of such examples, such counter waves are arranged to define phase angles at least partially opposite to those of such harmful waves, to at least partially match at least a portion of the harmful waves due to the configuration, and to counter the harmful waves in the target space due to the phase angles.

In another exemplary embodiment of this aspect of the invention, a speaker system may have at least one first piezo plate, at least two first electrodes, at least one first metal plate, and at least one counter unit. In one example, the system includes a single counter unit which is arranged to define a preset shape, to be disposed in a preset arrangement with respect to at least one of such base units, and then to emit counter electromagnetic waves, where the shape and/or arrangement is arranged to match only one (or at least two) of the wavefronts of the harmful waves. In another example, such a system includes multiple counter units at least two (or all) of which are also arranged to have a preset overall shape, to be disposed in a preset arrangement with respect to at least one of such base units, and then to emit counter electromagnetic waves, where the shape and/or arrangement is arranged to match only one (or at least two) of such wavefronts of the harmful waves. Whereby and in each of the examples, the counter waves are arranged to define multiple wavefronts at least one of which is similar (or identical) to at least one of such wavefronts of the harmful waves due to the shape and/or arrangement, to have phase angles at least partially opposite to those of the harmful waves and, thus, to counter the harmful waves in the target space due to the opposite phase angles.

In another exemplary embodiment of this aspect of the invention, a speaker system may have at least one first piezo plate, at least two first electrodes, at least one first metal plate, and at least one counter unit. In one example, the system has a single counter unit shaped, sized, and/or disposed to emit counter electromagnetic waves which matches only one (or at least two) of such wavefronts of the harmful waves irradiated from only one of the base units. In another example, such a system has multiple counter units shaped, sized, and/or disposed to emit counter electromagnetic waves a sum of which is arranged to match only one (or at least two) of the wavefronts of the harmful waves which are irradiated from only one of the base units. Whereby and in each of these examples, such counter waves are arranged to define multiple wavefronts at least one of which is similar (or identical) to at least one of the wavefronts of the harmful waves due to a shape, a size, and/or a disposition of such a counter unit, to define phase angles at least partially opposite to those of such harmful waves and, therefore, to counter the harmful waves in the target space due to the phase angles.

In another exemplary embodiment of this aspect of the invention, a speaker system may have at least one first piezo plate, at least two first electrodes, at least one first metal plate, and at least one counter unit. In one example, such a system has a single counter unit shaped, sized, and/or disposed to emit counter electromagnetic waves which match only one (or at least two) of the wavefronts of a sum of the harmful waves irradiated by at least two of the base units. In another example, the system includes multiple counter units shaped, sized, and/or disposed to emit the counter waves which match only one (or at least two) of the wavefronts of a sum of the harmful waves irradiated by at least two of the base units. Whereby and in each of such examples, the counter waves are arranged to define multiple wavefronts at least one of which is similar (or identical) to at least one of such wavefronts of the harmful waves due to a shape, a size, and/or a disposition of such a counter unit, to define phase angles at least partially opposite to those of the sum of the harmful waves and, therefore, to counter the harmful waves in the target space due to the phase angles.

In another aspect of the present invention, a speaker system may also be provided for emitting counter electromagnetic waves which have multiple wavefronts and which are capable of countering harmful electromagnetic waves irradiated from multiple base units of at least one wave source with at least one of the wavefronts of the counter waves by canceling the harmful waves in a target space with the counter waves and/or suppressing such harmful waves from propagating toward the target space by the counter waves, where the base units are arranged to include only portions of the wave source which are responsible for irradiating the harmful waves and for affecting paths of the harmful waves therethrough, while the target space is formed between the system and at least one body part of an user.

In one exemplary embodiment of this aspect of the invention, such a speaker system may have at least one first piezo plate, at least two first electrodes, at least one first metal plate, and at least one counter unit which is arranged to define a preset shape and a preset size, to be disposed in a preset arrangement along at least a portion of only one (or at least two) of such wavefronts, and then to emit counter electromagnetic waves having phase angles at least partially opposite to those of the harmful waves, matching only one (or at least two) of the wavefronts of the harmful waves and, accordingly, countering the harmful waves in the target space due to the phase angles.

In another exemplary embodiment of this aspect of the invention, such a speaker system may include at least one first piezo plate, at least two first electrodes, at least one first metal plate, multiple counter units, and so on. In one example, the counter units are arranged to be in a disposition which is defined between at least two of such base units and target space, to be in an arrangement which conforms to at least a portion of only one (or at least two) of such wavefronts of the harmful waves, and to emit counter electromagnetic waves. In another example, the counter units are arranged to be in a disposition defined on an opposite side of the target space with respect to the base units, to be in an arrangement at least partially inverse to only one (or at least two) of the wavefronts of the harmful waves, and to emit counter electromagnetic waves. Whereby and in each of the examples, a sum of the counter waves which are emitted by at least two of the counter units is arranged to define phase angles which are at least partially opposite to those of the harmful waves, to match at least one of the wavefronts of the harmful waves based on the arrangement and/or disposition and, thus, to counter the harmful waves in the target space due to the phase angles.

In another aspect of the present invention, a speaker system may include at least one speaker which includes multiple base units irradiating harmful electromagnetic waves and which is capable of countering the harmful waves by suppressing the harmful waves from propagating to a target space and/or canceling the harmful waves in the target space, where the base units are arranged to include only portions of the speaker responsible for irradiating the harmful waves and affecting paths of such harmful waves therethrough and where the target space is defined between the system and at least one body part of an user.

In one exemplary embodiment of this aspect of the invention, a system may include at least one piezoelectric plate (or simply a “piezo plate” hereinafter), at least two electrodes, at least one counter units, and the like. Such a piezo plate is arranged to convert source voltage to vibration thereof while serving as one of the base units during the vibration. The electrodes are then arranged to electrically couple with opposite sides of the piezo plate, to supply the source voltage across the piezo plate, and to vibrate along with the piezo plate while emitting the harmful waves in response to the source signal and serving as another of the base units. In one example, such a counter unit is arranged to define a configuration identical (or similar) to the piezo plate or electrodes and to emit counter electromagnetic waves defining phase angles at least partially opposite to those of the harmful waves, defining wave characteristics at least partially similar to those of the harmful waves due to such a configuration and, accordingly, countering such harmful waves in the target space due to the phase angles. In another example, the counter unit is arranged to have a configuration which is different from both of the piezo plate and electrodes, to be in a preset arrangement, and to emit counter electromagnetic waves which define phase angles which are at least partially opposite to those of the harmful waves, which define wave characteristics at least partially similar to those of such harmful waves due to the arrangement and, accordingly, counter the harmful waves in the target space due to the phase angles. In another example, the counter unit is arranged to be disposed in an arrangement defined along only one (or at least two) of multiple wavefronts of such harmful waves and to emit counter electromagnetic waves having phase angles which are at least partially opposite to those of the harmful waves, having wave characteristics at least partially similar to those of the harmful waves based on the arrangement and, accordingly, countering such harmful waves in the target space due to the phase angles. In another example, such a counter unit is arranged to be disposed in an arrangement which is at least partially inverse to only one (or at least two) of multiple wavefronts of the harmful waves and to emit counter electromagnetic waves having phase angles at least partially opposite to those of the harmful waves, defining wave characteristics which are at least partially similar to those of the harmful waves due to the arrangement and, therefore, countering the harmful waves in the target space due to the phase angles.

In another exemplary embodiment of this aspect of the invention, a system may include at least one frame, at least one speaker, and at least one counter unit. The frame is arranged to be disposed over an ear of the user or into an ear canal thereof, while the speaker is arranged to be supported by the frame and to include the base units for irradiating the harmful waves. In one example, the counter unit is arranged to define a configuration identical (or similar) to at least one of the base units of such a speaker and to emit counter electromagnetic waves defining phase angles at least partially opposite to those of the harmful waves, having wave characteristics at least partially similar to those of such harmful waves due to the configuration and, thus, countering such harmful waves in the target space due to the phase angles. In another example, such a counter unit is arranged to define a configuration which is different from the base units of the speaker, to be in a preset arrangement, and then to emit counter electromagnetic waves having phase angles at least partially opposite to those of the harmful waves, having wave characteristics at least partially similar to those of the harmful waves due to the arrangement and, thus, countering the harmful waves in the target space due to the phase angles. In another example, such a counter unit is arranged to be disposed in an arrangement defined along only one (or at least two) of multiple wavefronts of the harmful waves and to emit counter electromagnetic waves defining phase angles at least partially opposite to those of the harmful waves, defining wave characteristics at least partially similar to those of such harmful waves due to the arrangement and, thus, countering the harmful waves in the target space due to the phase angles. In another example, the counter unit is arranged to be disposed in an arrangement which is at least partially inverse to only one (or at least two) of multiple wavefronts of the harmful waves and to emit counter electromagnetic waves having phase angles at least partially opposite to those of the harmful waves, defining wave characteristics at least partially similar to those of such harmful waves due to such an arrangement and, therefore, countering the harmful waves in the target space due to the phase angles.

In another aspect of the present invention, a communication system may include multiple base units irradiating harmful electromagnetic waves and also capable of countering the harmful waves by canceling the waves in a target space and/or suppressing the harmful waves from propagating to the target space, where such base units are arranged to include only portions of the system responsible for irradiating the harmful waves and affecting paths of the harmful waves therethrough and where the target space is defined between at least one body part of an user and the system.

In one exemplary embodiment of this aspect of the invention, a system may include a frame, a handset, at least one input module, at least one output module, and at least one counter unit. Such a handset is arranged to be electrically connected to the frame by a wire. The input module is arranged to be disposed in the handset, to have at least one microphone, and to convert audible sounds of the user into output signals while serving as one of the base units and irradiating the harmful waves. The output module is arranged to be disposed in the handset, to have at least one speaker, and to convert an external source signal into audible sound while serving as another of the base units and irradiating the harmful waves. In one example, the counter unit is arranged to define a configuration similar (or identical) to at least one of the base units of the modules, to be in a preset disposition with respect to at least one of the base units, and to emit counter electromagnetic waves which have phase angles at least partially opposite to those of the harmful waves, define wave characteristics at least partially similar to those of the harmful waves due to the configuration and disposition and, therefore, counter the harmful waves in the target space due to the phase angles. In another example, the counter unit is arranged to define a configuration different from the base units of such modules, to be in a preset disposition with respect to at least one of the base units, and to emit counter electromagnetic waves which define phase angles at least partially opposite to those of the harmful waves, also have wave characteristics which are at least partially similar to those of the harmful waves due to the disposition and, accordingly, counter the harmful waves in the target space due to the phase angles. In another example, the counter unit is arranged to be disposed in an arrangement defined along only one (or at least two) of multiple wavefronts of such harmful waves and to emit counter electromagnetic waves which define phase angles which are at least partially opposite to those of the harmful waves, have wave characteristics at least partially similar to those of such harmful waves due to the arrangement and, accordingly, counter the harmful waves in the target space due to the phase angles. In another example, such a counter unit is arranged to be disposed in an arrangement which is at least partially inverse to only one (or at least two) of multiple wavefronts of the harmful waves and to emit counter electromagnetic waves having phase angles at least partially opposite to those of the harmful waves, defining wave characteristics which are at least partially similar to those of the harmful waves due to the arrangement and, therefore, countering the harmful waves in the target space due to the phase angles.

In another exemplary embodiment of this aspect of the invention, such a system may include a handset, at least one input module, at least one transmitting module, at least one receiving module, and at least one counter unit. The input module is arranged to be disposed in the handset, to have at least one microphone, and to convert audible sounds of the user into output signals while serving as one of such base units and irradiating the harmful waves. The transmitting module is arranged to wirelessly transmit the output signals, and the receiving module is arranged to wirelessly receive source signals. The output module is arranged to be disposed in the handset, to include at least one speaker therein, and to convert the source signals into audible sound while serving as another of the base units and irradiating the harmful waves. In one example, the counter unit is arranged to define a configuration similar (or identical) to at least one of the base units of the modules, to be in a preset disposition with respect to at least one of the base units, and then to emit counter electromagnetic waves which have phase angles at least partially opposite to those of the harmful waves, define wave characteristics at least partially similar to those of the harmful waves due to the configuration and disposition and, thus, counter such harmful waves in the target space due to the phase angles. In another example, such a counter unit is arranged to define a configuration different from the base units of the modules, to be in a preset disposition with respect to at least one of the base units, and to emit counter electromagnetic waves having phase angles at least partially opposite to those of the harmful waves, defining wave characteristics at least partially similar to those of such harmful waves due to such a disposition and, thus, counter the harmful waves in the target space due to the phase angles. In another example, the counter unit is arranged to be disposed in an arrangement defined along only one (or at least two) of multiple wavefronts of the harmful waves and to emit counter electromagnetic waves which define phase angles at least partially opposite to those of the harmful waves, have wave characteristics at least partially similar to those of the harmful waves due to the arrangement and, accordingly, counter the harmful waves in the target space due to the phase angles. In another example, the counter unit is arranged to be disposed in an arrangement which is at least partially inverse to only one (or at least two) of multiple wavefronts of the harmful waves and to emit counter electromagnetic waves having phase angles at least partially opposite to those of the harmful waves, defining wave characteristics which are at least partially similar to those of such harmful waves due to such an arrangement and, therefore, countering the harmful waves in the target space due to the phase angles.

Embodiments of such system aspects of the present invention may include one or more of the following features, and configurational and/or operational variations and/or modifications of the above systems also fall within the scope of the present invention.

At least a (or an entire) portion of at least one of such base units may be exposed through the wave source or may be disposed inside the wave source. The base units may include a wire, a strip, a sheet, a plate, and/or a ring each of which may be made of and/or include at least one conductive, semiconductive or insulative material. At least one of the base units may include an insert made of at least one ferromagnetic material.

The system may be any electric devices including at least one piezoelectric speaker capable of converting audible sounds into electric and/or optical signals, where examples of the devices may include, but not be limited to earphones, headphones, handsets of phones, mobile phones, assemblies of the microphones and speakers, CD players, mp3 players, DVD players, audio devices, audiovisual devices, and so on. Such a device including the speaker may include at least two identical (or similar, different) speakers enclosed inside a single case member, at least two identical (or similar, different) speakers which are separately enclosed inside different case members, a pair of earphones, a pair of headphones, an assembly of the speaker and microphone, and so on. Such a system may be any electric devices including at least one mechanism which may convert electric and/or optical signals to audible sounds, where examples of such a device may be, but not be limited to, microphones, where such signals may be electrical signals, optical signals, magnetic signals, and the like.

Such harmful waves may include carrier-frequency waves having frequencies less than from about 50 Hz to 60 Hz, extremely low-frequency waves of frequencies less than 300 Hz, other waves defining frequencies less than 1 kHz, 10 kHz, 100 kHz, 1 MHz, 10 MHz, 100 MHz, 1 GHz, 10 GHz, 100 GHz, 1 THz, and the like, where the counter waves may be arranged to have similar frequencies. The harmful waves may include ultra low-frequency waves with frequencies less than 3 kHz, very low-frequency waves defining frequencies less than 30 kHz, low-frequency waves having frequencies less than 300 kHz, and so on, while the counter waves may be arranged to have similar frequencies. Such a target space may be formed on one side of the counter unit and at least one of the base units, around a preset angle around the counter unit or at least one of the base units, between the counter unit and at least one of the base units, and the like. The countering may include the canceling and/or the suppressing.

The counter unit may include at least one electric conductor in which the current may flow, at least one electric conductor, semiconductor or insulator across which the voltage may be applied, and the like. The counter unit may be disposed side by side with at least one of the base units, may wind around at least one of the base units along a preset length, may concentrically enclose at least one of the base units, may be enclosed by or within at least one of such base units, may be axially disposed along at least one of the base units, and the like. The counter unit may be spaced from at least one of the base units at a preset distance, may mechanically, electrically, and/or magnetically couple with at least one of the base units, may form an unitary article with at least one of the base units, and the like. The counter unit may be retained by at least one support and may maintain its shape while emitting the harmful waves or, alternatively, may vary its shape while emitting such counter waves. The counter unit may include at least one ferromagnetic insert disposed therethrough.

The configuration and/or disposition of the counter unit may be determined based on whether the counter unit is to match the configuration of at least one of the base units (or wave source) or to match at least one of the wavefronts of the harmful waves from such base units (or wave source). The counter unit may define the shape identical to, similar to or different from that of at least one of the base units (or wave source). The counter unit may define a shape of the wire, strip, sheet, tube, coil, spiral, mesh, mixture of at least one of the shapes, combination thereof, and/or array thereof, where the array may include a bundle of at least two of such shapes, a braid thereof, a coil thereof, a mesh thereof, and the like. The shape of the counter unit may (or not) conform to that of at least one of the base units (or wave source). The counter unit may form the 1-D, 2-D, and/or 3-D analogs of at least one of the base units (or wave source). The counter unit may define only one of such analogs or at least two of the analogs. The counter units may define only one of the analogs or at least two of the analogs. The analog may maintain a similarity with at least one of such base units (or wave source). The analogs may maintain a similarity with at least one of the base units (or wave source). At least two portions of the counter unit and/or at least two counter units may also define the same shape of different sizes, different shapes of similar or different sizes, and the like. The counter unit may have at least substantially uniform shape and/or size along at least a substantial portion thereof along its longitudinal axis, may have the shape and/or size varying along the portion and/or axis, and the like.

The size of the counter unit may (or may not) conform to that of at least one of the base units (or wave source). Such counter units may be disposed in the arrangement which may be identical to, similar to or different from the shape of one of the base units (or wave source) and/or arrangement of at least two of the base units (or wave sources). Such counter units may further be disposed in an arrangement which conforms (or not) to the shape of one of the base units (or wave source), to the arrangement of at least two of the base units (or wave sources), and the like. The counter units may be disposed in a symmetric (or asymmetric) arrangement with respect to each other and/or to at least one of such base units (or wave source). The counter unit may be aligned with (or misaligned from) the direction of propagation of the harmful waves, the direction of the electric current and/or voltage, the longitudinal axis of at least one of the base units (or wave source), the short axis of at least one of the base units (or wave source), and the like. All of (or only some of, one of, none on the counter units may be aligned with (or misaligned from) at least one of the directions and/or axes. The counter unit and at least one of such base units may be disposed at an identical (or similar) distance from the target space. At least a portion of the counter unit and/or at least one of the base units may also be disposed in another of the units or, alternatively, the counter unit and at least one of such base units may be axially disposed along a single common axis of at least two of the counter and/or base units, and the like. Such counter units may be disposed angularly around the longitudinal axis, and may also be movably or stationarily disposed closer to (or farther from) the target space than at least one of the base units (or wave source). The counter unit and at least one of the base units may be disposed on the same side of the target space or, alternatively, the units may be disposed on opposite sides of the target space. The counter unit may conform to at least one of the base units or, in the alternative, the counter units may conform to at least one of the base units, and the like.

The counter unit may be disposed on an exterior, disposed on an interior, and/or embedded in at least one of the base units (or wave source). The counter unit may be disposed on, in or inside a case member of the system. The counter unit and at least one of the base units may also be made of and/or have at least one common material, may be made of and/or include identical materials, or may not include any common material. The counter unit may directly couple with the case member, at least one of the base units, and/or other parts of the system or, in the alternative, may be indirectly coupled thereto through at least one coupler. Such a counter unit may be arranged to emit the counter waves with a least amount of material, while consuming a least amount of the current and/or voltage.

The base units may also be supplied with source current and/or voltage, where the current or voltage may be supplied to the counter unit as counter current or voltage, where only a portion of the source current or voltage may then be supplied to the counter unit as the counter current or voltage, where amplitude and/or direction of at least a portion of the source current or voltage may be altered and supplied to the counter unit as the counter current or voltage, where external current or voltage may first be synchronized with the source current or voltage, and supplied to the counter unit as the counter current or voltage, and the like. The counter units may also be supplied with identical counter currents or voltages, with different counter currents or voltages, and the like. The counter unit and at least one of the base units may electrically couple with each other in a series mode, in a parallel mode or in a hybrid mode or, alternatively, may not be directly coupled to each other. The counter units may be electrically coupled to each other in a series mode, in a parallel mode or in a hybrid mode or, in the alternative, may not be directly coupled to each other. All (or only some) of such counter units may be electrically coupled to at least one of the base units in the same mode or, in the alternative, none of the counter units may electrically couple to at least one of the base units in the same mode. Such counter waves may define amplitudes which may be greater than, similar to or less than those of the harmful waves depending upon the disposition thereof with respect to at least one of the base units. Such a counter unit and at least one of such base units may define substantially identical, similar or different resonance frequencies or, in the alternative, may instead have identical, similar or different resonance frequencies. At least a portion of a single counter unit and/or at least one of the multiple counter units may define resonance frequencies which are different from those of the rest thereof. The base units may receive the energy through two electric contacts provided in one of such electrodes and in such a metal plate. At least one of the electrodes may define at least two electrically separated portions, to define at least one electric contact in each of such portions, and receive the energy through at least three electric contacts at least two of which are provided in the at least one of the electrodes and at least one of which is formed in the metal plate. The counter unit may also define at least two electric contacts which may be incorporated in locations similar to those for the electric contacts of the base units.

The system may include at least one of the magnetic shields described hereinabove, where the magnetic shields may be disposed in, on, over, around, and/or through at least one of the counter and/or base units. The magnetic shields may define shapes which may at least partially conform to the shapes of the counter and/or base units or, in the alternative, may define shapes which may be at least partially different from shapes of the counter and/or base units. Such a magnetic shield may have at least one path member of a relative magnetic permeability greater than 1,000, 10,000, 100,000 or 1,000,000. The magnetic shield may have at least one magnet member with at least one South pole. The magnetic shield may include at least one shunt member which may directly or indirectly couple with the magnet member, where the shunt member may have the relative magnetic permeability which may be greater than 1,000, 10,000, 100,000 or 1,000,000. The magnetic shield described hereinabove may also be incorporated to any of the devices described above. The system may also include at least one of the electric shields described above, where such electric shields may be incorporated into any of the devices described hereinabove.

The magnetic and/or electric shields may form shapes and/or sizes which may be maintained uniform along the longitudinal axis of such counter and/or base units or which may vary therealong. The shapes and/or sizes of the magnetic and/or electric shields may also be identical to, similar to or different from those of the counter and/or base units. Such a system may include multiple magnetic and/or electric shields. At least two of such magnetic and/or electric shields may shield against the magnetic waves and/or electric waves of the harmful waves with same or different frequencies in same or different extents. The magnetic and/or electric shields may also be disposed over at least a portion (or entire portion) of the counter and/or base units.

In another aspect of the present invention, a method may be provided for countering harmful electromagnetic waves which are irradiated from multiple base units of at least one wave source of a piezoelectric speaker by emitting counter electromagnetic waves, by adjusting shapes of the counter waves, and by suppressing the harmful waves from propagating to a target space and/or canceling the harmful waves inside the target space, where the base units are arranged to include at least one piezoelectric plate of such a speaker, at least two electrodes thereof, and at least one portion thereof which are responsible for irradiating the harmful waves and for affecting paths of the harmful waves therethrough, where the target space is formed between the speaker and its user, where the counter waves include at least one first wavefront, and where the harmful waves have at least one second wavefront.

In one exemplary embodiment of this aspect of the invention, a method may have the steps of: providing at least one counter unit capable of emitting the counter waves (which will be referred to as the “first providing” hereinafter); extending the counter unit to be wider (or longer) than at least one of the base units; disposing the counter unit between the user and the base units while aligning its width (or length) with at least a portion of the second wavefront; and emitting the counter waves which are aligned with and similar to the harmful waves due to the extending and disposing, thereby countering the harmful waves in the target space. The above extending and disposing may be replaced by the steps of: extending the counter unit to be narrower (or shorter) than the wave source; and disposing the counter unit on an opposite side of the target space with respect to the base units while aligning its width (or length) with at least a portion of the second wavefront.

In another exemplary embodiment of this aspect of the invention, a method may have the steps of: providing a single counter unit for emitting such counter waves; assessing at least one location in the target space in which at least a portion of the first wavefront may match at least a portion of the second wavefront; and disposing the counter unit in the location to emit the counter waves, thereby countering the harmful waves with the counter waves in the target space.

In another exemplary embodiment of this aspect of the invention, a method may have the steps of: providing at least two counter units each emitting the counter waves; emitting by the counter units the counter waves which define similar (or identical) phase angles and which form a first sum of the first wavefronts of the counter waves from the counter units; finding a relation between a distance between the counter units and an increase in a radius of curvature of the first wavefront of the first sum; selecting the distance between the counter units for a preset radius of curvature; assessing at least two locations for the counter units in the target space in which at least a portion of the first sum matches at least a portion of the second wavefront; and disposing the counter units in such locations spaced by the distance, thereby countering the harmful waves with the counter waves in the target space. The above emitting and finding may be replaced by the steps of: emitting by the counter units the counter waves defining at least partially opposite phase angles and forming a first sum of the first wavefronts of the counter waves by the counter units; and then finding a relation between a distance between the counter units and a decrease in a radius of curvature of the first wavefront of the first sum.

In another aspect of the present invention, a method may be provided for countering harmful electromagnetic waves irradiated by multiple base units of at least one wave source of a piezoelectric speaker by matching at least one feature of the base units and by suppressing such harmful waves from propagating toward a target space and/or canceling the harmful waves in such a target space, where the base units are arranged to include at least one piezoelectric plate of the speaker, at least two electrodes thereof, and at least one portion thereof responsible for irradiating the harmful waves and affecting paths of the harmful waves therethrough, where the target space is defined between the source and its user, and where the feature includes a shape, a size, and/or an arrangement.

In one exemplary embodiment of this aspect of the invention, a method may have the steps of: providing at least one counter unit capable of emitting counter electromagnetic waves; configuring the counter unit to match the feature of the base units; emitting such counter waves similar to the harmful waves due to such configuring; and disposing the counter unit in a location for matching the harmful waves in such a target space with the counter waves, thereby countering the harmful waves by the counter waves therein. The above configuring g may be replaced by one of the steps of: configuring the counter unit to define a configuration simpler than that of such base units while at least minimally maintaining the feature; configuring the counter unit to have a configuration more complex than that of the base units while at least minimally maintaining the feature; configuring the counter unit to define a dimension which is defined by a less number of unit axes than such base units while at least minimally maintaining the feature; configuring the counter unit to have a dimension which is defined by a greater number of unit axes than that of the base units while at least minimally maintaining the feature, and the like.

In another exemplary embodiment of this aspect of the invention, a method may have the steps of: providing a single counter unit capable of emitting counter electromagnetic waves; configuring the counter unit to define a configuration simpler than that of only one of the base units while maintaining the feature; emitting the counter waves similar to the harmful waves due to the configuring; and then disposing the counter unit in a location for matching the harmful waves in such a target space by the counter waves, thereby countering such harmful waves by such counter waves in the target space. Such configuring may be replaced by one of the steps of: configuring such a counter unit to define a configuration similar (or identical) to an arrangement of at least two of the base units while maintaining the feature; configuring the counter unit to have a dimension formed by less mutually orthogonal unit axes than an arrangement of at least two of the base units while maintaining the feature; configuring the counter unit to define a dimension which is formed by more mutually orthogonal unit axes than a dimension of at least two of the base units while maintaining the feature, and the like.

In another exemplary embodiment of this aspect of the invention, a method may have the steps of: providing multiple counter units for emitting counter electromagnetic waves; arranging at least two of the counter units in a configuration simpler than that of only one of the base units while maintaining the feature; emitting the counter waves similar to the harmful waves due to the configuring; and then disposing such counter units in locations for matching the harmful waves in the target space with the counter waves, thereby countering the harmful waves by such counter waves therein. The above arranging may also be replaced by one of the steps of: arranging at least two of the counter units in a configuration which is similar (or identical) to an arrangement of at least two of such base units while maintaining the feature; arranging the counter units in an arrangement defining a dimension formed by less mutually orthogonal unit axes than a dimension of at least one of the base units while maintaining the feature; and arranging the counter units in an arrangement defining a dimension formed by more mutually orthogonal unit axes than a dimension of at least one of the base units while maintaining the feature.

In another exemplary embodiment of this aspect of the invention, a method may have the steps of: providing a smaller number of the counter units for a greater number of the base units; arranging the counter units while approximating an arrangement of the base units and maintaining the feature; emitting the counter waves similar to the harmful waves due to the arranging; and then disposing the counter unit in a location for matching the harmful waves in the target space with the counter waves, thereby countering the harmful waves by such counter waves therein. Such providing and arranging may be replaced by the steps of: providing a greater number of the counter units for a smaller number of the base units; and arranging the counter units while disposing at least two of such counter units around at least one of the base units and while maintaining the feature.

In another exemplary embodiment of this aspect of the invention, a method may have the steps of: providing at least one counter unit capable of emitting counter electromagnetic waves; configuring the counter unit to move with respect to at least one of the base units; emitting by the counter unit the counter waves; finding a relation between a distance between the counter unit and at least one of the base units and matching between the counter and harmful waves; assessing a location in which the counter waves match the harmful waves; and moving the counter unit to the location for matching the harmful waves in the target space with the counter waves, thereby countering the harmful waves by the counter waves therein.

In another aspect of the present invention, a method may be provided for countering harmful electromagnetic waves which are irradiated from multiple base units of at least one wave source of a piezoelectric speaker by matching such harmful waves with counter electromagnetic waves and by canceling the harmful waves by the counter waves in a target space and/or suppressing the harmful waves from propagating toward the target space by the counter waves, where such base units are arranged to include at least one piezoelectric plate, at least two electrodes thereof, and at least one portion thereof which are all responsible for irradiating the harmful waves and affecting paths thereof therethrough, where such a target space is defined between such base units and an user, where the counter waves define at least one first wavefront, and where the harmful waves also define at least one second wavefront.

In one exemplary embodiment of this aspect of the invention, a method may have the steps of: the first providing; disposing the counter unit along at least a portion of the second wavefront; and emitting the counter waves while matching at least a portion of the second wavefront with at least a portion of the first wavefront in the target space due to the disposing, thereby countering the harmful waves by the counter waves therein.

In another exemplary embodiment of this aspect of the invention, a method may have the steps of: the first providing; configuring the counter unit to match ts shape and/or arrangement with a shape and/or an arrangement of the first wavefront; disposing the counter unit along at least a portion of the second wavefront; and emitting such counter waves while matching at least a portion of the second wavefront with at least a portion of the first wavefront in the target space due to the configuring and disposing, thereby countering the harmful waves by the counter waves therein. The configuring and disposing may also be replaced by the steps of: configuring the counter unit to define a shape and/or an arrangement different from a shape and/or an arrangement of the first wavefront; and disposing the counter unit across (or along) at least two different and distant portions of the second wavefront.

In another exemplary embodiment of this aspect of the invention, a method may have the steps of: the first providing; disposing multiple counter units in an arrangement along at least a portion of the second wavefront; configuring the counter units to match their arrangement with an arrangement of the first wavefront; and emitting the counter waves while aligning at least a portion of such a second wavefront with at least a portion of the first wavefront in the target space due to such disposing and configuring, thereby countering the harmful waves by the counter waves therein. The disposing and configuring may also be replaced by the steps of: disposing multiple counter units in an arrangement across (or along) at least two different portions of the second wavefront; and configuring the counter units to mismatch the arrangement thereof from an arrangement of the first wavefront.

In another exemplary embodiment of this aspect of the invention, a method may have the steps of: the first providing; placing the counter unit between the base units and target space; comparing a shorter radius of curvature of such a first wavefront with a longer radius of curvature of the second wavefront; and then disposing the counter unit in a location of such a target space in which the radii of curvature of such first and second wavefronts match each other, thereby countering the harmful waves by the counter waves therein. The above placing and comparing may also be replaced by the steps of: placing the counter unit on an opposite side of the target space relative to the base unit; and comparing a longer radius of curvature of the first wavefront to a shorter radius of curvature of the second wavefront.

In another exemplary embodiment of this aspect of the invention, a method may have the steps of: the first providing; configuring the counter unit to move with respect to such base units; finding a relation between a distance between the counter unit and at least one of the base units and matching between radii of curvature of the first and second wavefronts; assessing a location in which the first and second wavefronts match each other; and moving the counter unit to the location for matching the harmful waves in the target space by the counter waves, thereby countering the harmful waves by the counter waves therein.

In another aspect of the present invention, a method may be provided for countering harmful electromagnetic waves which are irradiated by multiple base units of at least one wave source of a piezoelectric speaker by emitting counter electromagnetic waves by at least one counter unit and by propagating the counter waves along a preset direction toward the harmful waves, where the base units are arranged to include at least one piezoelectric plate, at least two electrodes thereof to supply electric energy to the piezoelectric plate, and at least one portion thereof responsible for irradiating the harmful waves and affecting paths of the harmful waves therethrough and where the target space is defined between the base units and an user.

In one exemplary embodiment of this aspect of the invention, a method may have the steps of: configuring the counter waves to define shapes similar to those of the harmful waves and to have at least partially opposite phase angles (to be referred to as the “first configuring” hereinafter); enclosing at least one of the base units by the counter unit; and emitting the counter waves while enclosing the harmful waves in such a target space, thereby countering the harmful waves by the counter waves therein. The above enclosing may also be replaced by the step of: disposing multiple the counter units around at least one of the base units.

In another exemplary embodiment of this aspect of the invention, a method may have the steps of: the first configuring; disposing at least a portion of the counter unit in at least one of the base units; and then emitting the counter waves while being enclosed by the harmful waves in the target space, thereby countering the harmful waves with the counter waves therein. The above disposing may be replaced by the step of: enclosing at least a portion of such a counter unit by at least two of the base units.

In another exemplary embodiment of this aspect of the invention, a method may have the steps of: the first configuring; disposing the counter unit lateral to at least one of the base units; and emitting the counter waves to the target space along with the harmful waves, thereby countering the harmful waves by the counter waves therein. The above disposing may also be replaced by one of the steps of: disposing the counter unit along a longitudinal axis of at least one of the base units and also away therefrom; and enclosing at least a portion of the counter unit and/or at least one of the base units by another of the units.

In another exemplary embodiment of this aspect of the invention, a method may have the steps of: the first configuring; aligning the counter unit in a direction of propagation of such harmful waves; and then emitting the counter waves toward the target space along with the harmful waves, thereby countering the harmful waves by the counter waves therein. The above aligning may be replaced by one of the steps of: aligning the counter unit in a direction of electric current and/or voltage applied to at least one of the base units; aligning the counter unit with a longitudinal axis of at least one of such base units; and aligning the counter unit with a short axis of at least one of the base units.

In another exemplary embodiment of this aspect of the invention, a method may have the steps of: the first configuring; disposing the counter unit between the base units and target space; emitting by the counter unit the counter waves of amplitudes less than those of the harmful waves; and then propagating the counter waves to the target space along with the harmful waves, thereby countering the harmful waves by the counter waves therein. The above disposing and emitting may be replaced by the steps of: disposing the counter unit on an opposite side of the target space relative to the base unit; and emitting by the counter unit the counter waves defining amplitudes greater than those of the harmful waves.

In another exemplary embodiment of this aspect of the invention, a method may have the steps of: the first configuring; disposing the counter unit between at least one of the base units and target space; extending the counter unit to a width greater than that of at least one of the base units along a direction normal to a direction of propagation of the harmful waves; and emitting such counter waves toward the target space along with the harmful waves, thereby countering the harmful waves by the counter waves therein. Such disposing and extending may be replaced by the steps of: disposing the counter unit on an opposite side of the target space with respect to the base units; and extending the counter unit to a width less than that of at least one of the base units in a direction perpendicular to a direction of propagation of the harmful waves.

In another aspect of the present invention, a method may be provided for countering harmful electromagnetic waves which are irradiated from multiple base units of at least one wave source of a piezoelectric speaker by emitting counter electromagnetic waves and by canceling the harmful waves with the counter waves in a target space and/or suppressing the harmful waves from propagating to the target space with the counter waves, where the base units are arranged to include at least one piezoelectric plate, at least two electrodes, and at least one portion thereof which are responsible for irradiating the harmful waves and affecting paths thereof therethrough and where the target space is defined between the base units and an user.

In one exemplary embodiment of this aspect of the invention, a method may have the steps of: providing a single counter unit capable of emitting the counter waves; the first configuring; and then countering the harmful waves irradiated from only one of the base units by the counter waves.

In another exemplary embodiment of this aspect of the invention, a method may have the steps of: providing a single counter unit for emitting the counter waves; the first configuring; and countering a sum of the harmful waves which are irradiated from all (or at least two but not all) of the base units with the counter waves.

In another exemplary embodiment of this aspect of the invention, a method may have the steps of: providing multiple counter units for emitting the counter waves; the first configuring; and countering the harmful waves which are irradiated by only one of the base units by a sum of all of such counter waves emitted by all of the counter units.

In another exemplary embodiment of this aspect of the invention, a method may have the steps of: providing multiple counter units for emitting the counter waves; the first configuring; and countering a sum of the harmful waves irradiated from all (or at least two but not all) of the base units with a sum of the counter waves emitted by at least two of the counter units.

In another exemplary embodiment of this aspect of the invention, a method may have the steps of: providing at least two counter units for emitting the counter waves; configuring at least one of the counter units to move with respect to the other thereof; the first configuring; and moving at least one of such counter units with respect to at least one of the base units in the emitting, thereby countering the harmful waves which are irradiated by only one of the base units by such counter waves emitted by a different number of the counter units.

In another aspect of the present invention, a method may be provided for countering harmful electromagnetic waves which are irradiated from at least one base unit of at least one wave source of a piezoelectric speaker by emitting counter electromagnetic waves, where the base unit is shaped as at least one curvilinear wire.

In one exemplary embodiment of this aspect of the invention, a method may have the steps of: the first providing; shaping the counter unit into a wire, strip, and/or sheet; disposing the counter unit along and close to the wire; and supplying electric energy to the base unit of the wire and counter unit in opposite directions while emitting the counter waves by the counter unit for countering the harmful waves by the counter waves (to be referred to as the “first supplying” hereinafter). Such disposing may be replaced by the step of: braiding the counter unit around and close to the wire.

In another exemplary embodiment of this aspect of the invention, a method may have the steps of: providing multiple counter units each shaped as a wire, strip, and/or sheet; disposing the counter units around and close to the wire; and the first supplying. The above disposing may be replaced by the step of: braiding each of the counter units around and adjacent to the wire along same or different directions.

In another exemplary embodiment of this aspect of the invention, a method may have the steps of: the first providing; shaping the counter unit into at least one coil and/or spiral; winding the counter unit around the wire; and the first supplying. The above shaping and winding may be replaced by the steps of: shaping the counter unit into a sheet and/or a mesh; and winding the counter unit around the wire or, alternatively, by the steps of: shaping the counter unit into an annular tube with a lumen; and disposing the wire inside the lumen of the counter unit.

In another exemplary embodiment of this aspect of the invention, a method may have the steps of: identifying multiple wavefronts of such harmful waves formed around the wire; disposing at least one counter unit along at least one of the wavefronts; and emitting by such a counter unit the counter waves defining multiple wavefronts similar (or identical) to the wavefronts which are defined by the wire, thereby countering the harmful waves with the counter waves.

In another aspect of the present invention, a method may be provided for countering harmful electromagnetic waves which are irradiated from at least one base unit of at least one wave source of a piezoelectric speaker by emitting counter electromagnetic waves, where the base unit is shaped into at least one curvilinear strip and/or sheet.

In one exemplary embodiment of this aspect of the invention, a method may have the steps of: the first providing; shaping the counter unit into a wire, a strip, and/or a sheet; disposing the counter unit along and close to the strip (or sheet); and supplying electric energy to the base unit of the strip and/or sheet and counter unit along opposite directions while emitting such counter waves with such a counter unit for countering the harmful waves by the counter waves (which will be referred to as the “second supplying” hereinafter). The above disposing may be replaced by the step of: braiding the counter unit around and close to the strip (or sheet).

In another exemplary embodiment of this aspect of the invention, a method may have the steps of: providing multiple counter units each of which is shaped as a wire, strip, and/or sheet; disposing the counter units around and close to the strip and/or sheet; and the second supplying. The above disposing may be replaced by the step of: braiding each of the counter units around and close to the strip and/or sheet in the same or different directions.

In another exemplary embodiment of this aspect of the invention, a method may have the steps of: the first providing; shaping the counter unit into at least one coil and/or spiral; winding the counter unit around the strip (or sheet); and the second supplying. The above shaping and winding may also be replaced by the steps of: shaping the counter unit into a sheet and/or a mesh; and winding such a counter unit around the strip (or sheet) or, alternatively, by the steps of: shaping the counter unit as a pair of strips and/or sheets; and disposing the wire between the strips and/or sheets.

In another exemplary embodiment of this aspect of the invention, a method may have the steps of: identifying multiple wavefronts of such harmful waves around the strip and/or sheet; disposing at least one counter unit along at least one of the wavefronts; and then emitting by the counter unit such counter waves defining multiple wavefronts similar (or identical) to the wavefronts of the strip and/or sheet, thereby countering the harmful waves with the counter waves.

In another aspect of the present invention, a method may be provided for countering harmful electromagnetic waves which are irradiated from at least one base unit of at least one wave source of a piezoelectric speaker by emitting counter electromagnetic waves, where the base unit is shaped into at least one curvilinear tube with a lumen.

In one exemplary embodiment of this aspect of the invention, a method may have the steps of: the first providing; shaping the counter unit as a wire, strip, and/or sheet; disposing the counter unit along and close to the tube; and supplying electric energy to the wave source of the tube as well as counter unit in opposite directions while emitting the counter waves by the counter unit for countering the harmful waves by the counter waves (to be referred to as the “third supplying” hereinafter). The above disposing may further be replaced by the step of: braiding the counter unit around and close to the tube.

In another exemplary embodiment of this aspect of the invention, a method may have the steps of: providing multiple counter units each shaped as one of a wire, a strip, and a sheet; disposing such a counter units around and close to the tube; and the third supplying. The above disposing may also be replaced by the step of: braiding each of the counter units around and close to the tube along the same or different directions.

In another exemplary embodiment of this aspect of the invention, a method may have the steps of: the first providing; shaping the counter unit as at least one wire and/or strip; disposing the counter unit inside the lumen of the tube; and the third supplying.

In another exemplary embodiment of this aspect of the invention, a method may have the steps of: the first providing; shaping the counter unit into at least one coil and/or spiral; winding the counter unit around the tube; and the third supplying. The above shaping and winding may be replaced by the steps of: shaping the counter unit into a sheet and/or a mesh; and winding the counter unit around the tube, by the steps of: shaping the counter unit into a bigger tube with a lumen; and disposing the tube inside the lumen of the counter unit or, in the alternative, by the steps of: shaping the counter unit into a smaller tube with a lumen; and disposing the counter unit inside the lumen of the tube.

In another exemplary embodiment of this aspect of the invention, a method may have the steps of: identifying multiple wavefronts of such harmful waves defined around the tube; disposing at least one counter unit along at least one of such wavefronts; and emitting by the counter unit the counter waves which define multiple wavefronts similar (or identical) to such wavefronts of the tube, thereby countering the harmful waves with the counter waves.

In another aspect of the present invention, a method may be provided for countering harmful electromagnetic waves which are irradiated from at least one base unit of at least one wave source of a piezoelectric speaker by emitting counter electromagnetic waves, where the base unit is shaped into at least one curvilinear coil.

In one exemplary embodiment of this aspect of the invention, a method may have the steps of: the first providing; shaping the counter unit as a toroid by disposing opposing ends of the coil close to each other; supplying the electric energy in the coil; and supplying electric energy to the wave source of the coil and counter unit in opposite directions while emitting the counter waves by the counter unit for countering the harmful waves by the counter waves (to be referred to as the “fourth supplying” hereinafter).

In another exemplary embodiment of this aspect of the invention, a method may have the steps of: the first providing; shaping the counter unit as one of a wire, a strip, and a spiral which is smaller than the coil of the base unit; winding the coil of the base unit around the counter unit; and the fourth supplying. The above shaping and winding may be replaced by the steps of: shaping the counter unit as another coil smaller than the coil of the base unit; and then winding the coil of the base unit around the counter unit.

In another exemplary embodiment of this aspect of the invention, a method may have the steps of: the first providing; shaping the counter unit as another coil; disposing the coils of the counter and base units adjacent to each other; and the fourth supplying. The above disposing may be replaced by the step of: braiding the coils of the counter and base units.

In another exemplary embodiment of this aspect of the invention, a method may have the steps of: identifying multiple wavefronts of the harmful waves formed around the coil; disposing at least one counter unit along at least one of the wavefronts; and emitting by the counter unit the counter waves defining multiple wavefronts similar (or identical) to the wavefronts of the tube, thereby countering the harmful waves with the counter waves.

Embodiments of such method aspects of the present invention may include one or more of the following features, and configurational and/or operational variations and/or modifications of the above methods also fall within the scope of the present invention.

Such countering may include the step of: countering the harmful waves but preserving audible sound waves. The countering may include at least one of the steps of: suppressing at least a portion of the harmful waves from propagating toward the target space by the counter waves; canceling the portion of the harmful waves by the counter waves in the target space, and the like. The countering may also include at least one of the steps of: countering the harmful waves of frequencies less than about 50 Hz to 60 Hz; countering the harmful waves defining frequencies less than about 300 Hz; and countering the harmful waves of frequencies less than about 1 kHz. The countering may also include at least one of the steps of: countering such harmful waves with frequencies less than about 10 kHz; countering the harmful waves of frequencies less than about 100 kHz; countering the harmful waves with frequencies less than about 1 MHz, 10 MHz, 100 MHz, 1 GHz, 10 GHz, 100 GHz, 1 THz, and the like. The countering may include at least one of the steps of: countering the harmful waves in only a portion of a preset frequency range while preserving the rest thereof; countering magnetic waves of the harmful waves; countering an entire portion of the harmful waves, and the like.

The affecting may include at least one of the steps of: including a permanent magnet; applying the electric voltage; flowing the electric current, and the like. Such extending may include one of the steps of: lengthening the counter unit along its length; widening the counter unit along its width, and the like. The providing may include at least one of the steps of: forming the counter unit into a shape of at least one of: a wire, a strip, a sheet, a tube, a coil, a spiral, and a mesh; forming the counter unit into one of a mixture of the shapes, a combination of the shapes, and an array of the shapes, and the like. The forming may include at least one of the steps of: enclosing at least a portion of such a base unit by an array (or bundle) of multiple wires of the counter unit; enclosing the portion of the base unit by an array (or bundle) of multiple strips of the counter unit; enclosing the portion of the base unit by an array (or bundle) of multiple sheets of the counter unit; enclosing the portion of the base unit by an array (or bundle) of multiple tubes of the counter unit; winding with at least one coil of the counter unit about the portion of the base unit; winding the portion of the base unit with an array (or a bundle) of multiple coils; and enclosing the portion of the base unit with at least one annular mesh of the counter unit. Such forming the counter unit may further include at least one of the steps of: extending a single wire for at least a portion of the counter unit; extending an array (or bundle) of multiple wires for the portion; extending a single strip for the portion; extending an array (or bundle) of multiple strips for the portion; extending a single sheet for the portion; extending an array (or bundle) of multiple sheets for the portion; extending a single tube therefor; extending a bundle (or array) of multiple tubes therefor; winding a single coil therefor; winding a bundle (or array) of multiple coils therefor; extending a single annular mesh therefor; and extending an array (or bundle) of multiple annular meshes therefor.

The providing may include one of the steps of: exposing the counter unit through the base unit; hiding the counter unit under (or inside) the base unit, and the like. The providing may include at least one of the steps of: fixedly disposing the counter unit; movably disposing the counter unit, and so on. The providing may include one of the steps of: forming the base and counter units of a same material; forming the base and counter units of different materials; including at least one but not all of materials in the base and counter units, and the like. The providing may include one of the steps of: arranging the base and counter units to have similar (or identical) resonance frequencies; arranging the base and counter units to define different resonance frequencies, and the like.

The disposing may include at least one of the steps of: disposing the counter unit laterally (or side by side) with the base unit; enclosing at least one of the counter and base units with another of the units; axially aligning the base and counter units, and the like. Such enclosing may include one of the steps of: disposing the counter unit indirectly over (or around) the base unit (or source); disposing the counter unit directly on (or around) the base unit (or source), and the like. The enclosing may also include at least one of the steps of: arranging at least two of the counter units concentrically; coupling the counter units electrically in one of a series mode, a parallel mode, and a hybrid mode, and the like. The aligning may include one of the steps of: aligning the counter unit with the longitudinal axis of the base unit; aligning the counter unit with the short axis of the base unit; aligning the counter unit in the direction of the current flowing in (or voltage applied across) the base unit, aligning the counter unit with the direction of propagation of the harmful waves, and the like.

The configuring the counter unit may include at least one of the steps of: controlling a shape of the counter unit; controlling a size of the counter unit; controlling an arrangement of the counter unit, and the like. The disposing may include at least one of the steps of: controlling an orientation of such a counter unit with respect to the base unit (or target space); controlling an alignment of the counter unit with respect thereto; controlling a first distance between the counter unit and base unit (or target space); controlling a second distance between the counter units, and the like.

The emitting may have one of the steps of: controlling the phase angles of the counter waves to be at least similar to those of the harmful waves when the counter and harmful waves propagate along at least partially opposite directions; controlling the phase angles of the counter waves to be at least opposite to those of the harmful waves when the counter and harmful waves propagate along at least similar directions; and controlling the phase angles of the counter waves to be transverse to those of the harmful waves when the counter and harmful waves propagate in directions transverse to each other. Such emitting may include at least one of the steps of: manipulating amplitudes of the counter waves to be greater (or less) than those of the harmful waves when measured in the target space; manipulating the amplitudes of the counter waves to be similar (or identical) to those of the harmful waves when measured at the base unit, and the like. The emitting may include at least one of the steps of: propagating the counter waves in the same direction as the harmful waves; propagating the counter waves in a direction different from that of the harmful waves irradiated by each of such base units but in the same direction as that of a sum of the harmful waves from the base units, and the like. The emitting may include the step of: manipulating phase angles of the counter waves to be at least partially (or substantially) opposite to those of the harmful waves.

The method may also include one of the steps of: flowing the current in an entire portion of the base unit; flowing the current in only a portion of the base unit; applying such voltage across an entire portion of the base unit; and applying such voltage across only a portion of the base unit. The method may include one of the steps of: flowing the current in a single direction through the base (or counter) unit; flowing such current along different directions in different portions of the base (or counter) unit; applying such voltage in a single direction through the base (or counter) unit; applying such voltage in different directions along different portions of the base (or counter) unit, and the like. The method may include the step of: providing multiple base units for the harmful waves, and the flowing may include one of the steps of: flowing the currents with the same amplitudes along a same direction in all of the base (or counter) units; flowing the currents of the same amplitudes in different directions along the base (or counter) units; flowing the currents of different amplitudes in the same direction in all of the base (or counter) units; flowing the currents of different amplitudes in different directions in the base (or counter) units, and the like. The method may include the step of: providing multiple base units for the harmful waves, and the applying may include one of the steps of: applying the voltages with the same amplitudes along a same direction in all of the base (or counter) units; applying the voltages of the same amplitudes in different directions along the base (or counter) units; applying the voltages of different amplitudes in the same direction in all of the base (or counter) units; applying the voltages of different amplitudes in different directions in the base (or counter) units, and the like.

Such flowings may include one of the steps of: flowing the currents of the same (or different) amplitudes in the counter unit; flowing in the counter unit another current which may not be derived from the current supplied to the base unit but may have a temporal pattern at least partially similar to that of the current supplied to the base unit; flowing along the counter unit another current which may be derived not from the current to the base unit and may have a temporal pattern different from that of the current to the base unit, and the like. Such flowing the currents may include one of the steps of: flowing such currents in the base unit and then in the counter unit; flowing the currents in the counter unit and then in the base unit; flowing such currents at least simultaneously in the base and counter units, and the like.

In another aspect of the present invention, a system may be provided for countering harmful electromagnetic waves which are irradiated from at least one base unit of at least one wave source of a piezoelectric speaker by emitting counter electromagnetic waves, by controlling a shape of the counter unit, and by canceling the harmful waves in a target space with such counter waves and/or suppressing the harmful waves from propagating to the target space by the counter waves, where such base units are arranged to include piezoelectric plate of the speaker, at least two electrodes thereof, and at least one portion thereof which are responsible for irradiating the harmful waves and affecting paths of the harmful waves therethrough, while the target space is defined between such a system and at least one body part of an user of the system.

In one exemplary embodiment of this aspect of the invention, such a system may be provided by a process comprising the steps of: arranging at least one counter unit to have a width longer than that of at least one of the base units; disposing the counter unit between the wave source and user while aligning a width thereof with at least a portion of a wavefront of the harmful waves; configuring the counter unit to emit the counter waves defining wave characteristics similar to the harmful waves but defining at least partially opposite phase angles thereto; and aligning the counter unit to propagate the counter waves toward the target space, thereby countering the harmful waves by such counter waves therein (to be referred to as the “first aligning” hereinafter). The arranging and disposing may be replaced by the steps of: arranging at least one counter unit to have a width narrower than at least one of the base units; and disposing the counter unit on an opposite side of the target space relative to at least one of the base units while aligning its width with at least a portion of a wavefront of such harmful waves.

In another exemplary embodiment of this aspect of the invention, a system may be provided by a process comprising the steps of: identifying multiple wavefronts of the harmful waves; configuring a single counter unit to emit the counter waves with multiple wavefronts which have phase angles at least partially opposite to those of the harmful waves and are capable of matching the wavefronts of the harmful waves when disposed at a preset distance from at least one of the base units; disposing the counter unit in the distance from the base units; and the first aligning.

In another exemplary embodiment of this aspect of the invention, a system may be provided by a process comprising the steps of: providing at least two counter units; configuring the counter units to emit the counter waves which define similar (or identical) phase angles and which also have a first set of multiple wavefronts each of which is a sum of at least two wavefronts formed by the counter units; finding a relation between a distance between the counter units and an increase in a radius of curvature of each of the wavefronts of the first set; identifying a second set of multiple wavefronts of the harmful waves; configuring the counter units to match the radii of curvature of the wavefronts of the first set to those of the wavefronts of the second set when disposed at preset distances from at least one of the base units; disposing the counter units in the distances; and the first aligning. The above configuring and finding may be replaced by the steps of: configuring the counter units to emit the counter waves which define at least partially opposite phase angles and also a first set of multiple wavefronts each of which represents a sum of at least two wavefronts generated by such counter units; and finding a relation between a distance between the counter units and a decrease in a radius of curvature of each of the wavefronts of the first set.

In another aspect of the present invention, a system may be provided for countering harmful electromagnetic waves which are irradiated from at least one base unit of at least one wave source of a piezoelectric speaker by emitting counter electromagnetic waves therefrom, by matching at least one feature of at least one of the base units therewith, and by canceling the harmful waves with the counter waves in a target space and/or suppressing the harmful waves from propagating thereto by the counter waves, where such base units are arranged to include at least one piezoelectric plate of the speaker, at least two electrodes thereof, and at least one portion thereof which are responsible for irradiating the harmful waves and for affecting paths of such harmful waves therethrough, while the target space is defined between the system and at least one body part of an user.

In one exemplary embodiment of this aspect of the invention, such a system may be provided by a process comprising the steps of: arranging at least one counter unit to match the feature of at least one of the base units; configuring the counter unit to emit the counter waves which are similar (or identical) to the harmful waves due to the arranging but which have phase angles at least partially opposite to those of the harmful waves (will be referred to as the “second configuring” hereinafter); and the first aligning. The above arranging may be replaced by one of the steps of: arranging at least one counter unit to define a configuration simpler than that of at least one of such base units while at least minimally maintaining the feature; arranging at least one counter unit to have a configuration more complex than that of at least one of such base units while at least minimally maintaining the feature; arranging at least one counter unit to have a dimension defined by a less number of unit axes than at least one of the base units while at least minimally maintaining the feature; and arranging at least one counter unit to define a dimension defined by a greater number of unit axes than that of at least one of the base units while at least minimally maintaining the feature.

In another exemplary embodiment of this aspect of the invention, a system may be provided by a process comprising the steps of: arranging a single counter unit to have a configuration simpler than that of only one of such base units while maintaining the feature; the second configuring; and the first aligning. The above arranging may be replaced by one of the steps of: arranging a single counter unit to define a configuration similar (or identical) to an arrangement of at least two of the base units while maintaining the feature; arranging a single counter unit to define a dimension which is formed by less mutually orthogonal unit axes than an arrangement of at least two of the base units while maintaining the feature; arranging a single counter unit to define a dimension formed by more mutually orthogonal unit axes than a dimension of at least two of the base units while maintaining the feature, and the like.

In another exemplary embodiment of this aspect of the invention, a system may be provided by a process also comprising the steps of: providing multiple counter units; arranging at least two of the counter units in a configuration simpler than that of only one of the base units while maintaining such a feature; configuring the counter units to emit such counter waves which are similar to (or identical to) the harmful waves due to the arranging but to have phase angles at least partially opposite to those of the harmful waves; and aligning the counter units to propagate the counter waves toward the target space, thereby countering the harmful waves by the counter waves therein. The above arranging may be replaced by one of the steps of: arranging at least two of the counter units in a configuration which is similar (or identical) to an arrangement of at least two of the base units while maintaining the feature; arranging such counter units in an arrangement defining a dimension formed by less mutually orthogonal unit axes than a dimension of only one of the base units while maintaining the feature; and arranging the counter units in an arrangement defining a dimension which is formed by more mutually orthogonal unit axes than a dimension of at least two of the base units while maintaining the feature.

In another exemplary embodiment of this aspect of the invention, a system may be provided by a process comprising the steps of: providing a smaller number of the counter units with respect to a greater number of the base units; approximating an arrangement of the base units by the counter units while maintaining such a feature; configuring the counter units to emit such counter waves which are similar to (or identical to) the harmful waves due to the approximating but also define phase angles at least partially opposite to those of the harmful waves; and then aligning the counter units to propagate the counter waves toward the target space, thereby countering the harmful waves by such counter waves therein. The above providing and approximating may be replaced by the steps of: providing a greater number of the counter units for a smaller number of the base units; and then approximating an arrangement of the base units by such counter units while disposing at least two of the counter units around at least one of the base units and maintaining the feature.

In another exemplary embodiment of this aspect of the invention, a system may be provided by a process comprising the steps of: arranging at least one counter unit to move with respect to at least one of such base units; configuring the counter unit to emit such counter waves which are similar (or identical) to the harmful waves but which have phase angles at least partially opposite to those of the harmful waves; finding a relation between a distance from the counter unit to at least one of the base units and an extent of matching between the counter and harmful waves; and moving the counter unit a location where the extent attains its maximum, thereby countering the harmful waves by the counter waves in the target space.

In another aspect of the present invention, a system may be provided for countering harmful electromagnetic waves which are irradiated from at least one base unit of at least one wave source of a piezoelectric speaker by emitting counter electromagnetic waves and then matching the harmful waves thereby, and by canceling the harmful waves with the counter waves in a target space and/or suppressing the harmful waves from propagating to the target space by the counter waves, where the base units are also arranged to include at least one piezoelectric plate of the speaker, at least two electrodes thereof, and at least one portion thereof which are responsible for irradiating the harmful waves and affecting their paths therethrough, and where the target space is defined between such a system and at least one body part of an user.

In one exemplary embodiment of this aspect of the invention, a system may be provided by a process comprising the steps of: identifying a first set of multiple wavefronts of the harmful waves; disposing at least one counter unit along at least one of the wavefronts; configuring the counter unit to emit the counter waves forming a second set of multiple wavefronts similar to (or identical to) the first set of the wavefronts in the target space due to the disposing; and the first aligning.

In another exemplary embodiment of this aspect of the invention, a system may be provided by a process comprising the steps of: identifying multiple wavefronts of the harmful waves; configuring at least one counter unit to emit the counter waves with multiple wavefronts similar to a shape and/or an arrangement of the counter unit; disposing the counter unit along at least one of the wavefronts of the harmful waves; and arranging the counter unit to emit such counter waves of which wavefronts are aligned with those of the harmful waves in the target space based upon the configuring, thereby countering the harmful waves by the counter waves therein. The above configuring and disposing may be replaced by the steps of: configuring at least one counter unit to emit the counter waves with multiple wavefronts different from a shape and/or an arrangement of the counter unit; and disposing the counter unit across (or along) at least two of the wavefronts of the harmful waves based on the configuring.

In another exemplary embodiment of this aspect of the invention, a system may be provided by a process comprising the steps of: identifying multiple wavefronts of such harmful waves; disposing multiple counter units in an arrangement along at least one of the wavefronts; configuring the counter units to emit the counter waves with multiple wavefronts which are similar to the arrangement of the counter units; and arranging the counter units to emit such counter waves of which wavefronts are aligned with those of the harmful waves in the target space due to the configuring, thereby countering the harmful waves by the counter waves therein. Such disposing and configuring may be replaced by the steps of: disposing multiple counter units in an arrangement across (or along) at least two of the wavefronts; and configuring the counter units to emit the counter waves with another plurality of wavefronts different from the arrangement of the counter units.

In another exemplary embodiment of this aspect of the invention, a system may be provided by a process comprising the steps of: identifying multiple wavefronts of the harmful waves; configuring at least one counter unit to emit the counter waves with multiple wavefronts each of which defines a radius of curvature; locating the counter unit between at least one of the base units and target space; comparing shorter radii of curvature of the wavefronts of such counter waves with longer radii of curvature of the harmful waves; and configuring the counter unit to be disposed in a location where the radii of curvature of the wavefronts of such counter waves are arranged to match those of the wavefronts of the harmful waves in the target space, thereby countering the harmful waves by the counter waves therein. The above locating and comparing may be replaced by the steps of: locating the counter unit on an opposite side of the target space with respect to at least one of the base units; and comparing longer radii of curvature of the wavefronts of such counter waves to shorter radii of curvature of the harmful waves.

In another exemplary embodiment of this aspect of the invention, a system may be provided by a process comprising the steps of: arranging at least one counter unit to move with respect to at least one of the base units; configuring the counter unit to emit such counter waves which are similar (or identical) to the harmful waves but which have phase angles at least partially opposite to those of the harmful waves; finding a relation between a distance between the counter unit and at least one of the base units and a matching between radii of curvature of the counter waves and those of the harmful waves; assessing a location in which the wavefronts of the counter and harmful waves best match each other; and moving the counter unit to the location for matching the harmful waves in the target space by the counter waves, thereby countering the harmful waves by the counter waves therein.

In another aspect of the present invention, a system may be provided for countering harmful electromagnetic waves which are irradiated from at least one base unit of at least one wave source of a piezoelectric speaker by suppressing the harmful waves from propagating toward a target space and/or canceling the harmful waves therein, where the base units are arranged to include at least one piezoelectric plate of the speaker, at least two electrodes thereof, and at least another portion thereof which are responsible for irradiating the harmful waves and for affecting paths of the harmful waves therethrough and where the target space is defined between the system and at least one body part of an user.

In one exemplary embodiment of this aspect of the invention, such a system may be provided by a process comprising the steps of: arranging at least one counter unit to have a shape identical (or similar) to at least one of the base units and to emit counter electromagnetic waves, and configuring the counter waves to define phase angles at least partially opposite to those of the harmful waves, to define wave characteristics at least partially similar to those of the harmful waves due to the shape and, therefore, to counter the harmful waves due to the opposite phase angles in the target space (to be referred to as the “third configuring” hereinafter).

In another exemplary embodiment of this aspect of the invention, a system may be provided by a process comprising the steps of: arranging a single counter unit to define a shape of an 1-D (or 2-D, 3-D) analog of at least one of the base units and to emit counter electromagnetic waves; and the third configuring. The above arranging may also be replaced by the step of: arranging a single counter unit to define a shape of an 1-D (or 2-D, 3-D) analog of at least two of the base units and to emit counter electromagnetic waves.

In another exemplary embodiment of this aspect of the invention, a system may be provided by a process comprising the steps of: arranging multiple counter units at least two of which are arranged to define shapes of 1-D (or 2-D, 3-D) analogs of at least one of such base units and to emit counter electromagnetic waves; and the third configuring. The arranging may be replaced by one of the steps of: arranging multiple counter units at least two of which are arranged to define shapes of 1-D (or 2-D, 3-D) analogs of all (or at least two but not all) of the base units and to emit counter electromagnetic waves; and arranging multiple counter units at least two of which are arranged to define shapes of 1-D (or 2-D, 3-D) analogs of each of the base units and to emit counter electromagnetic waves.

More product-by-process claims may be constructed by modifying the foregoing preambles of the apparatus and/or method claims and by appending thereonto such bodies of the apparatus and/or method claims. In addition, such process claims may include one or more of the above features of the apparatus and/or method claims of the present invention.

As used herein, the term “units” collectively refers to both of a “base unit” and a “counter unit” of an electromagnetically-countered piezoelectric speaker system of e present invention, where such a system is to be abbreviated as the “EMC speaker system,” “EMC system” or simply as the “system” hereinafter. Such a classification between the “units” is primarily based upon their intended functions. That is, the “base unit” refers to various parts of the EMC system which perform intended functions of the system such as, e.g., producing audible sounds from source signals. Such “base units” invariably irradiate the harmful waves while performing their intended functions, and always incorporated in the above system. In contrary, the “counter unit” represents those parts of the EMC system which are to perform countering functions such as, e.g., canceling at least a portion of such harmful waves in the target space and/or suppressing or preventing the portion of such harmful waves from propagating to the target space. When desirable, the “counter unit” may also be arranged to perform the functions intended for the “base unit” and, accordingly, serve as an extra “base unit” which also performs the countering function. This unit, however, is to be deemed as the “counter unit” within the scope of this invention unless otherwise specified. Within the scope of this invention, the “base unit” is therefore omnipresent in any prior art devices, whereas the “counter unit” is neither physically not functionally present in the prior art devices.

The “base unit” is to be distinguished from a “wave source” within the scope of this invention. More particularly, the “wave source” collectively refers to portions of the EMC system irradiating such harmful waves, whereas the “base unit” specifically refers only to the portions of the “wave source” which are directly responsible for irradiating the harmful waves and/or affecting propagation paths of the waves. For example, a piezoelectric speaker of a mobile phone is deemed as the “wave source” and the “base units” of such a phone includes a piezoelectric plate, multiple electrodes, a metal plate, and the like, while a case member and other couplers coupling to such base units are portions of the “wave source” but not portions of the “base unit,” for the case member and couplers neither generate the harmful waves nor affect the propagation paths of the waves. Therefore, a shape of the “wave source” is generally different from a shape of the “base unit,” where such a “base unit” may have the shape simpler or more complex than that of the “wave source.” However, the “base unit” may also be deemed as a subset of the “wave source” and, therefore, such a “base unit” almost always defines a size which is smaller than or at most equal to that of the “wave source.”

As used herein, the term “configuration” collectively refers a shape, size, and/or arrangement, while the term “disposition” collectively includes orientation, alignment, and/or distance. Accordingly, the “configuration” of the (counter or base) unit may refer to the shape of the unit, the size of the unit, and/or arrangement of the unit with respect to the other of the base and counter units. Similarly, the “disposition” of the unit may refer to the orientation and/or alignment of such a unit with respect to the other of the base and counter units, to the target space, to a direction of propagation of the harmful or counter waves, to a direction of the electric current flowing in or voltage applied across such a unit or the other of the base and counter units, and the like. The “disposition” of the unit may also refer to the distance to the other of the base and counter units therefrom, to the target space, and the like. When the system include multiple counter units, the “disposition” thereof may include the distance between at least two of such counter units.

Within the scope of the present invention, the term “wire” collectively refers to an article with a shape of a wire, a fiber, a filament, a rod, and/or a strand, and shapes of any other similarly elongated articles each of which may be straight or curved (i.e., curvilinear), and each of which may be formed into a loop, a coil, a roll, a spiral, a mesh, and the like. The term “strip” collectively refers to an article with a shape of a strip, a bar, a pad, and/or a tape, and shapes of any other planar or curved articles with large aspect ratios (i.e., ratios of lengths to widths or heights), each of which may be arranged straight or curved, each of which may be arranged in a two- or three-dimensional configuration, each of which may be arranged into a loop, a coil, a roll, a spiral, a mesh, and the like. In addition, the term “sheet” collectively refers to an article with a shape of a sheet, a slab, a foil, a film, a plate, and/or a layer, and shapes of any other articles which are wider than the “strip,” each of which may be planar (i.e., two-dimensional or 2-D) or curved (i.e., three-dimensional or 3-D), each of which may be formed in a segment, a roll, and the like. The term “tube” collectively refers to an article which may define any of the shapes described hereinabove and to be described hereinafter and forming at least one lumen therethrough. Such a “tube” may be arranged straight or curved, may be arranged into a loop, a coil, a roll, a spiral, a mesh, and the like. The term “coil” collectively refers to an article defining a shape of a helix and/or a spring, and shapes of any other articles winding around an object along a longitudinal or short axis of such an object at a constant distance from the object, and the like. The “coil” may be arranged straight or curved, may also be arranged into a loop (such as a toroid), a coil, a roll, a spiral, a mesh, and the like. The term “spiral” collectively refers to an article defining a shape of another helix and/or spring which may, however, expand or shrink along the longitudinal oe short axis of an object, and shapes of any other articles winding around such an object at varying distances, and the like. It is appreciated that a planar “spiral” may be formed on a single curvilinear plane which is normal to the longitudinal or short axis of the object. The term “mesh” collectively refers to an article with a shape a mesh, a net, a screen, a quilt, a fabric, and/or a garment, and shapes of any other articles which may be formed into a networking structure, a woven structure, an interwoven structure, and the like. The term “bundle” collectively refers to an article defining a shape of two or more of the same or different elongated shapes which are aligned side by side or laterally in such a manner that a cross-section of the “bundle” or a “bundled article” may include at least two of such shapes therein. The term “braid” collectively refers to an article with a shape of two or more of the same of different elongated shapes which are braided in such a manner that the “braid” or a “braided article” may consist of at least two of such shapes in a cross-section normal to a longitudinal and/or short axis thereof, where examples of such articles may include, but not be limited to, a thread, a yarn, any other articles made by prior art braiding techniques, and the like. It is to be understood that at least a portion of each of such articles formed according to the above terms in this paragraph may be arranged to be solid, hollow or porous such as, e.g., a foam, a sponge, and the like. It is also appreciated that each of such articles formed according to the foregoing terms of this paragraph may be arranged to include (or define) at least one hole, gap or opening.

Similarly and as used herein, the term “mixture” collectively refers to a liquid, a solution, a sol, a gel, an emulsion, a suspension, a slurry, and/or a powder, each of which may include therein multiple particles, particulates, grains, granules, filings, fragments, and/or pellets each of which may also have shapes of spheres, ellipsoids, cylinders, flakes, “wires,” “strips,” and the like, and each of which may be in a range of millimeters, microns or nanometers. When appropriate, such a “mixture” may include at least one solvent, at least one chemically, electrically, and/or magnetically inert filler for the purpose of providing mechanical strength and/or integrity thereto, and so on.

In addition, the term “combination” refers to a collection of different shapes examples of which may include, but not be limited to, the above wire, strip, sheet, tube, coil, spiral, mesh, their braid, and their bundle. The term “array” similarly refers to the collection of such shapes. However, the “array” refers to the “collection” which in addition forms multiple holes or openings therethrough.

As used herein, the terms “axial,” “radial,” and “angular” will be used in reference to a center axis of the system. Based thereupon, the term “axial direction” refers to a direction along the center axis of the system, while the term “radial direction” means another direction which is normal to such an “axial direction” and, therefore, which represents a direction extending away and outwardly from the center of the system. It is appreciated that such a “radial direction” may be other directions which extend away and outwardly from the center of the system and may be transverse but not necessarily perpendicular to the “axial direction.” The term “angular direction” refers to another direction revolving about the “axial direction” in a clockwise or counterclockwise manner.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and/or advantages of the present invention will be apparent from the following detailed description, and from the claims.

### BRIEF DESCRIPTION OF THE DRAWING

FIGS. 1A to 1E are various views of a typical conventional piezoelectric speaker;

FIGS. 2A to 2F are top schematic views of exemplary electromagnetic countering mechanisms in each of which a single counter unit emits counter waves to counter harmful waves irradiated by a single base unit of a single wave source according to the present invention;

FIGS. 2G to 2L are top schematic views of exemplary electromagnetic countering mechanisms in each of which multiple counter units emit counter waves to counter harmful waves irradiated by a single base unit of a single wave source according to the present invention;

FIGS. 3A to 3D are schematic perspective views of exemplary counter units for approximating base units in various configurations in source matching according to the present invention;

FIGS. 4A to 4D are schematic perspective views of exemplary counter units for approximating wavefronts in various configurations based on wave matching according to the present invention;

FIGS. 5A to 5F are schematic perspective views of exemplary counter units incorporated into a piezoelectric speaker based on source or wave matching according to the present invention; and

FIGS. 6A to 6L are schematic perspective views of exemplary counter units countering base units based on source or wave matching according to the present invention.

### DETAILED DESCRIPTION OF THE PREFERRED EMBODIMENTS

The present invention relates to an electromagnetically-countered system including at least one wave source irradiating harmful electromagnetic waves and at least one counter unit emitting counter electromagnetic waves for countering the harmful waves by the counter waves, e.g., by canceling at least a portion of the harmful waves in a target space by the counter waves and by suppressing the harmful waves from propagating to the target space. More particularly, the present invention relates to generic counter units for electromagnetically-countered piezoelectric speaker systems and various mechanisms for countering the harmful waves irradiated by various base units of the wave sources by the counter waves. Accordingly, the counter unit may be shaped, sized, and/or arranged to match its configuration with configuration of the base units of the wave source, thereby emitting the counter waves automatically matching of such harmful waves. In the alternative, such a counter unit may be shaped, sized, and/or disposed in an arrangement which is defined along one or more wavefronts of the harmful waves, thereby emitting the counter waves automatically matching the harmful waves. The present invention also relates to various counter units which are provided as analogs of the base units of the wave source, where the analog may approximate the base units which are more complex than the counter unit, where the three- or two-dimensional base units may be approximated as a two- or one-dimensional analog, and the like. The present invention relates to multiple counter units which are simpler than the base units but disposed in an arrangement which approximates the shape and/or arrangement of such base units. The present invention relates to the counter unit which are shaped and/or sized based upon the configuration of the base units and/or dispositions thereof. The present invention relates to various countering modes where a single counter unit counters a single base unit, at least two but not all of multiple base units, and/or all of the base units, where multiple counter units counter a single base unit, more base units or less multiple units, and the like. The present invention relates to various electric and/or magnetic shields which may be used alone or in conjunction with the counter units to minimize irradiation of the harmful waves from the system.

The present invention also relates to various methods of countering the harmful waves by the counter waves through source matching or wave matching. More particularly, the present invention relates to various methods of forming the counter unit as an analog of the base units and emitting the counter waves matching the harmful waves, various methods of approximating the base units by the simpler counter unit for the countering, various methods of approximating such base units by multiple simpler counter units, and the like. The present invention relates to various methods of disposing the counter unit along the wavefronts of the harmful waves and emitting the counter waves for matching such wavefronts of the harmful waves, various methods of disposing multiple counter units along the wavefronts of the harmful waves and emitting the counter waves with the counter units for matching such wavefronts, and the like. The present invention also relates to various methods of manipulating the wavefronts of such counter waves by disposing the counter unit closer to or farther away from the target space with respect to the base unit, various methods of controlling radii of curvature of the wavefronts of the counter waves by incorporating one or multiple counter units emitting such counter waves of the same or opposite phase angles, various methods of manipulating the wavefronts of the counter waves by disposing one or multiple counter units of the shapes similar to or different from the shapes of the base units, and the like. The present invention relates to various methods of countering the harmful waves irradiated by one or multiple base units by the counter waves emitted by the single or multiple counter units. Accordingly, the present invention relates to various methods of emitting the counter waves from a single counter unit for the harmful waves irradiated by one or more base units, various methods of emitting such counter waves by two or more counter units for the harmful waves irradiated by a single or multiple base units, and the like. The present invention also relates to various methods of minimizing irradiation of the harmful waves by incorporating such electric and/or magnetic shields, by incorporating one or both of such shields in conjunction with the above counter units, and the like.

The present invention further relates to various processes for providing various counter units and various electromagnetically-countered piezoelectric speaker systems incorporating one or multiple counter units therein. More particularly, the present invention relates to various processes for forming such counter units to emit the counter waves having the wavefronts similar to (or different from) the shapes of the counter units, various processes for forming the counter units as the above analogs of the base units, various processes for providing the counter units emitting the counter waves defining the similar or opposite phase angles, various processes for providing such counter units defining the wavefronts shaped similar to the harmful waves, various processes for disposing the counter units in a preset arrangement and emitting therefrom the counter waves which have the wavefronts similar to such an arrangement, and the like. The present invention relates to various processes for assigning a single counter unit to counter the harmful waves irradiated by a single base unit for local countering or to counter such harmful waves from multiple base units for a global countering, various processes for assigning multiple counter units to counter such harmful waves irradiated by a single base unit for the global countering or to counter the harmful waves from multiple base units for the local countering or global countering depending on numbers of the counter and base units. The present invention further relates to various processes for incorporating such electric and/or magnetic shields for minimizing the irradiation of the harmful waves, and various processes for minimizing the irradiation of such harmful waves by employing such shields as well as the above counter units.

The basic principle of the counter units of the generic electromagnetically-countered systems of this invention is to emit the counter waves which form the wavefronts similar (or identical) to those of the harmful waves but define the phase angles at least partially opposite to those of such harmful waves. Therefore, by propagating such counter waves to the target space, the counter waves can effectively counter the harmful waves in the target space by, e.g., canceling at least a portion of such harmful waves therein and/or suppressing the harmful waves from propagating theretoward. To this end, the counter units are arranged to emit the counter waves which define the wavefronts matching those of the harmful waves by various mechanisms. In one example, such counter units are shaped similar (or identical) to the base units of the waves sources, or arranged similar (or identical) to such base units and, therefore, emit the counter waves which can counter the harmful waves in the target space. In another example, such counter units are disposed along one or more of the wavefronts of the harmful waves and emit the counter waves which are similar (or identical) to the harmful waves and, accordingly, counter the harmful waves in the target space. In these two examples, the counter units are to emit the counter waves with the wavefronts which are similar (or identical) to the shapes of such counter units themselves, and such counter waves are to define the phase angles which are at least partially opposite to the phase angles of the harmful waves. In another example, the counter units are shaped differently from the base units, but are rather disposed in an arrangement in which the counter waves emitted therefrom may match such harmful waves in the target space. In another example, the counter units are disposed across different wavefronts of the harmful waves but are to emit the counter waves which are similar (or identical) to the harmful waves and, therefore, counter the harmful waves in the target space. In the last two examples, the counter units may be arranged to emit the counter waves with the wavefronts may or may not be similar (or identical) to the shapes of the counter units themselves, while the counter waves are to define the phase angles which are at least partially opposite to those of the harmful waves.

The basic principle of the counter units of various EMC systems may also be applied to various conventional devices. For example, the counter units may be included in any base units of electrically conductive wires, coils, and/or sheets or, in the alternative, into any electrically semiconductive and/or insulative wires, coils, and/or sheets for minimizing the irradiation of the harmful waves by countering such harmful waves by the counter waves, e.g., by canceling at least a portion of the harmful waves in the target space and/or suppressing the harmful waves from propagating toward the target space, where the counter units may be made of and/or include at least one electrically conductive, insulative or semiconductive material. The counter units may be implemented into any of such base units which define the shapes which may be formed by incorporating one or multiple wires, coils, and/or sheets, by modifying the shapes of one or multiple wires, coils, and/or sheets, where a few examples of the modified shapes may include a solenoid and toroid each formed by modifying the shape of such a coil. Therefore and in one example, such counter units may be implemented into various speakers such as cone-drive speakers, electrostatic speakers, and piezoelectric speakers for minimizing the irradiation of the harmful waves. Accordingly, any prior art devices including the electromagnetically-countered speakers such as earphones, headphones, wired phones, mobile phones, and audiovisual devices may be converted into the electromagnetically countered systems. Similarly, the counter units may be implemented into various microphones which are inverse examples of such speakers, and any prior art devices including such electromagnetically-countered microphones such as wired phones, mobile phones, audio and/or audiovisual sound systems, and an assembly of the earphone and microphone may be converted into the electromagnetically countered systems.

It is appreciated that various counter units of the generic EMC systems of this invention may be incorporated into any electrical and/or electronic devices each of which may include at least one base unit and, accordingly, may irradiate the harmful waves including electric waves (to be abbreviated as “EWs” hereinafter) and magnetic waves (to be abbreviated as “MWs” hereinafter) having frequencies of about 50 to 60 Hz and/or other EWs and MWs of higher frequencies. It is also appreciated that the generic EMC systems of this invention may also be incorporated into any portable or stationary electric and/or electronic devices which include at least one base unit detailed examples of which have been provided heretofore and will be provided hereinafter. It is further appreciated that such counter units may be provided in a micron-scale and incorporated to semiconductor chips and circuits such as LSI and VLSI devices and that such counter units may be provided in a nano-scale and incorporated into various nano devices including at least one base unit which in this case may be a single molecule or a compound or may be a cluster of multiple molecules or compounds.

Various system, method, and/or process aspects of such EMC speaker systems and various embodiments thereof are now enumerated. It is to be understood, however, that following system, method, and/or process aspects of this invention may be embodied in many other different forms and, accordingly, should not be limited to such aspects and/or their embodiments which are to be set forth herein. Rather, various exemplary aspects and their embodiments described hereinafter are provided such that this disclosure will be thorough and complete, and fully convey the scope of this invention to one of ordinary skill in the relevant art.

Unless otherwise specified, it is to be understood that various members, units, elements, and parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

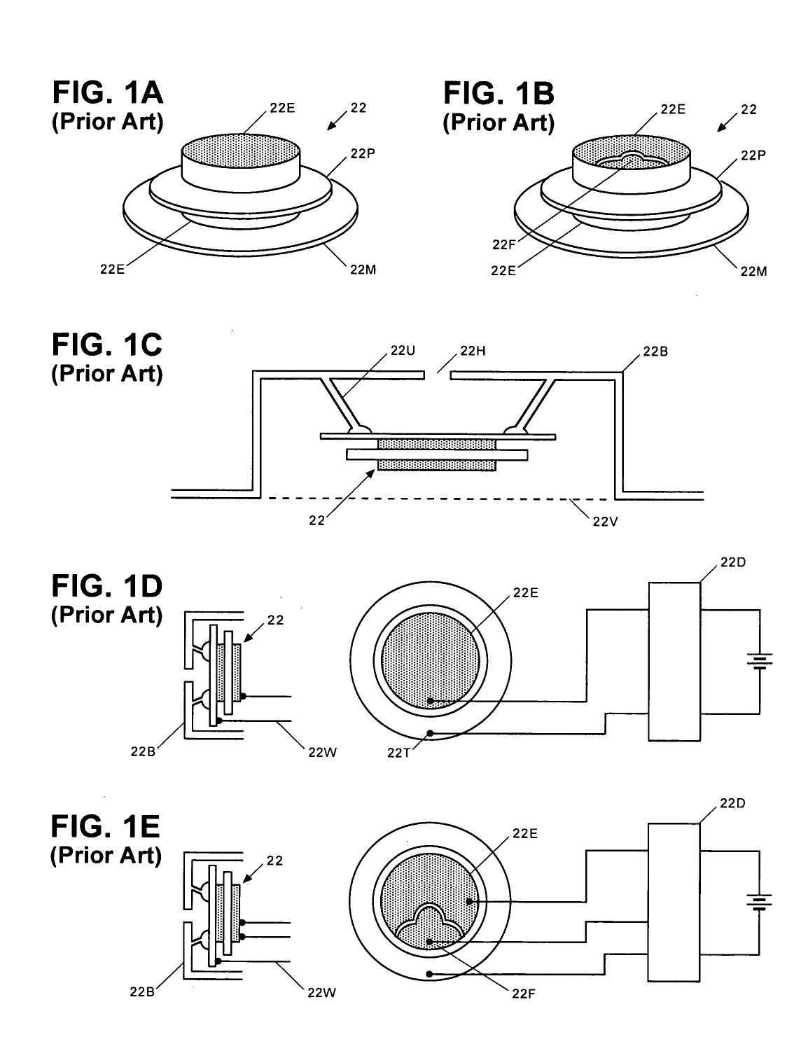

Despite their performance limitations when compared to their cone-drive counterparts, various piezoelectric speakers have found a widespread usage thanks to their compact configurations, lower cost of manufacture, and the like. FIGS. 1A through 1E depict various views of a typical conventional piezoelectric speaker, where FIGS. 1A and 1B show perspective views of conventional piezoelectric speakers operating on an external drive mechanism and on a self-drive mechanism, respectively, FIG. 1C is a cross-sectional view of the piezoelectric speaker of FIG. 1A or 1B incorporated into a body, and FIGS. 1D and 1E are cross-sectional and top views of such piezoelectric speakers connected to corresponding drivers.

As described in FIGS. 1A and 1B, a conventional piezoelectric speaker (to be abbreviated as a “piezo speaker”) 22 includes at least one piezoelectric plate (to be abbreviated as a “piezo plate”) 22P which is arranged to deform or distort when electric energy (i.e., electric voltage or energy or, more particularly, electric voltage) is applied thereto or thereacross. The piezo plate 22P is sandwiched by a pair of conductive electrodes 22E which serve to supply the energy to opposite sides of the piezo plate 22P. A metal plate 22M is also provided to electrically contact one of such electrodes 22E while providing mechanical support thereto. Each electrode 22E of FIG. 1A defines an unitary contact such that the energy is applied thereacross at the same polarity and with the same amplitudes. In contrary, at least one electrode 22E of FIG. 1B defines at least two electrically isolated portions such that one of the electrodes is to serve as a main electrode 22E and that another of such electrodes is to serve as a feedback electrode as will be described in FIG. 1E. As depicted in FIG. 1C, the piezo speaker 22 is encased inside a body 22B for normal sound-generating operation. Such a body 22B defines an open front and a closed rear, and typically forms a cavity which extends from the front to the rear and into which the speaker 22 is disposed. The speaker 22 is fixed in a preset location inside the cavity of the body 22B by fixedly coupling the metal plate 22M of the speaker 22 with multiple couplers 22U. Once the speaker 22 is disposed in the cavity, a perforated cover 22V is disposed over the front, thereby concealing the piezoelectric speaker 22 inside the cavity. The body 22B also forms a hole 22H in the rear in order to increase the sound pressure.

Such piezoelectric speakers 22 generate sound waves based on two different mechanisms. In one example of FIG. 1D, the speaker 22 of FIG. 1A electrically couples with a driver 22D through a pair of electric contacts 22T, one of which is provided on one of the electrodes 22E, while another of which is formed on the metal plate 22M which is in turn electrically coupled to another electrode 22E. The driver 22D typically includes an external oscillating circuit such as, e.g., a multivibrator, which can supply such oscillating energy (i.e., voltage or current) to the speaker 22, where this driving method is referred to as an “external drive” mechanism. Through this mechanism, the piezoelectric speaker 22 can work as a generic speaker. In another example of FIG. 1E, the speaker 22 of FIG. 1B electrically couples with a different driver 22D through three electric contacts 22T, one of which is provided on a main electrode 22E, another of which is formed on a feedback electrode 22F, and the last of which is provided on the metal plate 22M which in turn electrically couples to another electrode 22E. The driver 22D similarly includes an oscillating circuit such as, e.g., a Hartley-type circuit, and drives the speaker 22 at a resonance frequency. It is appreciated that the piezoelectric speakers 22 driven by the self-drive mechanism generally work as sounders or buzzers, while those 22 driven by the external-drive mechanism generally work as sounders and speakers.

In operation, the piezoelectric speaker 22 is installed inside the cavity of the body 22B, and the open front is sealed with the cover 22V. The electric energy is then supplied to the piezo speaker 22 through the electric contacts 22T provided on one of such electrodes 22E and on the metal plate 22M. When the speaker 22 is to operate on the self-drive mechanism, the energy is also supplied to another electric contact 22T formed on the feedback electrode 22F. When the energy is delivered thereto, the piezo plate 22P begins to deform or distort while bending concavely toward one of its opposing sides onto which the energy is supplied with the positive polarity, where such distortion tends to propagate from the electric contact 22T toward an opposite portion of the piezo plate 22P. Thereafter, the driver 22D reverses the polarity of the energy and supplies such energy onto the piezo plate 22P which then deforms or distorts while bending in opposite direction, ie., concavely bending toward another of its opposing sides onto which such energy is now supplied with the positive polarity. As the driver 22D reverses the polarity of the energy in an alternating mode, the piezo plate 22P also deforms or distorts in an alternating fashion, thereby compressing and rarefying air and generating audible sound waves. The rear hole 22H of the body increases the sound pressure and the sound waves propagate out of the speaker 22 through numerous openings provided in the cover 22V. During such sound-generating operation, the piezo plate 22P, electrodes 22E, and metal plate 22M irradiate harmful electromagnetic waves (to be abbreviated as the “harmful waves” hereinafter) due to the oscillating energy and serve as primary base units of the piezoelectric speaker 22. In addition, wires 22W and various conductive, semiconductive, and/or insulative portions of such a speaker 22 in which the electric current flows or across which the electric voltage is applied also irradiate the harmful waves and serve as secondary base units of the speaker 22. It is to be understood that all of such primary and secondary base units are to be referred to as the “base units” or to be collectively referred to as the “base unit” hereinafter.

In order to counter such harmful waves irradiated from various base units of the conventional piezoelectric speakers, various counter units are incorporated into such speakers for emitting counter electromagnetic waves (to be abbreviated as the “counter waves” hereinafter) and countering such harmful waves with the counter waves, e.g., by canceling at least a portion of the harmful waves by the counter waves, by suppressing the harmful waves from propagating toward a specific direction, and the like. Accordingly, such conventional speakers incorporated with one or more of such counter units may be converted into the EMC piezoelectric speaker systems of this invention. Various counter units and various countering mechanisms are now enumerated. It is to be understood, however, that following counter units and countering mechanisms of the present invention may be embodied in many other different forms and, accordingly, should not be limited to such units and mechanisms which are to be set forth herein. Rather, various exemplary counter units and countering mechanisms described hereinafter are provided such that this disclosure will be thorough and complete, and fully convey the scope of this invention to one of ordinary skill in the relevant art.

In a generic aspect of this invention, an EMC piezoelectric speaker system typically includes at least one wave source and at least one counter unit, and counters the harmful waves irradiated from the wave source by the counter waves which are emitted by such counter units. The wave source always includes one or multiple base units which are the real source of the harmful waves, i.e., those irradiating the harmful waves, affecting paths of propagation of the harmful waves while maintaining or altering their amplitudes and/or phase angles, and so on, where examples of such a base unit may include, but not be limited to, a conductive or semiconductive article such as a wire, a strip, a plate, a ring thereof, a coil thereof, a spiral thereof, and a mesh thereof all of which emit such harmful waves when electric current flows therein, an insulative article such as a wire, a strip, a plate, a ring thereof, a coil thereof, a spiral thereof, and a mesh thereof all of which can not carry such electric current but emit the harmful waves when electric voltage is applied thereacross, a permanent magnet which can affect the direction, paths, and/or amplitudes of such harmful waves, and the like. The wave source further includes at least one optional part which mechanically supports or retains such a base unit but which neither irradiates nor affects the propagation paths of the harmful waves, where examples of the optional part may include, but not be limited to, a case enclosing the base unit, a protective cover, a coupler, any parts in which such current does not flow, any parts across which the voltage is not applied, and the like. The counter unit is arranged to emit such counter waves capable of countering the counter waves, e.g., by canceling the harmful waves and/or by suppressing the harmful waves from propagating along a specific direction. The counter unit may be arranged to counter the harmful waves in every direction from the base unit of the wave source, e.g., above, below and around such a base unit. However, such an embodiment may be costly to implement, may not be feasible, and may not be necessary, particularly when the EMC system is to be used in a specific orientation by an user who is to be protected from such harmful waves. In such a case, the counter is arranged to counter the harmful waves only around a specific target space (or area) which is generally defined between the base unit and the user (or a specific body part thereof).

In order for the counter waves to counter (i.e., cancel and/or suppress) such harmful waves, there are a few prerequisite which the counter waves must satisfy. The first is the phase angles of the counter waves. In general, such counter waves preferably define the phase angles which are at least partially or substantially opposite to those of the harmful waves so that the counter waves may cancel and/or suppress the harmful waves when propagated to the target space from the same side as the base unit. In the alternative, the counter waves may have the phase angles which are at least partially similar (or identical) to those of the harmful waves so that such counter waves cancel and/or suppress the harmful waves when propagated to the target space from an opposite side of the base unit. When the system includes multiple counter units, each counter unit may emit the counter waves having the same, similar or different phase angles. The next is the amplitudes of the counter waves. In contrary to the phase angles, such counter waves may define various amplitudes which, however, effectively counter the harmful waves in the target space. When disposed closer to the target space than the base unit, the counter unit has only to emit the counter waves with the amplitudes less than those of the harmful waves. By the same token, the counter unit disposed farther from the base unit has to emit the counter waves with the amplitudes greater than those of the harmful waves, while the counter unit disposed flush with the base unit with respect to the target space has to emit the counter waves with the similar or same amplitudes as the harmful waves. When the system includes multiple counter units, all of such counter units may be disposed at similar distances from the base unit and/or target space or, alternatively, at least two of the counter units may be disposed at different distances from the base unit and/or target space. In addition to the distances and/or dispositions thereof, such counter waves may have various intensities depending upon whether the counter waves counter the harmful waves throughout an entire portion of the target space or only at preset positions inside such a target space. For example, the counter unit preferably emits the counter waves which are capable of countering the harmful waves throughout the target space as the user may be situated anywhere across the target space. When the user is to be situated only in preset positions of the target space, however, the counter may be shaped, sized, arranged, and then disposed to emit the counter waves which best counter the harmful waves in such positions but not with such an efficiency in other parts of the target space.

Once the counter unit is arranged to emit the counter waves defining proper phase angles and amplitudes, such a counter unit may be shaped, sized, arranged, and disposed in order to counter the harmful waves depending on detailed countering mechanisms.

In one example, the counter unit may be shaped, sized, and/or arranged similar (or identical) to the base unit, which is to be referred to as a “source matching” hereinafter. The basic concept of the “source matching” is that the counter unit may emit the counter waves defining wavefronts similar to a configuration (i.e., a shape, a size, and an arrangement) of the counter unit and that such wavefronts of the counter waves automatically match wavefronts of the harmful waves, and the counter waves counter the harmful waves due to the similarity between the configurations of the counter and base units. When the system includes multiple base units, the single counter unit may then be arranged to emit the counter waves capable of countering the harmful waves irradiated by one of such base units or countering a sum of the harmful waves irradiated by at least two or all of such base units. When the system includes multiple counter units, such counter units may emit the counter waves capable of countering the harmful waves emitted by the single base unit or multiple base units. When the system includes multiple counter and base units, such counter waves from each counter unit may counter the harmful waves by each base unit, a sum of such counter waves from at least two counter units may counter the harmful waves from one of the base units, the counter waves from a single counter unit may counter a sum the harmful waves from at least two base units, a sum of the counter waves from all of such counter units may then counter a sum of the harmful waves from all of the base units, and the like. It is preferred in this “source matching” that the counter unit emit the counter waves with the wavefronts of the configuration similar to that of the counter unit. It is, however, possible that such a counter unit emits the counter waves with the wavefronts with the configuration different from that of the counter unit, that the wavefronts of a sum of the counter waves emitted by multiple counter units may have the configuration different from the configuration of each counter unit or the arrangement of the counter units, and the like, as long as the counter waves may counter the harmful waves in such a target space.

In another example, the counter unit may be disposed (i.e., oriented, aligned, and/or positioned) in such a manner that at least one wavefront of the counter waves may match at least one wavefront of the harmful waves, where such a mechanism will be referred to as a “wave matching” hereinafter. The basic concept of the “wave matching” lies in the that the counter waves may counter the harmful waves when the counter unit is disposed in such a position to match the wavefronts of such counter waves with the wavefronts of the harmful waves as far as the configuration of the counter unit may be properly adjusted to satisfy such “wave matching.” When the system includes multiple base units, a single counter unit may be arranged to emit the counter waves capable of matching and countering the harmful waves irradiated by one of the base units or, alternatively, matching and countering a sum of the harmful waves irradiated by at least two or all of the base units. When such a system includes multiple counter units, the counter units may emit the counter waves capable of countering the harmful waves emitted by a single base unit or multiple base units. When the system includes multiple counter and base units, such counter waves from each counter unit may counter the harmful waves by each base unit, a sum of the counter waves emitted by at least two counter units may counter the harmful waves from one of the base units, the counter waves from a single counter unit may counter a sum the harmful waves from at least two base units, a sum of the counter waves from all of such counter units may counter a sum of the harmful waves irradiated by all of the base units, and the like, as long as at least one of the wavefronts of the counter waves may match at least one of the wavefronts of the harmful waves in the target space.

Various counter units constructed based on the source matching and/or wave matching are to be disclosed hereinafter. It is appreciated in the source matching that there does not exist any one-to-one correlations between the configuration of such a counter unit and the configuration of the counter waves emitted thereby. That is, the counter waves of certain configuration (or wave characteristics) may be obtained by a single counter unit which defines a certain shape and size and is provided in a certain arrangement, by another counter unit which defines a similar shape and size but is provided in another arrangement, by another counter unit which has a different shape and size but is provided in a similar arrangement, by at least two counter units defining preset shapes and sizes and provided in a preset arrangement, by the same number of counter units defining different shapes and/or sizes or in a different arrangement, by a different number of counter units defining similar shapes and/or sizes or in a similar arrangement. It is similarly appreciated in the above wave matching that there does not exist an one-to-one correlation between the disposition of the counter unit and the wavefronts of the counter waves emitted by the counter unit. In other words, the wavefronts with certain shapes may be obtained by a single counter unit which defines a certain configuration and is disposed in a certain position with respect to the base unit and/or target space, by another single counter unit which forms another configuration and which is disposed in another position, by at least two counter units which have preset configurations and are disposed in preset positions, by the same number of counter units defining different configurations and disposed in different positions, by a different number of counter units which define different configurations and which are disposed in different positions, and the like. It is, accordingly, appreciated that such counter units may be embodied in many other different forms and should not be limited to the following aspects and/or their embodiments which are to be set forth herein. Rather, various exemplary aspects and/or embodiments described herein are provided so that this disclosure will be thorough and complete, and fully convey the scope of the present invention to one of ordinary skill in the relevant art.

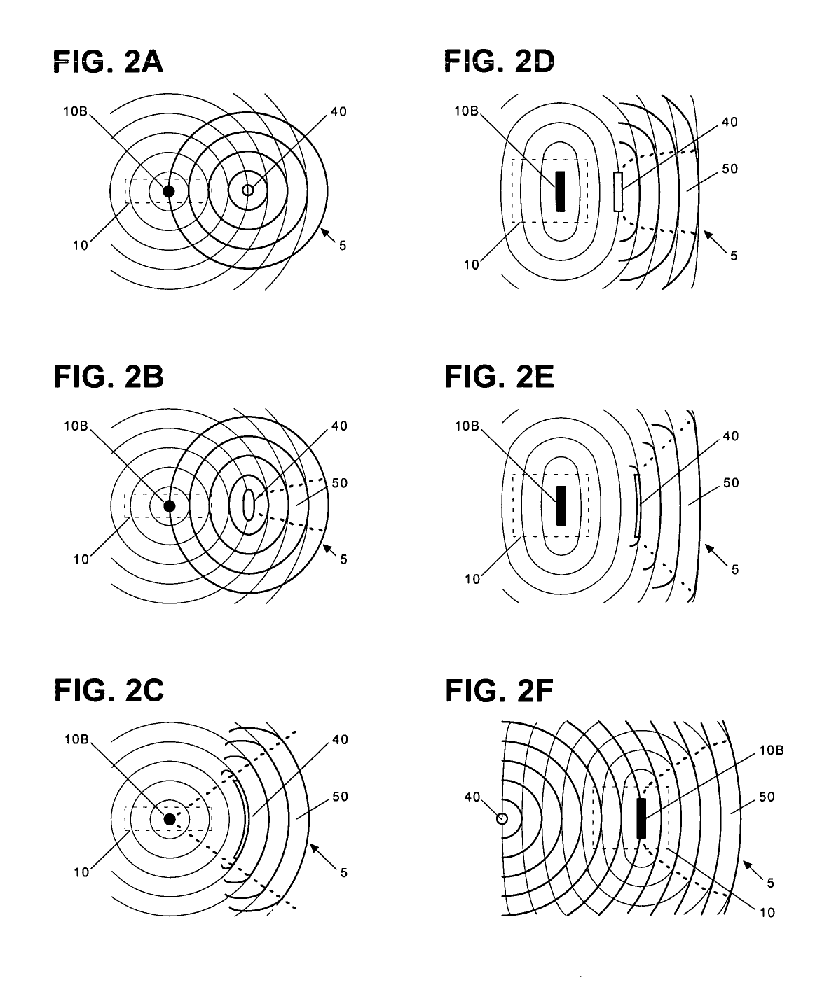

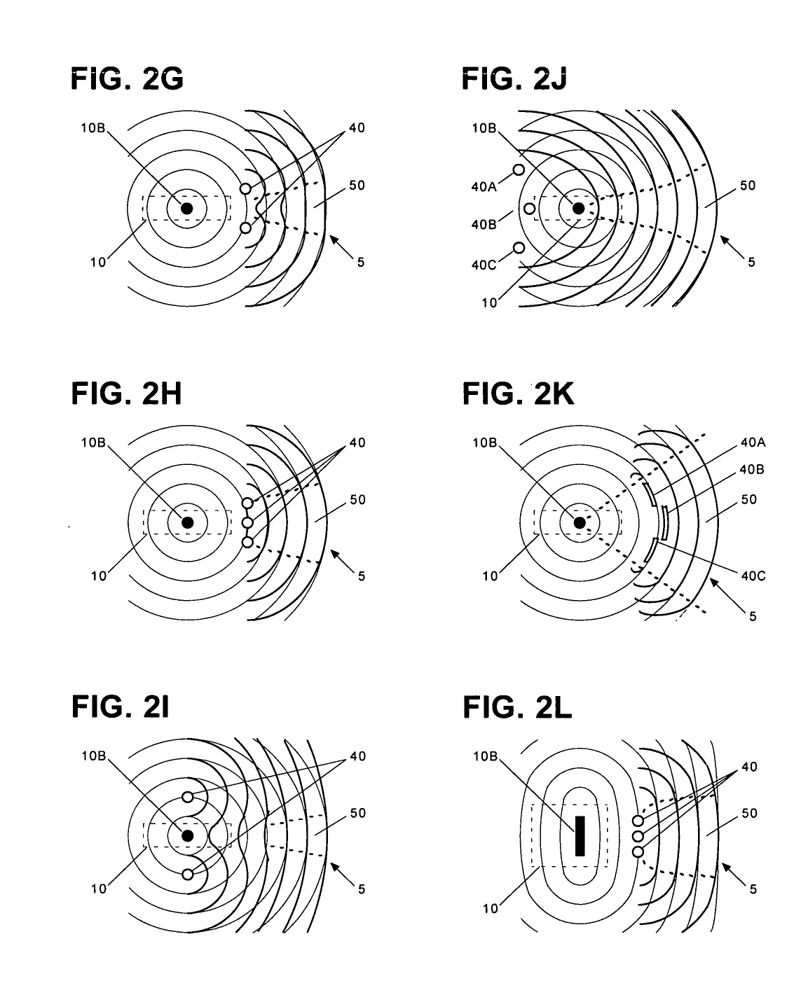

In another aspect of the present invention, a single generic counter unit may be provided for a single generic base unit to counter the harmful waves from the base unit by the counter waves from the counter unit. FIGS. 2A to 2F show top schematic views of exemplary electromagnetic countering mechanisms in each of which a single counter unit emits the counter waves capable of countering the harmful waves which are irradiated from a single base unit of a single wave source according to the present invention, where the base unit is a point source in FIGS. 2A to 2C and 2F, while the base unit is an elongated source in FIGS. 2D and 2E. It is appreciated that these figures, however, may also be interpreted in different perspectives. For example, such figures may be interpreted as the top cross-sectional views, where the base units of FIGS. 2A to 2C and 2F are wires extending perpendicular to the sheet, and the base units of FIGS. 2D and 2E are strips or rectangular rods also extending normal to the sheet. In another example, the figures may be interpreted as sectional views of more complex articles, where the base units of FIGS. 2A to 2C and 2F may correspond to sections of coils, spirals, meshes, and the like, while the base units of FIGS. 2D and 2E may similarly correspond to sections of curvilinear rods or strips. It is also appreciated in these figures that such base units are enclosed in the wave sources which may be cases or other parts of such a system which do not irradiate such harmful waves. It is further appreciated in all of these figures that the EMC systems are disposed in such a way that the target space is formed to the right side of the counter and base units.

In one exemplary embodiment of such an aspect of the invention and as described in FIG. 2A, an EMC system 5 includes a single rectangular wave source 10 and a single counter unit 40, where the source 10 includes therein a single base unit 10B defining a shape of a point source. The counter unit 40 is similarly shaped as another point source and disposed to the right side of the base unit 10B. In this arrangement, the counter unit 40 emits the counter waves of which wavefronts are identical to those of the harmful waves irradiated by the base unit 10B. Because the counter unit 40 is disposed closer to a hypothetical target space on the right side of the figure, such counter wavefronts always define radii of curvature smaller than those of the harmful wavefronts. Accordingly, the counter unit 40 may counter (i.e., cancel or suppress) the harmful waves only along a line connecting the counter and base units 40, 10B or in its vicinity. It is appreciated that such an embodiment corresponds to the source matching which turns out to be ineffective due to a discrepancy in the radii of curvature of the wavefronts of the counter and harmful waves.

In another exemplary embodiment of this aspect of the invention and as depicted in FIG. 2B, an EMC system 5 includes a single counter unit 40 and a single rectangular wave source 10 with a single base unit 10B disposed therein. The base unit 10B is similar to that of FIG. 2A, however, the counter unit 40 is elongated, oriented vertically along its length, and disposed on the right side of the base unit 10B. Due to its elongated shape, the counter unit 40 emits the counter waves whose wavefronts are also elongated vertically and, therefore, define the radii of curvature which are greater than those of FIG. 2A and which match those of the harmful waves. Accordingly, such a counter unit 40 defines a target space 50 across which the counter waves counter the harmful waves to a preset extent. It is to be understood that such an embodiment corresponds to the wave matching mechanism in that the counter unit 40 is shaped similar to one of the harmful wavefronts.

In another exemplary embodiment of this aspect of the invention and as depicted in FIG. 2C, an EMC system 5 includes a single counter unit 40 and a single rectangular wave source 10 with a single base unit 10B disposed therein. The base unit 10B is similar to that of FIG. 2A, however, the counter unit 40 is shaped and sized to conform to one wavefront of such harmful waves. That is, the counter unit 40 is shaped as an arc and disposed in an orientation concave to the right side of the figure or to the target space 50. Because of its arcuate shape, such a counter unit 40 emits the counter waves of which wavefronts are also arcuate and, therefore, define the radii of curvature which are similar or identical to those of the harmful waves. Therefore, the counter unit 40 defines a target space 50 across which the counter waves counter the harmful waves to a preset extent. It is appreciated that such an embodiment corresponds to another wave matching mechanism and that the counter waves emitted form this arcuate counter unit 40 better match such harmful wavefronts and define the target space 50 which expands over a wider angle around the base unit 10B than those of FIGS. 2A and 2B.

In another exemplary embodiment of this aspect of the invention and as depicted in FIG. 2D, an EMC system 5 includes a single counter unit 40 and a single rectangular wave source 10 with a single base unit 10B. Contrary to those of the above, this base unit 10B is rectangular and oriented vertically along its length or its long axis, and irradiates the harmful waves of which wavefronts define vertical and relatively straight portions which are attributed to the length or long axis of the base unit 10B. The counter unit 40 is shaped and sized similar or identical to the base unit 10B, and disposed in the same orientation as the base unit 10B. This orientation may be viewed to dispose the counter unit 40 along the vertical straight portions of the wavefronts of the harmful waves. The counter unit 40 also emits the counter waves whose wavefronts define vertical and relatively straight portions, similarly due to the length or long axis thereof. Because such portions of the counter wavefronts match those of the harmful wavefronts, the counter unit 40 forms the target space 40 to the right side. This embodiment corresponds to the source matching, wave matching or their combination. It is to be understood that the counter unit of FIG. 2A is shaped and sized as the base unit but ineffective due to a discrepancy in the radii of curvature between the wavefronts of the counter and source waves. The counter unit 40 of this embodiment is similarly shaped and sized as the base unit 10B but efficiently counter such harmful waves in the target space 50. The primary reason of this countering lies in the fact that both of the harmful and counter waves define along their wavefronts the vertical straight portions which generally do not depend upon the radii of curvature thereof. Otherwise, configuring the counter unit 40 similar to the base unit 10B and then disposing such a counter unit 10 between the base unit 10B and target space generally do not provide an efficient countering, where further details of this front arrangement are to be provided below. It is appreciated that such an embodiment corresponds to the source matching in which the counter unit 40 is shaped, sized, and/or arranged similar (or identical) to the base unit 10B.

In another exemplary embodiment of this aspect of the invention and as depicted in FIG. 2E, an EMC system 5 includes a single counter unit 40 and a single rectangular wave source 10 with a single base unit 10B which is similar to that shown in FIG. 2D. The counter unit 40, however, is shaped and sized to conform to one wavefront of such harmful waves. Similar to that of FIG. 2C, the counter unit 40 is shaped as an arc and disposed in an orientation concave to the right side of the figure or target space 50. Because of its arcuate shape, such a counter unit 40 emits such counter waves of which wavefronts are also arcuate and, therefore, define the radii of curvature which are similar or identical to those of the harmful waves, not only along their vertical straight portions but also along their curved portions, mainly due to the arcuate shape of the counter unit 40. Accordingly, such a counter unit 40 defines a target space 50 which also expands over a wide angle therearound and across which the counter waves effectively counter such harmful waves. It is to be understood that this embodiment corresponds to another wave matching mechanism.

In another exemplary embodiment of this aspect of the invention and as depicted in FIG. 2F, an EMC system 5 includes a single counter unit 40 and a single rectangular wave source 10 which has a single base unit 10B therein. Both of the counter and base units 40, 10B are identical to those of FIG. 2A. However, the counter unit 40 is disposed on an opposite side of a target space 50 with respect to the base unit 10B and aligned with the base unit 10B as are the cases with the preceding figures. In this arrangement, the counter unit 40 emits the counter waves of which wavefronts are identical to those of the harmful waves irradiated by the base unit 10B. Because the counter unit 40 is disposed farther away from the target space 50, such counter wavefronts define the radii of curvature which approach and then match those of the harmful wavefronts when disposed at a proper distance from the base unit 10B. Accordingly, the counter unit 40 disposed in this rear arrangement may effectively counter the harmful waves and defines the target space 50 expanding over a wide angle around the base unit 10B. It is appreciated that the sole difference between the counter units of FIGS. 2A and 2F is their dispositions, i.e., one disposed in the “front arrangement” of FIG. 2A and another disposed in the “rear arrangement” of FIG. 2F. It is also appreciated that the rear arrangement is not necessarily superior to the front arrangement and that further details of selecting the proper arrangement are to be provided below. It is further appreciated that this embodiment corresponds to the wave matching in which the counter unit 40 is disposed at the position for matching the harmful wavefronts with the counter wavefronts.

Although not included in the figures, a single counter unit may be disposed in an arrangement flush with the base unit with respect to the target space, flush with a direction of propagation of the harmful waves, flush with another direction along which electric current flows in the base or counter unit, flush with another direction in which electric voltage is applied across the base or counter units, and so on. In this “lateral” arrangement, the radii of curvature of the counter wavefronts automatically match those of the harmful wavefronts and, therefore, the counter waves effectively match and then counter the harmful waves in the target space. For this arrangement, however, the wave source has to provide a space in which the counter unit may be incorporated. Therefore, the counter unit may be implemented inside the wave source and close to the base unit thereof when applicable. Otherwise, the counter unit may instead be disposed over, below or beside the wave source and as close to the base unit as possible. It is appreciated, however, that the counter unit disposed next to the base unit may propagate the counter waves onto the base unit and obstruct normal operation of the base unit. Accordingly, the lateral arrangement is preferably selected only when such an arrangement may not obstruct the normal operation of the base unit, wave source including such or EMC system including such. When the lateral arrangement does not affect the operation of the base unit but the counter unit may not be disposed close to the base unit due to space limitations, two or more counter units may be disposed on opposing sides (e.g., left and right, top and bottom, front and rear, and the like) of such a base unit and as close to the base unit as possible. Such counter units may also be arranged to emit the counter waves a sum of which may be symmetric or skewed toward a preset direction based on the wave characteristics of the harmful waves.

In another aspect of the present invention, multiple generic counter unit may be provided for a single generic base unit for countering the harmful waves irradiated by the base unit with the counter waves emitted by all of such counter units or emitted by at least two but not all of such counter units. FIGS. 2G to 2L are top schematic views of exemplary electromagnetic countering mechanisms in each of which multiple counter units emit counter waves to counter harmful waves irradiated from a single base unit of a single wave source according to the present invention, where the base unit is a point source in FIGS. 2G to 2K, while the base unit is an elongated source in FIG. 2L. It is appreciated that these figures, however, may also be interpreted in different perspectives. For example, such figures may be viewed as the top cross-sectional views, where the base units of FIGS. 2G to 2K are wires extending perpendicular to the sheet, and the base unit of FIG. 2L is a strip or a rectangular rod also extending normal to the sheet. In another example, the figures may be interpreted as sectional views of more complex articles, where the base units of FIGS. 2G to 2K may correspond to sections of coils, spirals, meshes, and the like, whereas the base unit of FIG. 2L may similarly correspond to sections of curvilinear rods or strips. It is also appreciated in these figures that such base units are enclosed in the wave sources which may be cases or other parts of such a system which do not irradiate such harmful waves. It is further appreciated in all of these figures that the EMC systems are disposed in such a way that the target space is formed to the right side of the counter and base units.

In one exemplary embodiment of such an aspect of the invention and as described in FIG. 2G, an EMC system 5 includes two counter units 40 and a single wave source 10 including a single base unit 10B. The base unit 10B is similar to those of FIGS. 2A to 2C, while a pair of counter units 40 are disposed between the base Ni 10B and a target space 50. Such counter units 40 are also disposed symmetric to the base unit 10B and flush with each other with respect thereto, i.e., the counter units 40 are disposed at an equal distance from the base unit 10B and/or target space 50. Such counter units 40 are arranged to emit the counter waves of the same phase angles so that the wavefronts of the counter waves from each counter unit 40 are superposed onto each other while increasing their amplitudes. As the counter waves propagate, their wavefronts which correspond to a sum of each set of wavefronts from each counter unit 40 increase their radii of curvature as if they are emitted by the elongated counter units of FIGS. 2B to 2E. Therefore, the counter wavefronts match the harmful wavefronts, and the pair of counter units 40 match and counter the base unit 10B while defining the target space 50 expanding over a limited angle therearound. It is to be understood that disposing two or more counter units 40 result in flattening the wavefronts of the counter waves and increasing the radii of curvature of the superposed portions of the counter wavefronts. It is further appreciated that this arrangement corresponds to the wave matching in which multiple counter units 40 are disposed along one wavefront of the harmful waves.

In another exemplary embodiment of this aspect of the invention and as depicted in FIG. 2H, an EMC system 5 includes three counter units 40 and a single wave source 10 enclosing therein a single base unit 10B. The base unit 10B is similar to those of FIGS. 2A to 2C, while the counter units 40 are similar to those of FIG. 2G such that all counter units 40 are disposed between the base unit 10B and target space 50 and flush with the base unit 10B. However, the system 5 includes one more counter unit 40 so that an array of three counter units 40 approximate the wavefronts of such harmful waves better than those of FIG. 2G. Accordingly, the counter units 40 emit the counter waves which better counter the base unit 10B and define the target space 50 expanding over a wider angle therearound than those of FIG. 2G. It is appreciated that disposing three counter units 40 result in further flattening the superposed wavefronts of the counter waves and also result in increasing the radii of curvature of such portions of the wavefronts of the counter waves. It is also appreciated that this arrangement is another wave matching where all three counter units 40 are disposed along one wavefront of the harmful waves.

In another exemplary embodiment of this aspect of the invention and as depicted in FIG. 2I, an EMC system 5 includes two counter units 40 and a single wave source 10 including a single base unit 10B which is similar to those of FIGS. 2A to 2C. Two counter units 40 are disposed on opposite sides of the base unit 10B at an equal distance therefrom and also flush with the base unit 10B with respect to a target space 50. Similar to those of all of the preceding embodiments, such counter units 40 emit the counter waves defining the similar or identical phase angles so that the counter waves emitted by each of such counter units 40 superpose onto each other for not only increasing their amplitudes but also flattening the superposed portions of their wavefronts while increasing the radii of curvature of such wavefronts. Accordingly, the counter units 40 counter the harmful waves and define the target space 50 spanning around a rather limited angle therearound. It is appreciated that this arrangement is rather the source matching than the wave matching in that the counter units 40 are disposed in the symmetric arrangement and effect the elongated counter unit arranged flush with the base unit 10B.

In another exemplary embodiment of this aspect of the invention and as depicted in FIG. 2J, an EMC system 5 includes three counter units 40 and a single wave source 10 enclosing therein a single base unit 10B which is similar to those of FIGS. 2A to 2F. Contrary to those of FIG. 2H, three counter units 40 are disposed on an opposite side of a target space 50 with respect to the base unit 10B. The counter units 40 are arranged flush with each other relative to the base unit 10B and target space 50 and also spaced away from each other at an equal distance. Similar to those of FIGS. 2G to 2I, both of outer counter units 40A, 40C are arranged to emit the counter waves defining the phase angles at least partially opposite to those of the harmful waves so that superposed portions of the wavefronts of the counter waves are flattened while increasing their radii of curvature. Contrary to those of the preceding figures, a middle counter unit 40B is arranged to emit the counter waves defining the phase angles which are at least partially similar to those of such harmful waves and opposite to those of the counter waves emitted by the outer counter units 40A, 40C. Therefore, a net effect of incorporating the middle counter unit 40B is to sharpen the curvature of the superposed portions of the wavefronts of a sum of the counter waves and to define the target space 50 expanding around a narrower angle around the base unit 10B, as manifest in a comparison between the target spaces 50 of FIGS. 2F and 2J. That is, by incorporating multiple counter units 40A-40C emitting the counter waves of the phase angles opposite to each other, it is feasible to precisely manipulate the wavefronts of the sum of such counter waves and their radii of curvature for better matching the wavefronts of the harmful waves. It is appreciated that such an embodiment may corresponds to the source matching, wave matching or a combination thereof.

The counter units 40A-40C of this embodiment may be incorporated in different arrangements. For example, only two counter units may be included to emit the counter waves with opposite phase angles, where resulting wavefronts of the sum of the counter waves are not symmetric but skewed to one or an opposite side. In addition, the distances between the counter units may be manipulated to adjust the wavefronts of a sum of the counter waves regardless of the number of the counter units. Moreover, the counter units emitting the counter waves defining the phase angles similar to those of the harmful waves may be employed as the outer units to further sharpen the superposed portions of the counter waves.

In another exemplary embodiment of this aspect of the invention and as depicted in FIG. 2K, an EMC system 5 includes three counter units 40 and a single wave source 10 enclosing therein a single base unit 10B which is similar to those of FIGS. 2A to 2C. The counter units 40A-40C are also similar to those of FIG. 2H so that all of such counter units 40A-40C are disposed between the base unit 10B and target space 50 and similar to each other, that the counter units 40A-40C emit the counter waves of the same or similar phase angles, and so on. However, each counter unit 40A-40C is arranged to form an arcuate article shaped and sized to match a portion of a wavefront of the counter waves. In addition, both of upper and lower counter units 40A, 40C are spaced away from each other and also disposed along one wavefront of the harmful waves, whereas a middle counter unit 40B is disposed between the upper and lower counter units 40A, 40C and along an adjacent wavefront of the harmful waves in such a manner that superposed portions of the wavefronts of a sum of the counter waves are flattened while defining larger radii of curvature and match the wavefronts of the harmful waves, thereby forming a target space 50 which expands over a wide angle around the base unit 10B. It is to be understood that this arrangement is another wave matching where all three counter units 40A-40C are disposed along multiple wavefront of the harmful waves.

In another exemplary embodiment of this aspect of the invention and as depicted in FIG. 2L, an EMC system 5 includes three counter units 40 and a single wave source 10 enclosing therein a single base unit 10B. While the base unit 10B is similar to those of FIGS. 2D and 2E, the counter units 40 are similar to those of FIG. 2H and emit the counter waves which are flattened and define vertical straight portions therealong. Therefore, the counter waves match the vertical straight portions of the harmful waves and define a target space 50 similar to that of FIG. 2D. It is appreciated that this embodiment is another source matching in which three counter units 40 approximate the elongated base unit 10B.

In another aspect of the present invention, a single generic counter unit may also be provided for multiple generic base units for countering the harmful waves from such base units by the counter waves from the counter unit. In one example, such a counter unit may be arranged to counter a sum of the harmful waves irradiated by each base units, where detailed disposition of the counter unit may depend upon configurations and/or dispositions of the base units, amplitudes and/or directions of the harmful waves irradiated by such base units, and the like. Based thereupon, the counter unit may be disposed symmetrically to all or at least some of the base units, may be incorporated in the front, rear or lateral arrangement, and the like, where such arrangements are generally referred to an “global or overall countering” hereinafter. In another example, the counter unit is rather arranged to counter the harmful waves irradiated by only one of multiple base units, where such an arrangement is generally referred to as “local or individual countering” hereinafter. This local countering may only be effective when other uncountered base units irradiate negligible amounts of such harmful waves, when other uncountered base units irradiate non-negligible amounts of the harmful waves to other directions than the target space, and the like. Otherwise, it is preferred to manipulate the counter unit to counter the harmful waves of the uncountered base units, to include additional counter units for countering those harmful waves, and the like.

It is appreciated that various countering mechanisms described hereinabove for a single base unit may equally be applied to the system with multiple base units in the global countering mechanism. That is, the above countering mechanisms may be applied not to such harmful waves irradiated by the single base unit but to a sum of the harmful waves irradiated by multiple base units. When the system is to operate in the local countering mechanism, the aforementioned mechanisms may also be applied to each of multiple base units regardless of an exact number of such base units.

In another aspect of the present invention, multiple generic counter unit may also be provided for multiple generic base units for countering the harmful waves from such base units by the counter waves from the counter unit. In one example, multiple counter units are provided in the same number as the base units and each counter unit is arranged to counter only one of such base units in the local countering mechanism. Alternatively, at least one of such counter units may counter only one of such base units based upon the local countering mechanism, while at least one another of the counter units may counter at least two of the base units in the global countering mechanism. In another example, a less number of counter units are provided such that each counter unit is arranged to counter at least two of the base units based on the global countering mechanism, that at least one of the counter units counters one of the base units based on the local countering mechanism while at least one another of the counter units counters at least two of the base units in the global countering mechanism, and the like. In another example, a greater number of counter units are provided such that each base unit may be countered by at least two of the counter units, that at least one of the counter units counters one of the base units in the local countering mechanism and at least one another of the counter units may counter at least two of such base units in the global countering mechanism, and so on. In all of these examples, any of the above front, rear or lateral countering mechanisms may be used by the counter units, where such countering mechanisms may be same or different for each counter unit.

In another aspect of the present invention, various counter units may also be implemented into the base units of various devices and convert such devices to the EMC systems in which the harmful device EM waves irradiated by their base units may be countered (i.e., canceled and/or suppressed) by the counter waves emitted by their counter units.

In one exemplary embodiment of this aspect of the present invention, the counter units may be implemented into any base units shaped as electrically conductive wires, strips, sheets, tubes, coils, spirals, and/or meshes or, in the alternative, to any electrically semiconductive and/or insulative wires, strips, sheets, tubes, coils, spirals, and/or meshes for minimizing the irradiation of the harmful waves by countering such harmful waves by the counter waves, e.g., by canceling at least a portion of the harmful waves in the target space and/or suppressing the harmful waves from propagating to such a target space. Such counter units may be made of and/or include at least one material which may then be electrically conductive, insulative or semiconductive. The counter units may be implemented to any of the base units which have the shapes formed by one or multiple wires, strips, sheets, tubes, coils, spirals, and/or meshes, by modifying the shapes of one or multiple wires, strips, sheets, tubes, coils, spirals, and/or meshes, where a few examples of the modified shapes may be a solenoid and a toroid each formed by modifying the shape of the coil. In general, the counter units of this embodiment may be disposed in any of the foregoing arrangements and may counter the harmful waves by any of the foregoing mechanisms. Accordingly, a similarly or identically shaped and/or sized counter unit may be disposed lateral or side by side to one or more base units, may be axially, radially or angularly aligned with one or more base units, may enclose therein one or more base units, may be enclosed by one or more base units, may wind around one or more base units, may be wound by one or more base units, and the like, based on the source matching. In the alternative, a similarly or differently shaped and/or sized counter unit may be disposed along one or more wavefronts of the harmful waves irradiated by one or more base units for the wave matching. In addition, such counter units may be employed in a proper number and/or arrangement to counter the harmful waves according to the local countering or global countering.

In another exemplary embodiment of this aspect of the present invention, the counter units may also be implemented into any conventional electric and/or electronic elements such as, e.g., resistors, inductors, capacitors, diodes, transistors, amplifiers, and other signal processors and/or regulators in order to counter the harmful waves which are irradiated by the elements, where such electric and/or electronic elements function to manipulate at least one input signal supplied thereto and to produce at least one output signal at least partially different from the input signal. All of the above electric and/or electronic elements may qualify as the base units within the scope of the present invention when the unsteady current flows therein or when the unsteady voltage is applied thereacross. In addition, the above elements may also qualify as the base units within the scope of this invention when any of the elements produces the unsteady output signal (i.e., the electric current or voltage) in response to the input signal which may be steady or unsteady. Therefore, any of the above prior art elements and/or devices including such elements may be converted into the EMC elements by incorporating thereinto various counter units having any of the above configurations in any of the above dispositions and/or arrangements, thereby countering the harmful waves in any of the above mechanisms. It is noted that such counter units may be provided in any dimension so that such EMC elements may be provided in a range of microns or nanometers.

Configurational and/or operational variations of such EMC systems and their counter units as well as configurational and/or operational modifications of such EMC systems and their counter units as exemplified in FIGS. 2A to 2L and as disclosed in the above aspects of this invention also fall within the scope of the present invention.

The EMC systems of the present invention are specifically intended to counter various harmful waves in a carrier frequency range or an extremely low frequency range from about 50 Hz to about 60 Hz or another frequency range of less than about 300 Hz. Therefore, in the preferred embodiment of this invention, various counter units of the EMC systems are arranged to emit the counter waves in the carrier frequency range or extremely low frequency range of from about 50 Hz to about 60 Hz or another frequency range of less than about 30 Hz, thereby effectively countering the harmful waves in the comparable frequency ranges. Considering various medical findings and/or presumptions that a main culprit of the EM waves are those in these frequency ranges, these counter units are believed to effectively eliminate those harmful frequency components from the harmful waves irradiated from the base units of various electric and electronic devices.

Although not preferred, various counter units of the EMC systems of the present invention may also be arranged to emit the counter waves in an ultra low frequency range of less than about 3 kHz, the counter waves in a very low frequency range of less than about 30 kHz, and the counter waves in a low frequency range of less than about 300 kHz for countering those harmful waves in the same or similar frequency ranges. The counter units may also be arranged emit the counter waves in other frequency ranges such as, e.g., the radio waves of frequencies which range from about 5×10² Hz to about 10⁸ Hz, microwaves of frequencies which range from about 10⁸ Hz to about 10¹² Hz, and so on, in order to counter the harmful waves of similar frequency ranges. When desirable, the counter units may also be arranged to emit the counter waves defining higher frequencies such as, e.g., ultraviolet rays of frequencies ranging from about 7.5×10¹⁴ Hz to about 10¹⁷ Hz, X-rays of frequencies ranging from about 7×10¹⁶ Hz to about 10¹⁹ Hz, gamma rays in a frequency range beyond 5×10¹⁸ Hz, and the like, for countering the harmful waves of similar frequency ranges.

Such counter units may further be arranged to selectively counter specific components of the harmful waves or, alternatively, to specifically preserve specific components of such harmful waves while countering (i.e., canceling and/or suppressing) the rest of the harmful waves. For example and particularly when the harmful waves include higher frequency components, the counter units may be specifically arranged to preserve beneficial waves such as, e.g., infrared rays including far infrared rays in a frequency range from about 300 gHz to about 10 tHz, medium infrared rays in a frequency range from about 10 tHz to about 100 tHz, near infrared rays in a frequency range from about 100 tHz to about 700 tHz, and the like, while countering the rest of the harmful waves including those of the carrier frequency range and extremely low frequency ranges. Conversely, the counter units may be arranged to emit the infrared rays including such far-, medium-, and/or near-infrared rays as well.

As described above, a typical EMC system includes at least one wave source and at least one counter unit, where the wave source in turn includes or encloses at least one base unit therein and where the counter unit may include at least one optional electric connector such as a lead wire and at least one optional coupler for coupling the counter unit to other parts of the system. The EMC system may also include at least one optional case member which encloses at least a portion of the base unit, at least a portion of the counter unit, and the like. Alternatively, an entire portion of the counter and/or base units may be exposed with or without such a case member.

More specifically, the counter unit consists of various parts such as at least one body, at least one optional support, and at least one insert. The body of the counter unit qualitatively corresponds to the base unit of the wave source in that such a body is the sole component of the counter unit which emits the counter waves when the electric current flows therein, when the electric voltage is applied thereacross, and the like. Therefore, such a body may preferably be made of and/or include at least one electric conductor when the electric current is to flow therein, may be made of and/or include any electrically conductive, semiconductive or insulative material when the electric voltage is to be applied thereacross, and the like. The support serves to mechanically support the above body and/or retain such a body therein for mechanical protection and/or electrical isolation. The insert is typically used to augment amplitudes of the counter waves, particularly when the counter unit includes at least one coil of conductive wire into which such an insert is disposed. The insert may be made of and/or include various magnetic materials such as, e.g., ferromagnetic materials, paramagnetic materials, diamagnetic materials, and ferrimagnetic materials, where the ferromagnetic materials are the preferred ones. It is appreciated that the counter unit is generally arranged to maintain its configuration while emitting such counter waves, where this fixed configuration may be embodied by forming the body of the counter unit of rigid materials, by fixedly coupling the body of the counter unit to the support, and so on. In the alternative, the counter unit may be arranged to change its shape while emitting such counter waves, where this variable configuration may be embodied by forming the body of the counter unit of elastic or deformable materials, by movably coupling the body of the counter unit to the support, and the like. It is appreciated that the counter unit emitting such counter waves is to be opposed by the base unit irradiating the harmful waves of an opposite magnetic polarity. Accordingly, such a counter unit tends to move while emitting the counter waves and a special provision may have to be implemented when it is desirable to fix the counter unit during its operation.

The counter may be provided in various configurations which typically refer to shapes, sizes, arrangements, and the like. In general, the configuration of the counter unit depends upon the above countering modes (such as the source matching and wave matching) and/or countering mechanisms (such as the front, rear or lateral arrangement, local or global matching, and the like) which generally depend on the configurational characteristics of the base units, wave characteristics of the harmful waves, and the like. In addition, the configuration of the counter unit also depends upon the shapes, sizes, orientation, and/or dispositions of the target spaces which are to be formed on one side of the counter unit.

The shape of the counter unit may be arranged to be identical to or similar to the shape of the base unit, where such a counter unit is to be constructed to emit the counter waves which match the harmful waves automatically. The shape of the counter unit may instead be arranged to be different from the shape of the base unit, where such a counter unit may be provided in other shapes, may be wound around the base unit, may enclose at least a portion of the base unit therein, may be enclosed by at least a portion of the base unit, and the like. Such a counter unit may define a shape of a wire, a strip, a sheet, a tube, a coil, a spiral, and/or a mesh, may define a combination of two or more of such shapes without defining any holes or openings therethrough, may define an array of two of more of such shapes while defining multiple holes and/or openings therethrough, and the like, where examples of the combinations and/or arrays may include, but not be limited to, a bundle including multiple identical or different shapes bundling each other, a braid of multiple identical or different shapes braided along each other, and the like. The counter unit may also be made of a mixture which includes at least two materials and which are also provided in any of the above shapes, combinations, and/or arrays. It is appreciated that the coil (including a solenoid or a toroid), the spiral, the mesh, and the arrays thereof may be particularly useful in the wave matching as will be described below. It is also appreciated that all of multiple counter units may define the same shape or that at least two but not all of such counter units may define the same shape. Alternatively, all of such counter units may define different shapes.

The counter unit may be shaped to conform to the base unit so that the counter waves by the counter unit better match the harmful waves, where such a counter unit may be conformed to such a base unit while approximating the base unit or providing further details to the base unit. Alternatively, the counter unit may be shaped to not conform to the base unit while manipulating the counter waves to match the harmful waves. This arrangement may be embodied when a single counter unit counters multiple base units or when multiple counter units counter a single base unit. It is appreciated in such an arrangement that the counter unit(s) may be provided with proper electrical energy (e.g., current or voltage) for emitting the counter waves capable of matching and countering the harmful waves in the target space. It is also appreciated that all of multiple counter units may conform to the base unit(s) or that at least two but not all of the counter units may conform to the base unit(s). In the alternative, all of the counter units may not conform to the base unit(s).

When one or multiple counter units are shaped similar or identical to one or multiple base units, the counter units are preferably arranged to approximate the base units. When the base unit forms a three-dimensional (or 3-D) shape, the counter unit may be constructed as a three-dimensional analog with a similar shape or simpler shape, a two-dimensional (or 2-D) analog or an one-dimensional (or 1-D) analog. When the base unit defines a 2-D shape, the counter unit may be fabricated as a 2-D of a similar or simpler shape or 1-D analog. When the base unit forms an 1-D shape, the counter unit may be provided as another 1-D analog defining a similar or simpler shape. When a single counter unit has to counter multiple base units, the counter unit may approximate only a major base unit as one of such analogs, may approximate at least two of such base units into one of the analogs, and the like. When multiple counter units counter a single base unit, each counter unit may approximate only a portion of the base unit. When multiple counter units are to counter multiple counter units, the counter units may approximate the base units into the analogs of the same dimension or into various analogs provided in different dimensions. It is appreciated that those analogs conform to the base units and, accordingly, that the analogs may define rather straight or curved shapes depending upon the shapes of the base units. It is also appreciated that the analogs preferably maintain similarity with the base units, where such similarity may be maintained in terms of lengths of such counter and base units, widths thereof, heights thereof, thicknesses thereof, diameters or radii thereof, radii of curvature thereof, numbers of revolutions or turns thereof, ratios of such lengths, ratios of such widths, ratios of such thicknesses or heights, ratios of such diameters or radii, ratios of such numbers, and the like. When a single base unit is countered by a single counter units, such configurational parameters are defined in each of the base and counter units. When a single counter unit counters multiple base units, such configurational parameters are defined in the counter unit, in an array of all of such base units, in an array of at least two but not all of such base units, and the like. When multiple counter units counter a single base unit, such configurational parameters are defined in the base unit, in an array of all of such counter units, in an array of at least two but not all of such counter units, and the like. When multiple counter units counter the same or different number of base units, such configurational parameters are also defined individually or in arrays as described above.

When the single or multiple counter units are shaped similar or identical to the single or multiple base units, the counter units are instead arranged to provide details to the base units, not in a sense of adding structures not existing in the base units but in a context of streamlining the wavefronts of the counter waves for the better purpose of matching the wavefronts of such counter waves with those of the harmful waves. For example, one or multiple small counter units may be disposed around (or inside) one or more major counter units for manipulating outer (or inner) edges of the wavefronts of a sum of the counter waves emitted by the major counter units. In another example, one or multiple small counter units may also be disposed closer to (or away from) one or more major counter units to manipulate the radii of curvature of the wavefronts of a sum of the counter waves which are emitted by the major counter units. Such small or minor counter units may be incorporated in various relations with respect to one or more major counter units for other purposes as well, as far as incorporation of such minor counter units may improve matching between the counter and harmful waves in the target space. Accordingly, when the system includes multiple counter units, all of the counter units may be arranged to approximate the base unit(s), all of such counter units may be arranged to provide details to the base unit(s), or some but not all of the counter units may approximate the base unit(s).

The counter unit may be arranged to define various cross-sections along a longitudinal or long axis thereof, its short axis which may be perpendicular or otherwise transverse to the long axis, and the like. In one example, the counter unit is arranged to define an uniform cross-section along at least one of such axes so that the counter waves emitted thereby also define the wavefronts defining the same shapes along such axes. In another example, the counter unit may be constructed to change its cross-section along at least one of such axes so that the counter waves emitted thereby also define the wavefronts varying their shapes along at least one of such axes. When the system has multiple counter units, all of such units may define the same shape or at least two of such counter units may define different shapes.

The counter unit may be arranged to have various sizes, where such a counter unit may emit the counter waves of proper amplitudes capable of effectively countering the harmful waves thereby. For example, the counter unit incorporated in the front arrangement may define a smaller size than the base unit due to its closer disposition toward the target space, whereas the counter unit incorporated in the rear arrangement may define a larger size than the base unit due to a greater distance toward the target space. However, the size of the counter unit may be determined by other factors such as, e.g., the shape of the counter unit, amplitudes of electric energy (i.e., electric current and/or voltage) supplied thereto, and the like. Therefore, the counter unit in the front arrangement may define a larger size than the base unit while emitting a less amount of the counter waves per an unit area, whereas the counter unit in the rear arrangement may define a smaller size than the base unit while emitting a greater amount of the counter waves per an unit area, and so on. That is, the size of the counter unit may be deemed as a secondary parameter which may be determined by other factors such as, e.g., the shape of the counter unit, amplitudes of the electric energy supplied thereto, distances to the base unit and/or target space, arrangement of the counter unit(s), orientation thereof, and the like.

The counter unit may be arranged to have various sizes along its longitudinal axis and/or short axis. In one example, the counter unit is arranged to define an uniform size along at least one of such axes so that the counter waves emitted thereby also define the wavefronts defining the same shapes along such axes, assuming that the same amount of the electric energy is supplied thereto. In another example, the counter unit may be constructed to change its size along at least one of the axes so that the counter waves emitted thereby also define the wavefronts varying their shapes along such axes. In addition, the counter unit may maintain the same size along at least one of such axes while varying its shapes therealong. When the system includes multiple counter units, such counter units may have the same size or at least two of such units may define different sizes.

Multiple counter units may also be incorporated in various arrangements, where such counter units are arranged to emit the counter waves capable of automatically matching such harmful waves due to the arrangement. In one example, such counter units may be incorporated into an arrangement which conform to the shape of a single base unit or conform to another arrangement of multiple base units such that the counter waves match the harmful waves in the target space. In another example, the counter units may be incorporated in an arrangement which does not conform to the shape of the single base unit or does not conform to the arrangement of multiple base units. This arrangement may be embodied when multiple counter units counter a single base unit or when multiple counter units are to counter a different number of multiple base units. It is appreciated in such an arrangement that the counter unit(s) may be provided with proper electrical energy (e.g., current or voltage) for emitting the counter waves which are capable of matching and countering the harmful waves in the target space. The counter units may be disposed in an arrangement symmetric to the base unit and/or target space so that the counter waves emitted thereby also match the symmetric harmful waves. Conversely, the counter units may also be disposed in an arrangement which is asymmetric to the base unit or target space such that the asymmetric counter waves counter the asymmetric harmful waves in the target space. The single counter unit or multiple counter units may be incorporated in an arrangement which encloses therein at least a portion of one or multiple base units. Conversely, the single counter unit or multiple counter units may be incorporated in another arrangement in which at least a portion of such a counter unit(s) may be enclosed by one or multiple base units. It is appreciated that the arrangement generally connotes a pattern of multiple counter units but that such an arrangement may also mean an orientation and/or alignment of a single counter unit.

The counter may also be provided in various dispositions which generally refer to orientations, alignments, distances, mobilities, and the like. In general, such disposition of the counter unit depends on such countering modes (such as the source matching or wave matching), countering mechanisms (such as the front, rear or lateral arrangement, local or global countering, and the like), configurations of the counter unit, and the like, each of which generally depend on the configurational characteristics of the base units, wave characteristics of the harmful waves, and so on. In addition, the dispositions of the counter unit also depend upon the shapes, sizes, orientation, and/or dispositions of the target spaces defined on one side of the counter unit. It is appreciated as rules of thumb that such counter unit(s) may be typically disposed closer to the base unit(s) in the local countering mechanism and that the counter unit(s) may be disposed away from the base unit(s) in the global countering mechanism.

The counter unit may be disposed in various orientations such that the counter waves emitted thereby may be properly oriented with and counter such harmful waves. In one example, the counter unit may be disposed in an orientation defined with respect to a direction of propagation of the harmful waves, e.g., by orienting its long axis normal to the direction of such propagation. In another example, the counter unit may be disposed in another orientation which is defined with respect to a direction of the electric current or voltage, e.g., by orienting its long axis parallel to, normal to or in a preset angle with respect to the direction of the electric energy. In another example, the counter unit may instead be disposed in another orientation which is defined with respect to the longitudinal and/or short axes of the base unit. It is appreciated that such orientations of the counter unit typically depend on other configurations of the base unit, particularly when such a base unit is arranged to irradiate the harmful waves in a direction different from at least one of its axes, different from a winding direction of its coil or other parts, and the like. When the system includes multiple counter units, all of such counter units may be disposed in the same orientation, each counter unit may be disposed in a different orientation, at least two but not all of the counter units may be disposed in the same orientation, and the like.

The counter unit may be disposed in various alignments such that the counter waves emitted thereby may be properly aligned with and counter such harmful waves. In one example, the counter unit may be aligned with one or more of the above directions and/or axes, may be wound in the same direction as the base unit, and the like. In another example, the counter unit may be misaligned with at least one of the above directions and/or axes, may be wound in a direction different from that of the base unit, and the like. When the system includes multiple counter units, all of such counter units may be aligned in the same direction and/or axis, each counter unit may be aligned in a different direction or axis, at least two but not all of such counter units may be aligned in the same direction or axis, and the like. When the system includes multiple counter units, all of such counter units may be disposed in the same alignment, each counter unit may be disposed in a different alignment, at least two but not all of the counter units may be aligned in the same orientation, and the like.

The counter unit may further be disposed in a lateral alignment, an axial alignment, a concentric alignment, and the like. In the lateral alignment, one or multiple counter units may be disposed side by side with respect to the base unit or between the base units along the long and/or short axes of such base unit(s). In the axial alignment, one or multiple counter units are disposed along a direction of one or more of such axes at a preset distance(s) from such base unit(s). In the concentric alignment, one or multiple counter units may be disposed inside the single base unit, may be surrounded with multiple base units, may enclose the single or multiple base units, and the like.

The counter unit may be disposed in various distances from the base unit and/or target space. In one example, such a counter unit may be fixedly coupled to the system at a preset distance from its base unit so as to emit the counter waves with the wavefronts matching those of the harmful waves. When desirable, the counter unit may receive variable electrical energy (i.e., current or voltage) such that the amplitudes of the counter waves may vary according thereto in order to counter the harmful waves of varying amplitudes, to define different target spaces, and the like. In another example, the counter unit may be movably coupled to the system and translate or rotate between two positions so as to emit the counter waves and dispose their wavefronts in different locations with respect to the harmful waves with or without varying the amplitudes of the counter waves. Therefore, the counter unit counters the harmful waves by the counter waves with the wavefronts of which characteristics vary according to the position of the counter unit with respect to the base unit and/or target space. In another example, the system may include therein multiple counter units and manipulate wave emitting operation of each of the counter units. By properly recruiting all or some of such counter units with or without manipulating the amplitudes of the counter waves emitted therefrom, the system may counter the harmful waves while defining the target space in various locations with respect to the base unit. When the system include multiple counter units, all of such units may be fixedly incorporated therein, all of such units may be movably incorporated therein, or at least two but not all of such units may be movable incorporated therein, and the like.

The disposition of the counter unit may be assessed in terms of the distances measured along the longitudinal axis of the base unit, along the short axis thereof, around at least one of the axes, and the like. The counter unit may be disposed closer to the target space than the base unit as in the front arrangement, farther away from the target space than the base unit as in the rear arrangement, flush with the target space as in the lateral arrangement, and the like. When the system includes multiple counter units, all of such units may be disposed in the same arrangement or at least two of such units may be disposed in different arrangements. In addition, all of the counter units may be disposed at an equal distance from the base unit or, alternatively, at least two of such counter units may be disposed at different distances therefrom. It is appreciated that the counter unit is preferably disposed on the same side of the base unit with respect to the target space. When the counter unit is disposed on an opposite side of the base unit with respect to the target space, however, the counter unit may still be able to counter the harmful waves, although such a disposition may not be the preferred embodiment.

The counter unit may be incorporated into various parts of the system and disposed in various exposures as well. When the system includes the case member, the counter unit may be disposed on or over an exterior surface of the case member, on or below an interior surface of the case member, embedded into the case member, and/or inside the case member. Such a counter unit may instead be disposed on or over an exterior surface of the wave source, on or below an interior surface of such a wave source, embedded between such surfaces of the wave source, inside the wave source, and the like. The counter unit may also be disposed on or over an exterior surface of the base unit, on or below an interior surface of the base unit, embedded between such surfaces of the base unit, inside the base unit, and the like. In addition, such a counter unit may be disposed and enclosed by at least a portion of the base unit. Similarly, at least a portion or an entire portion of the counter unit may also be exposed through the system, through the case member, through the wave source, through the base unit, and the like. Moreover, the counter unit may fixedly or movably couple with one or more existing parts of the system, wave source, and/or base unit or, in the alternative, may be coupled thereto by a coupler. Similarly, the counter unit may be spaced away from or may form an unitary article with such a system, wave source, and/or base unit.

The counter unit may be made of and./or include various materials in order to emit the counter waves having proper amplitudes in response to the electric energy supplied thereto and matching the harmful waves. In one example, the counter and base units may be made of and/or include the same materials so that such units may emit the same amount of the counter and harmful waves per an unit amount of such electric energy. In another example, the counter and base units may include at least one common material and at least one different material so that such units may emit the similar but not identical amount of the counter and harmful waves per the unit amount of the electric energy. In yet another example, the counter and base units may be made of and/or include different materials so that the counter and base units emit different amounts of waves per the unit amount of the electric energy. In general, various characteristics of the counter and base units determined by their compositions may be electric resistance or conductivity, magnetic permittivity, resonance frequency, and the like. Thus, the counter unit may be arranged to define the same, similar or different conductivity, permittivity, and resonance frequency based on its composition. An entire portion of the counter unit may be arranged to have an identical composition or, alternatively, various portions of the counter unit may be arranged to have different compositions which may vary along the long or short axis thereof. When the system includes multiple counter units, all of such counter units may have the same composition, at least two but not all of the counter units may have the same composition, or all of such counter units may have different compositions, thereby also maintaining or varying the above properties therealong.

As described hereinabove, precisely matching the phase angles (either opposite or similar) of the counter and harmful waves is a prerequisite for countering the harmful waves irradiated from the base unit by the counter waves emitted by the counter unit. This phase matching may be attained by supplying proper electric energy (i.e., electric current or voltage) to such base and counter units and optionally electrically coupling such counter and base units with each other. For illustration purposes, the electric energy supplied to the base unit is to be referred to as a “source energy” hereinafter, and the electric current and voltage of the “source energy” are to be referred to as “source current” and “source voltage” hereinafter, respectively. In one example, identical source current or voltage may be supplied to the base and counter units either sequentially or simultaneously so that such phase angles of the harmful and counter waves are properly synchronized. In another example, the counter unit is supplied with only a portion of the source current or voltage sequentially or simultaneously, where the phase angles of such harmful and counter waves are still synchronized as well. In another example, the base unit is first supplied with the source current or voltage, while the system thereafter modifies the amplitudes or directions of the source current or voltage and then supplies the modified current or voltage to the counter unit. As long as the phase angles of such source energy is maintained during modification, the counter and harmful waves are properly phase synchronized. In another example, the base unit is supplied with the source energy, and the system provides an analog of such source energy and supplies the analog energy to the counter unit with or without modifying the amplitudes and/or directions thereof, where such a system may employ various electronic components, circuits, and/or controllers to provide such an analog. As long as the phase angles of the electric energy is maintained in the analog energy, the counter and harmful waves are phase synchronized as well. In another example, the counter unit is electrically coupled to the base unit in a series mode, in a parallel mode or in a hybrid mode, where the counter unit is supplied with the source energy, modified source energy or analog energy as described above and where the counter unit may be supplied with such energy sequentially or simultaneously with the base unit. When the system includes multiple counter units, all of such counter units may be supplied with the same energy, at least two but not all of such units may be supplied with the same energy, each unit may be supplied with different energy, and the like. When the system includes multiple base units which are supplied with different source energies, the single counter unit may be supplied with only one of such energies, with a combination of at least two of such energies, and the like. When the system includes multiple counter units, such units may couple with the base unit by the same or different modes, may be supplied with the same or different energies sequentially or simultaneously, and the like. It is appreciated in all of the above examples that the phase matching also depends upon other configurations and/or dispositions of the counter unit so that a direction of winding of the counter unit, orientation of the counter unit, and/or alignment thereof may have to be considered to accomplish the proper phase matching.

Further details of such source and wave matching will be provided hereinafter. As described hereinabove, it has been understood in such a source matching that there does not exist any one-to-one correlations between the configuration of such a counter unit and the configuration of the counter waves emitted thereby. That is, the counter waves of certain configuration (or wave characteristics) may be obtained by a single counter unit which defines a certain shape and size and is provided in a certain arrangement, by another counter unit which defines a similar shape and size but is provided in another arrangement, by another counter unit which has a different shape and size but is provided in a similar arrangement, by at least two counter units defining preset shapes and sizes and provided in a preset arrangement, by the same number of counter units defining different shapes and/or sizes or in a different arrangement, by a different number of counter units defining similar shapes and/or sizes or in a similar arrangement. It has also been appreciated in such a wave matching that there does not exist an one-to-one correlation between the disposition of the counter unit and the wavefronts of the counter waves emitted by the counter unit. In other words, the wavefronts with certain shapes may be obtained by a single counter unit which defines a certain configuration and is disposed in a certain position with respect to the base unit and/or target space, by another single counter unit which forms another configuration and which is disposed in another position, by at least two counter units which have preset configurations and are disposed in preset positions, by the same number of counter units defining different configurations and disposed in different positions, by a different number of counter units which define different configurations and which are disposed in different positions, and the like. However, there are a few heuristic rules which may apply not only to the source matching but also to the wave matching. The first rule is that the counter unit disposed in the front arrangement preferably defines a characteristic dimension greater than that of the base unit when other things equal so as to increase the radii of curvature of the wavefronts of the counter waves and to attain better matching between the counter and harmful waves. The second rule is the reverse of the first rule and dictates that the counter unit disposed in the rear arrangement preferably has a characteristic dimension less than that of the base unit in order to decrease the radii of curvature of the wavefronts of the counter waves and to attain better matching between the counter and harmful waves. In order to match the amplitudes of the counter and harmful waves, however, the longer or wider counter unit in the front arrangement is arranged to emit the counter waves with the amplitudes less than those of the harmful waves. Similarly, the shorter or narrower counter unit in the rear arrangement is arranged to emit the counter waves defining the amplitudes greater than those of the harmful waves. The third rule is that disposing multiple counter units emitting the counter waves of the same or similar phase angles tends to flatten the wavefronts of a sum of the counter waves and to increase the radii of curvature of the wavefronts of the counter waves. The fourth rule is the reverse of the the third rule and dictates that disposing a less number of counter units tend to sharpen such wavefronts of the sum of the counter waves and to decrease the radii of curvature of the wavefronts of the counter waves. The fifth rule is that the wavefronts of the sum of the counter waves may be sharpened and the radii of curvature of such wavefronts may be decreased when at least one but not all of multiple counter units may be arranged to emit the counter waves with the phase angles opposite to those of other counter units. It is appreciated that these rules do not generally apply to the counter units emitting the counter waves with the wavefronts defining the shapes different from the shape of the counter unit, and that those rules do not generally apply to the counter units of the non-uniform emitting power either which will be described in greater detail below.

A main purpose of the source matching is to manipulate the configuration of the counter unit to match that of the base unit such that the counter waves emitted from the counter unit better match the harmful waves irradiated from the base unit. When a system preferentially depends upon the source matching to counter the harmful waves, its counter unit may preferably be disposed within a preset or reasonable distance from the base unit, for any advantages which may be obtainable by the similarly configured counter unit may be lost otherwise. It is to be understood that the source matching is most useful when the base unit has a simple or symmetric configuration or when it is reasonable feasible to construct a replica of a complex base unit. When the system includes a single wave source including multiple base units or includes multiple waves sources each including at least one base unit, the single counter unit may be arranged to attain the source matching with multiple base units or multiple counter units may be arranged to perform the source matching with multiple base units. The source matching may include a shape matching, a size matching, an arrangement matching, a disposition matching, an intensity matching, and other configurational matching.

Some details of the shape matching have been disclosed heretofore. For example, the counter unit may be formed as a 3-D (or bulk) analog which is a replica or an approximation of one or multiple 3-D base units, may be provided as a 2-D (or planar) analog which is an approximation of a single or multiple 3-D or 2-D base units or which is a replica of a single or multiple 2-D base units, may also be formed as an 1-D (or linear) analog which is an approximation of one or multiple 3-D, 2-D or 1-D base units or which is a replica of a single or multiple 1-D base units, and the like. Similarly, multiple counter units may be constructed as 3-D analogs which are the replica or approximation of one or multiple 3-D base units, may be formed as the 2-D analogs which are the approximation of one or multiple 3-D or 2-D base units or which are the replica of a single or multiple 2-D base units, may be provided as the 1-D analogs which are the approximation of a single or multiple 3-D, 2-D or 1-D base units or which are the replica of one or multiple 1-D base units, and the like. Such analogs may have continuous shapes or shapes with multiple holes or openings, may form solid shapes or deformable shapes, may define symmetric or asymmetric shapes, and the like. The shapes of the analogs may also be determined by the foregoing countering mechanisms or, conversely, such shapes may dictate the selection of other configurations of the analogs, proper countering mechanisms adopted thereby, and the like.

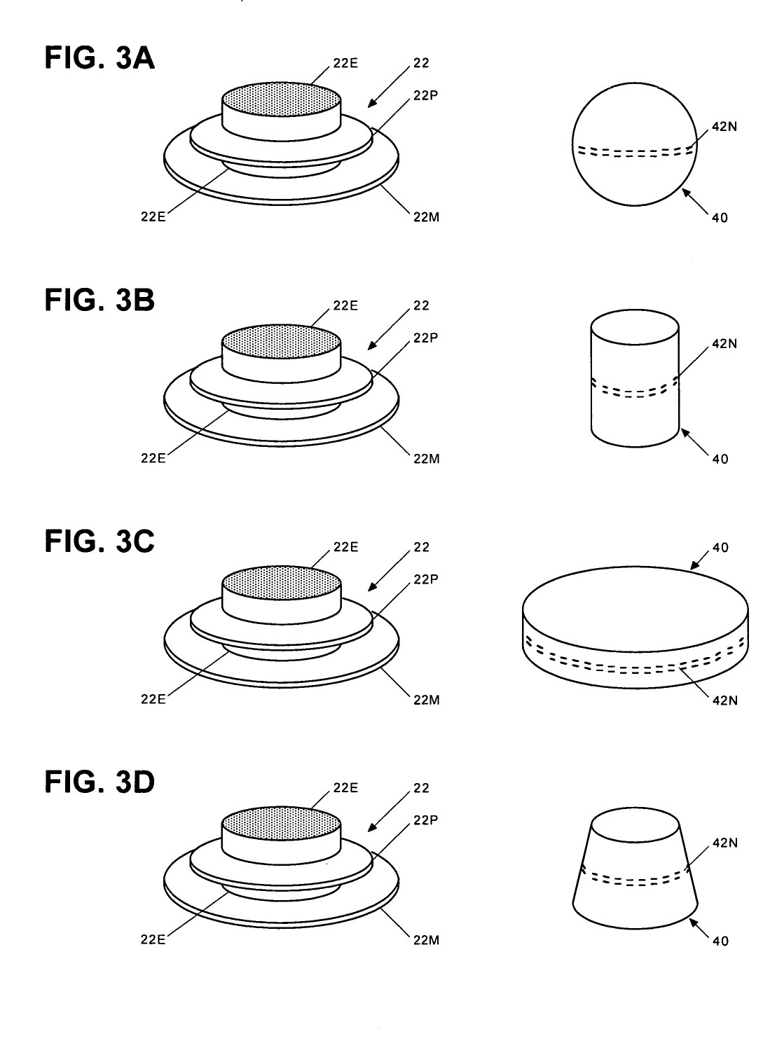

It is appreciated that the piezoelectric speaker includes various primary base units such as the piezo plate, electrodes, and metal plate. When the counter unit is arranged to approximate only one of such base units, such a counter unit may be shaped as a curvilinear plate which approximates one of the base units and counters the harmful waves irradiated by only one of the base units. Two or more of such analogs may also be disposed in various locations around the base units or, alternatively, may be mechanically and/or electrically coupled to each other, supplied with the electric energy in a preset pattern, and disposed in a preset location for countering the harmful waves irradiated by two or more of such base units. Such counter units may also be formed as an unitary article which approximates two or more of such primary base units. For example, FIGS. 3A to 3D describe schematic perspective views of exemplary counter units each of which approximate multiple base units and is also provided in various configurations based on the source matching according to the present invention. It is to be understood in each of the figures that the counter unit is arranged to approximate an assembly of the piezo plate, electrodes, and metal plate of the speaker. It is also appreciated in such figures that the piezoelectric speakers are provided on the left panels of the figures and that various counter units for approximating such speakers are provided on the right panels thereof.

In one example of FIG. 3A, a counter unit 40 is provided according to a point analog so that the piezoelectric speaker 22 is approximated as a point wave source and that various base units of such a speaker 22 are represented as different layers of the point analog 40. For example, the counter unit 40 includes a middle layer 42N dividing such a point analog 40 into an upper hemisphere and a lower hemisphere, where the middle layer 42N corresponds to the piezo plate 22P of the speaker 22, where the upper hemisphere represents the upper electrode 22E, while the lower hemisphere corresponds to an aggregate of the lower electrode 22E and metal plate 22M. The middle layer 42N may be made of and/or include at least one piezoelectric material which is similarly included in the piezo plate 22P. In the alternative, the middle layer 42N may be made of and/or include at least one semiconductive or insulative but not piezoelectric material which defines an electric resistance similar to that of the piezo plate 22P so that the middle layer 42N emits the counter waves similar to the harmful waves. In either example, the middle layer 42N is preferably arranged to not vibrate in response to the electric energy and, accordingly, may be fixedly coupled to the upper and lower hemispheres. The upper and lower hemispheres may be made of and/or include at least one conductive article which is also included in the electrodes 22E and/or metal plate 22M. In the alternative, such hemispheres may instead be made of and/or include at least one electric conductor which is not included in such electrodes 22E and/or metal plate 22M but defines similar electric conductivities. Accordingly, the counter unit 40 formed as the point analog of the assembly of the electrodes 22E, piezo plate 22P, and metal plate 22M emits the counter waves defining similar wavefronts as the harmful waves. By arranging the counter waves to have the phase angles opposite to those of the harmful waves, the counter unit 40 counters such harmful waves from the assembly of various base units of the piezoelectric speaker 22.

The point analog-type counter unit 40 may be fabricated in various configurations. First of all, the middle layer 42N may define any thicknesses as long as the counter unit 40 may emit the counter waves at least partially similar to the harmful waves. The thickness of the middle layer 42N may also be determined by its piezoelectric or insulative properties such that the middle layer 42N is thicker or thinner than the piezo plate 22P, that the middle layer 42N defines a ratio of its thickness to its diameter which is similar to such a ratio of the piezo speaker 22, and the like. The middle layer 42N may define an uniform thickness or may define a thickness varying therealong. Such a middle layer 42N may be provided exactly in the middle of the analog 42N so that the upper and lower hemispheres define the same shapes and sizes, may be defined asymmetrically such that the upper and lower hemispheres are different from each other, and the like. In addition, the analog 40 may define the shape other than a sphere while forming an elongated object.

It is appreciated that wave characteristics of such harmful waves also depend upon locations of the contacts 22T on the electrode 22E and metal plate 22M. For example, when the contact 22T is provided on an edge of the electrode 22E (or metal plate 22M), the electric energy is applied across an entire portion of the electrode 22E (or metal plate 22M) in an uniform direction, and the harmful waves are irradiated from the entire portion of the electrode 22E (or metal plate 22M) while defining the same phase angles. In contrary, as the contact 22T is provided on an internal location of the electrode 22E (or metal plate 22M), the electric energy is then applied across a major portion of the electrode 22E (or metal plate 22M) in one direction and across a minor portion of the electrode 22E (or metal plate 22M) in an opposite direction. Accordingly, the harmful waves are mainly irradiated from the major portion of the electrode 22E (or metal plate 22M), while at least a portion of such harmful waves are canceled or suppressed by other harmful waves irradiated from the minor portion of the electrode 22E (or metal plate 22M). In this context, such a speaker 22 defines effective base units which are smaller than the assembly of the electrodes 22E, piezo plate 22P, and metal plate 22M. In addition, when the contacts 22T are provided on one edge of the electrode 22E and on an opposite edge of the metal plate 22M, at least a portion of the harmful waves which are irradiated by the electrode 22E tends to be canceled or suppressed by at least a portion of the harmful waves irradiated from the metal plate 22M, thereby reducing an effective size of the assembly of the base units. Therefore, the locations of the contacts 22T have to be accounted for when constructing the analog of the base units in the source matching. Conversely, the electric energy may be supplied to such analogs through various contacts provided in various portions thereof, thereby manipulating shapes of the wavefronts of such counter waves and better matching the harmful waves therewith.

The point analog-type counter unit 40 may find its best use in various situations. For example, such an analog 40 may be useful when the piezo speaker 22 is provided as a very small article such that its characteristic dimension (e.g., its length, width or height) is relatively miniscule compared with that of the counter unit 40. Similarly, this analog 40 may be useful when the characteristic dimension of the piezo speaker 22 is relatively small with respect to a distance to the target space therefrom. In addition, the point analog 40 may be useful when the piezo speaker 22 defines an aspect ratio (i.e., a ratio of its length or width to its height) close to 1.0 or, in other words, when the speaker 22 defines a length, width or diameter similar to its height, regardless of its actual size, the ratio of its dimension to the distance to the target space, and the like.

In another example of FIG. 3B, a counter unit 40 is provided based on a wire analog so that the piezoelectric speaker 22 may be approximated into an elongated wave source and that various base units of the speaker 22 may be represented by various layers along the wire analog 40. For example, the counter unit 40 includes a middle layer 42N dividing the wire analog 40 into an upper segment and a lower segment, where the middle layer 42N corresponds to the piezo plate 22P of the speaker 22, where the upper segment represents the upper electrode 22E, while the lower segment corresponds to an aggregate of the lower electrode 22E and metal plate 22M. The middle layer 42N and segments may be provided similar to the middle layer and hemispheres of FIG. 3A, respectively. Therefore, such a counter unit 40 formed as the wire analog of the assembly of such electrodes 22E, piezo plate 22P, and metal plate 22M emits the counter waves which define similar wavefronts as the harmful waves. By arranging the counter waves to define the phase angles opposite to those of such harmful waves, the counter unit 40 counters the harmful waves irradiated from the assembly of various base units of the piezoelectric speaker 22.

The wire analog-type counter unit 40 may also be formed in various configurations. First of all, the middle layer 42N may define any thicknesses as long as the counter unit 40 may emit the counter waves at least partially similar to the harmful waves. The thickness of the middle layer 42N may also be determined by its piezoelectric or insulative properties such that the middle layer 42N is thicker or thinner than the piezo plate 22P, that the middle layer 42N defines a ratio of its thickness to its diameter which is similar to such a ratio of the piezo speaker 22, and the like. The middle layer 42N may define an uniform thickness or may define a thickness varying therealong. Such a middle layer 42N may be provided exactly in the middle of the analog 42N so that the upper and lower segments have the same shapes and sizes, may be defined asymmetrically such that the upper and lower segment differ from each other, and the like. In addition, the wire analog 40 may define different diameters along its length. Moreover, detailed configurations of the wire analog 40 may also be determined by the number of and locations of the electric contacts 22T similar to those of the contacts of FIG. 3A. Other configurational and/or operational characteristics of the counter unit 40 of FIG. 3B may be similar or identical to those of the counter unit of FIG. 3A.

The wire analog-type counter unit 40 may find its best use in various situations. For example, such an analog 40 may be useful when various base units of the piezo speaker 22 define identical or at least substantially similar dimensions so that the point analog may amount to an oversimplification. Similarly, this analog 40 may be useful when the characteristic dimensions along a height of the piezo speaker 22 in the same or similar order of magnitude as the distance to the target space therefrom. In addition, the wire analog 40 may be useful when the piezo speaker 22 defines an aspect ratio (i.e., a ratio of its length or width to its height) less than 1.0 or, in other words, when the speaker 22 defines a length, a width, and/or a diameter shorter than its height, regardless of its actual size, the ratio of its dimension to the distance to the target space, and the like.

In another example of FIG. 3C, a counter unit 40 is provided according to a plate analog so that the piezoelectric speaker 22 is approximated as a flat wave source and that various base units of the speaker 22 are represented as different layers of the plate analog 40. For example, the counter unit 40 includes a middle layer 42N dividing the plate analog 40 to an upper layer and a lower layer, where the middle layer 42N represents the piezo plate 22P of the speaker 22, where the upper layer refers to the upper electrode 22E, while the lower layer corresponds to an aggregate of the lower electrode 22E and metal plate 22M. The middle layer 42N, upper layer, and lower layer may be provided similar to those of FIGS. 3A and 3B. Therefore, the counter unit 40 which is formed as the plate analog of the assembly of the electrodes 22E, piezo plate 22P, and metal plate 22M emits the counter waves which define similar wavefronts as the harmful waves. By arranging the counter waves to have the phase angles opposite to those of the harmful waves, the counter unit 40 counters the harmful waves from the assembly of various base units of the piezoelectric speaker 22.

The plate analog-type counter unit 40 may be fabricated in various configurations. First of all, the middle layer 42N may define any thicknesses as long as the counter unit 40 may emit the counter waves at least partially similar to the harmful waves. The thickness of the middle layer 42N may also be determined by its piezoelectric or insulative properties such that the middle layer 42N is thicker or thinner than the piezo plate 22P, that the middle layer 42N defines a ratio of its thickness to its diameter which is similar to such a ratio of the piezo speaker 22, and the like. The middle layer 42N may define an uniform thickness or may define a thickness varying therealong. Such a middle layer 42N may be provided exactly in the middle of the analog 42N so that the upper and lower hemispheres define the same shapes and sizes, may be defined asymmetrically such that the upper and lower hemispheres are different from each other, and the like. The plate analog 40 may also define a shape other than a circular plate, e.g., an oval plate, a rectangular plate, a square plate, a polygonal plate, and the like. It is appreciated that detailed configurations of the plate analog-type counter unit 40 may be determined by the number of and/or locations of the electric contacts 22T as well. Further configurational and/or operational characteristics of the counter unit 40 of FIG. 3C may be similar or identical to those of the counter units of FIGS. 3A and 3B.

The plate analog-type counter unit 40 may find its best use in various situations. For example, such an analog 40 may be useful when various base units of the piezo speaker 22 define identical or at least substantially similar dimensions so that the point analog may amount to an oversimplification. Similarly, this analog 40 may be useful when the characteristic dimensions along a width or a diameter of the piezo speaker 22 may be in the same or similar order of magnitude as the distance to the target space therefrom. In addition, the plate analog 40 may be useful as the piezo speaker 22 defines an aspect ratio (i.e., a ratio of its length or width to its height) greater than 1.0 or, in other words, when the speaker 22 has a length, a width, and/or a diameter longer than its height, regardless of its actual size, the ratio of its dimension to the distance to the target space, and the like.

In another example of FIG. 3D, a counter unit 40 is provided based on a hybrid analog so that the piezoelectric speaker 22 is approximated as a hybrid wave source and that various base units of the speaker 22 are represented as different layers of the hybrid analog 40. For example, the counter unit 40 includes a middle layer 42N dividing such a point analog 40 into an upper section and a lower section. The middle layer 42N corresponds to the piezo plate 22P of the speaker 22, the upper section represents the upper electrode 22E, and the lower section corresponds to an aggregate of the lower electrode 22E and metal plate 22M. The middle layer 42N and sections may be provided similar to the middle layer and hemispheres of FIG. 3A, and the hybrid analog of this example may correspond to a modification of either of the above analogs of FIGS. 3A to 3C. Accordingly, the counter unit 40 which is formed as the hybrid analog of the assembly of the electrodes 22E, piezo plate 22P, and metal plate 22M emits the counter waves defining similar wavefronts as the harmful waves. By arranging such counter waves to have the phase angles opposite to those of the harmful waves, the counter unit 40 counters the harmful waves from the assembly of various base units of the piezoelectric speaker 22.

The hybrid analog-type counter unit 40 may be provided in various configurations. First of all, the middle layer 42N may define any thicknesses as long as the counter unit 40 may emit the counter waves at least partially similar to the harmful waves. The thickness of the middle layer 42N may also be determined by its piezoelectric or insulative properties such that the middle layer 42N is thicker or thinner than the piezo plate 22P, that the middle layer 42N defines a ratio of its thickness to its diameter which is similar to such a ratio of the piezo speaker 22, and the like. The middle layer 42N may define an uniform thickness or may define a thickness varying therealong. Such a middle layer 42N may be provided exactly in the middle of the analog 42N so that the upper and lower hemispheres define the same shapes and sizes, may be defined asymmetrically such that the upper and lower hemispheres are different from each other, and the like. In addition, detailed configurations of the hybrid analog 40 may be determined by the number of and/or locations of the electric contacts 22T as well. The hybrid analog of this example may also find its best use when any of the above analog may turn out to be an oversimplification of the base units of such a speaker 22. Further configurational and/or operational characteristics of the counter unit 40 of FIG. 3D are similar or identical to those of the counter units of FIGS. 3A to 3C.

In all of the examples of FIGS. 3A to 3D, the middle layers 42N of such analogs 40 may include the piezoelectric material and vibrate as the electric energy is supplied thereto. It is preferred in such an arrangement that the counter units 40 may be arranged to produce the sound waves which do not counter the sound waves generated by the piezo speaker 22 while emitting the counter waves which counter the harmful waves irradiated by various base units of the piezo speaker 22. To this end, the analogs 40 may be disposed in a preset relation to the piezo speaker 22 such that the sound waves from the analogs 40 and piezo speaker 22 may be in the same phase and augment each other, while the analogs 40 may be disposed in a preset alignment and/or orientation and/or may be supplied with the electric energy in a preset direction such that the counter and harmful waves define the opposite phase angles.

As described in FIGS. 1D and 1E, such a piezo speaker 22 may be driven by the external drive mechanism or self-drive mechanism, and the counter unit may be adjusted accordingly. For example, such a counter unit may approximate the electrode with a single portion with a single polarity as is the case in the external drive mechanism or, in the alternative, may approximate another electrode having multiple portions as is the case in the self-drive mechanism. It is appreciated that the counter unit may be supplied with the electric energy through two electric contacts as is the case in the external drive mechanism or through three or more electric contacts as is the case in the self-drive mechanism.

The size matching may be embodied by defining the counter unit to be larger than, similar to or smaller than the base unit whether or not maintaining the similarity between the configurations of such counter and base units. Whether or not the counter unit may emit the counter waves which have the wavefronts of the similar shapes as the counter unit itself, the size of the counter unit determines an extent of dispersion or flattening of the counter waves, edge characteristics of the wavefronts, and the like. As described hereinabove, the size of the counter unit is also dictated by various countering mechanisms adopted thereby, disposition thereof, amplitudes of the electrical energy supplied thereto, and the like. Conversely, the size of the counter unit may dictate the selection of other configurations thereof, proper countering mechanisms, and the like.

The disposition matching may be embodied by manipulating the orientation of the counter unit, alignment thereof, distance to the base unit and/or target space therefrom, its mobility, and the like. As described herein, the counter unit may be oriented in the preset relations with respect to various axes and/or various directions, may be disposed in the front, rear or lateral arrangement, may be aligned or misaligned with such directions and/or axes, may be aligned or misaligned with the base unit axially, radially, angularly, concentrically, laterally, and the like. The disposition of the counter unit may also be dictated by various countering mechanisms adopted thereby, shapes and sizes thereof, amplitudes of the electrical energy supplied thereto, and the like. Conversely, the disposition of the counter unit may dictate the selection of other configurations thereof, proper countering mechanisms, and the like.

The intensity matching may be embodied by manipulating the amplitudes of the counter waves emitted by the counter unit. For example, the counter waves may define the amplitudes greater than, similar to or less than those of the harmful waves when measured at a certain distance from the base unit, when measured across the target space or at a preset position in the target space, and the like. The amplitudes of the counter waves are further dictated by various countering mechanisms adopted thereby, shapes and sizes thereof, disposition thereof, amplitudes of such electrical energy supplied thereto, and the like. Conversely, the amplitudes of the counter waves may determine the selection of other configurations thereof, proper countering mechanisms, and the like.

A main purpose of the wave matching is to dispose the counter unit along at least one of such wavefronts of the harmful waves and to emit the counter waves defining the wavefronts capable of matching and countering those of the harmful waves. When a system preferentially depends on the wave matching to counter the harmful waves, its counter unit may be disposed anywhere around the base unit in any distance as long as the counter wavefronts may match the harmful wavefronts. It is appreciated that the wave matching is most powerful when the base unit defines a rather complex or asymmetric configuration or when it is impossible to construct a replica or approximation of a complex base unit. When such a system includes a single wave source having multiple base units or includes multiple waves sources each including at least one base unit, the single counter unit may be arranged to attain the wave matching with multiple base units or multiple counter units may instead be arranged to perform the wave matching with multiple base units. The only one disadvantage or complication as to the wave matching is that detailed shapes and distribution of the wavefronts of the harmful waves have to be assessed a priori.

In one type of the wave matching, the counter waves are emitted by at least one counter unit defining an uniform emitting capacity in which amplitudes per an unit configuration of the counter unit such as, e.g., its length, its width, its radius or diameter, its area, and/or its weight is maintained to be uniform thereacross. Therefore, such a counter unit emits the counter waves having the wavefronts which are similarly shaped as the counter unit itself and, when disposed along the wavefront of the harmful waves, counters the counter waves while defining the target space. In another type of the wave matching, such counter waves are emitted by another counter unit with a non-uniform emitting capacity in which amplitudes per the unit configuration of the counter unit vary thereacross. In such an arrangement, the counter unit emits the counter waves of the wavefronts which are not similar to the shape of the counter unit. Therefore, the counter unit of this non-uniform capacity are disposed not along a single wavefront of the harmful waves but across at least two of such wavefronts so as to emit the counter waves capable of matching the harmful waves and defining the target space.

It is appreciated that the counter units with the uniform emitting capacity may also be disposed along at least two wavefronts of the harmful waves as exemplified in FIG. 2K. When multiple counter units are disposed in different wavefronts of the harmful waves, such units may also be arranged to emit the counter waves of different amplitudes in order to compensate discrepancies in the distances to the base unit therefrom. Such compensation may be attained by various means, e.g., by adjusting the shapes and sizes of the counter units, by manipulating the amount of the electric energy supplied thereto, by controlling the orientations and/or alignments of such counter units, and the like. As far as a sum of the counter waves defines the wavefronts which match those of the harmful waves in the target space, such counter units may be disposed along adjacent or space-apart wavefronts of the harmful waves in various configurations and/or dispositions.

Similar to their counterparts in the case of the source matching, the counter unit for the wave matching may similarly define a shape of a wire, a strip, a sheet, a tube, a coil, a spiral, and/or a mesh, may also define a combination of two or more of such shapes without defining any holes or openings therethrough, may define an array of two of more of such shapes while defining multiple holes and/or openings therethrough, and so on, where examples of such combinations and/or arrays may include, but not be limited to, a bundle of multiple identical or different shapes bundling each other, a braid of multiple identical or different shapes braided along each other, and the like. Such a counter unit may then be disposed along the single or multiple wavefronts of the harmful waves.

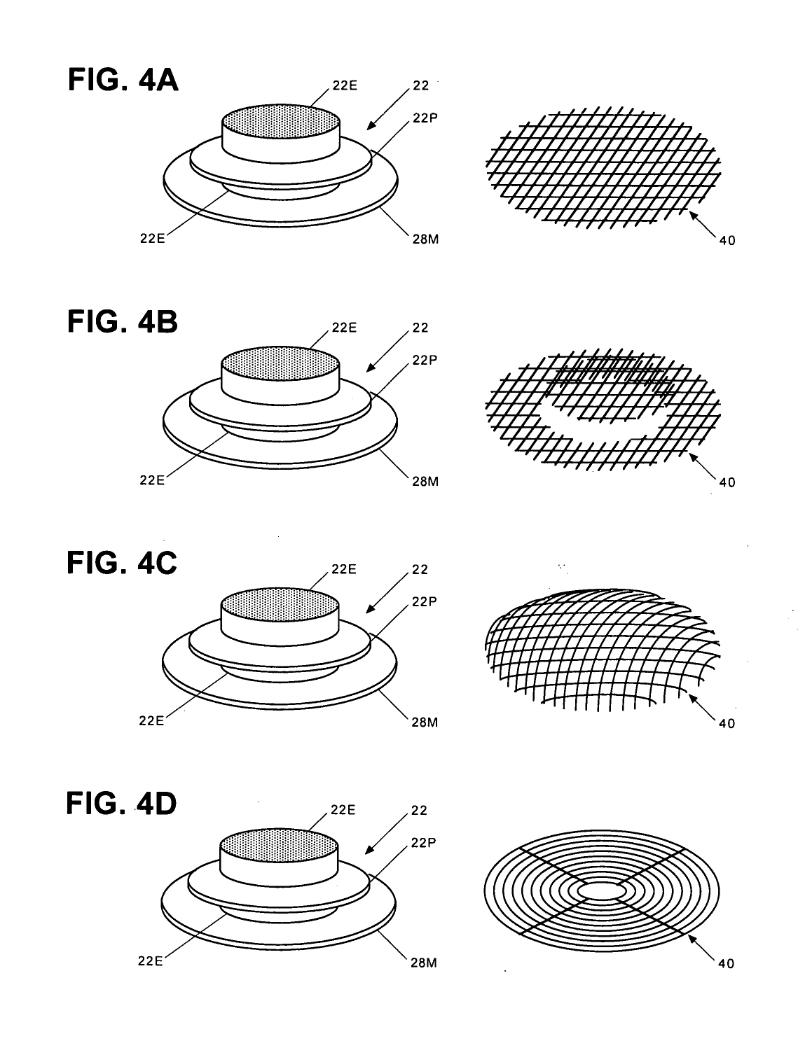

When the counter unit is arranged to emit the counter waves capable of matching the harmful waves which are irradiated by such primary base units of the piezo speaker such as, e.g., the piezo plate, electrodes, and metal plate, such a counter unit may define the configuration matching at least a portion of at least one wavefront of the harmful waves, may be disposed along at least a portion of at least one wavefront of the harmful waves, and the like. Multiple counter units may also be disposed in an arrangement matching at least a portion of only one wavefront of the harmful waves or at least portions of two or more wavefronts of the harmful waves, and the like. Multiple counter units may be disposed along a single or multiple wavefronts of the harmful waves while being separated from each other, while being mechanically and/or electrically coupled to each other, while being supplied with the electric energy in a preset pattern (e.g., separately, in a series mode, in a parallel mode, and the like), and the like. Such counter units may also be provided as an unitary article which approximates two or more of the primary base units. In the alternative, such a counter unit may define the configuration which is inverse to at least a portion of one or more wavefronts of such harmful waves in its location of disposition but matches at least a portion of one or multiple wavefronts thereof in the target space, may be disposed inversely to at least a portion of at least one wavefront of the harmful waves in its location of disposition but matches at least a portion of at least one wavefront of such harmful waves in the target space, and the like. Multiple counter units may also be disposed in an arrangement which is inverse to at least a portion of a single or multiple wavefronts of the harmful waves in its location of disposition but matches at least a portion of a single or multiple wavefronts of such harmful waves in the target space. FIGS. 4A to 4D represent schematic perspective views of exemplary counter units each of which is arranged to match at least a portion of a single or multiple wavefronts of the harmful waves with at least a portion of at least one wavefront of the counter waves on the wave matching according to the present invention. It is to appreciated in such figures that the piezoelectric speakers are provided on the left panels of the figures and that various counter units for approximating such speakers are provided on the right panels thereof.

In one example of FIG. 4A, a counter unit 40 is provided as an array of wires or strips or as a mesh thereof each of which forms multiple openings therethrough and each of which is substantially flat. Accordingly, such a counter unit 40 emits the counter waves propagating away therefrom while defining wavefronts which are at least substantially flat thereover and then bending downward along its edge. When disposed on or over the piezo speaker 22, the counter waves emitted by the counter unit 40 match at least a portion of the harmful waves. Due to its unitary configuration, however, this counter unit 40 is preferably arranged to match a single wavefront of the harmful waves, although it is possible to dispose the counter unit 40 across multiple wavefronts thereof. In another example of FIG. 4B, the counter unit 40 is similar to that of FIG. 4A but rather consists of two portions, where an inner portion is shaped as a small circle of such an array or mesh, while an outer portion is shaped as a concentric ring of the array or mesh and aligned with the inner portion. Accordingly, the inner and outer portions of the counter unit 40 also emit the counter waves propagating away therefrom while defining wavefronts which match at least a portion of the harmful waves. Different portions of this counter unit 40, however, may also be disposed to match different wavefronts of the harmful waves as well. For example, the inner portion may be disposed closer to (or farther away from) the target space while emitting the counter waves with less (or greater) amplitudes than those of the harmful waves. In this embodiment, different portions of the counter unit 40 may define the configurations for completely matching each other or overlapping at least a portion of each other. Such inner and outer portions may be disposed in a preset arrangement so that the counter waves may not be completely flat and better match the counter waves as well. In another example of FIG. 4C, the counter unit 40 is similar to that of FIG. 4A, except that wires or strips of the array or mesh of the counter unit 40 may be curved along preset radii of curvature so that the counter unit 40 as a whole defines a contour to be concave upward. When disposed on or over the speaker 22, the curved counter unit 40 emits the counter waves propagating away therefrom while defining similarly curved wavefronts which better match one or more of the wavefronts of the harmful waves irradiated from various base units of the speaker 22. When desirable, the counter unit 40 may also be disposed across multiple wavefronts of such harmful waves. In another example of FIG. 4D, a counter unit 40 is provided as a flat coil, a flat spiral or an array of loops each of which defines multiple openings therethrough and each of which is substantially flat. Multiple straight wires are also arranged to extend radially and electrically contact the coil, spiral or array. Accordingly, the counter unit 40 emits such counter waves which propagate away therefrom while forming wavefronts which are at least substantially flat thereover and bending downward along its edge. When disposed on or over the piezo speaker 22, the counter waves from the counter unit 40 match at least a portion of the harmful waves. Due to its unitary configuration, this counter unit 40 is preferably arranged to match a single wavefront of the harmful waves, although it is also possible to dispose the counter unit 40 across multiple wavefronts thereof.

Various counter units 40 fabricated according to the wave matching of FIGS. 4A to 4D may be modified in various configurations as well. For example, wires or strips of the array or mesh may be distributed in an uniform density or in densities which vary along its length, width, diameter, and so on. Accordingly, a density of the openings of the counter unit 40 may be maintained uniform thereacross or may vary along its length, width or diameter. The counter unit 40 may be formed by identical wires or strips thereacross or, in the alternative, at least a portion of the counter unit may be made of such wires or strips which are different from those in other portions of the unit. When the counter unit 40 includes multiple portions, such portions may define the same configuration or different configurations, may be disposed in various arrangements described hereinabove, and the like. More particularly, the portions may be disposed along the same wavefront of the harmful waves or may be disposed along or across different wavefronts of the harmful waves. In general, detailed shapes of the wavefronts of the counter waves are determined by the number of such portions and arrangement therebetween and, therefore, such counter waves may better match the harmful waves by manipulating the number or arrangement. Detailed shapes of the wavefronts may also depend on detailed modes of supplying the electric energy to the counter unit and/or to different portions thereof. Similar to the description for the effects of the electric contacts on the wavefronts of the harmful waves, the wavefronts of such counter waves may be determined by the locations of the electric contacts, directions of the electric energy, amplitudes of the electric energy, and the like. The counter unit 40 may further be disposed in the front arrangement or rear arrangement depending on their configurations. When the counter unit 40 is disposed in the front arrangement, such a unit 40 is typically arranged to be convex toward the speaker 22 and to match at least one wavefront of such harmful waves. When the counter unit 40 is disposed in the rear arrangement, however, the counter unit 40 is generally arranged to be concave toward the speaker 22, to be typically inverse to the wavefront of the harmful waves in the location of disposition, and to match at least one wavefront of such waves in the target space. Similar to the counter units of the source matching, the counter units of the wave matching may also be disposed on or above the cover, under or below the cover or embedded inside the cover.

The wave-matched counter units 40 may find its best use in various situations. For example, such counter units 40 may be useful when the piezo speaker 22 defines a complicated configuration and when it is not straightforward to form any of the above analogs of the source matching. Similarly, the wave-matched counter units 40 may be useful when the piezo speaker 22 has a relatively simple configuration but when the electric energy is supplied thereto in a complicated pattern and the harmful waves, therefore, define complicated wave characteristics. In such cases, the counter units 40 may be formed to emit the counter waves matching at least a portion of the harmful waves and countering such harmful waves in the target space.

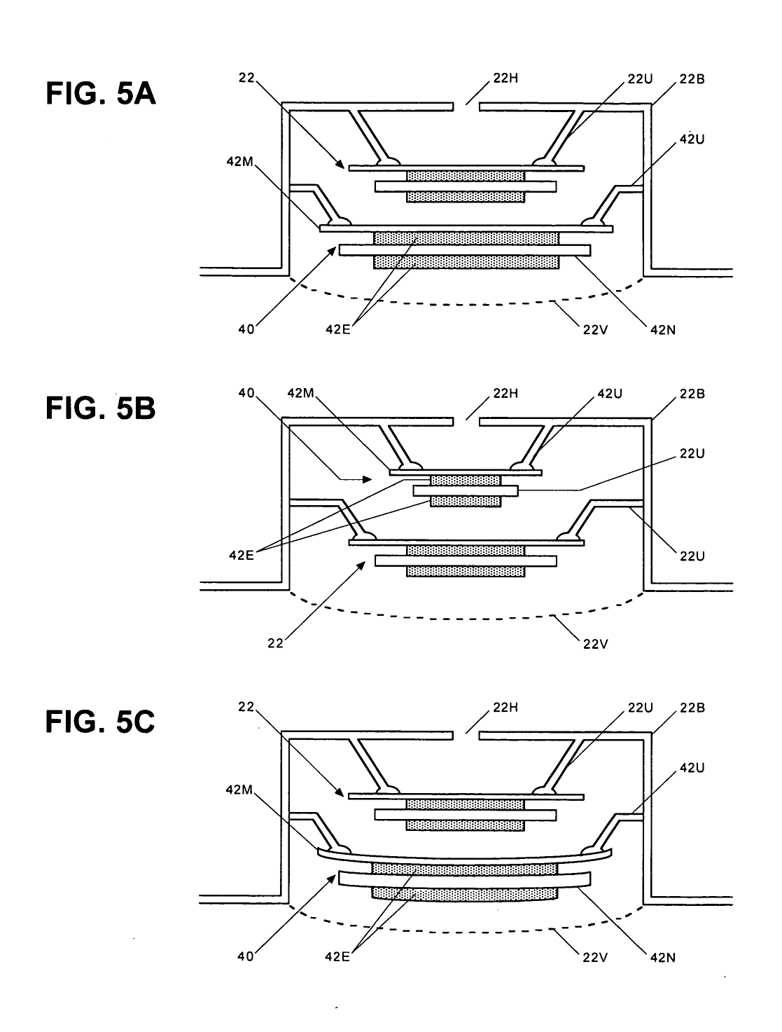

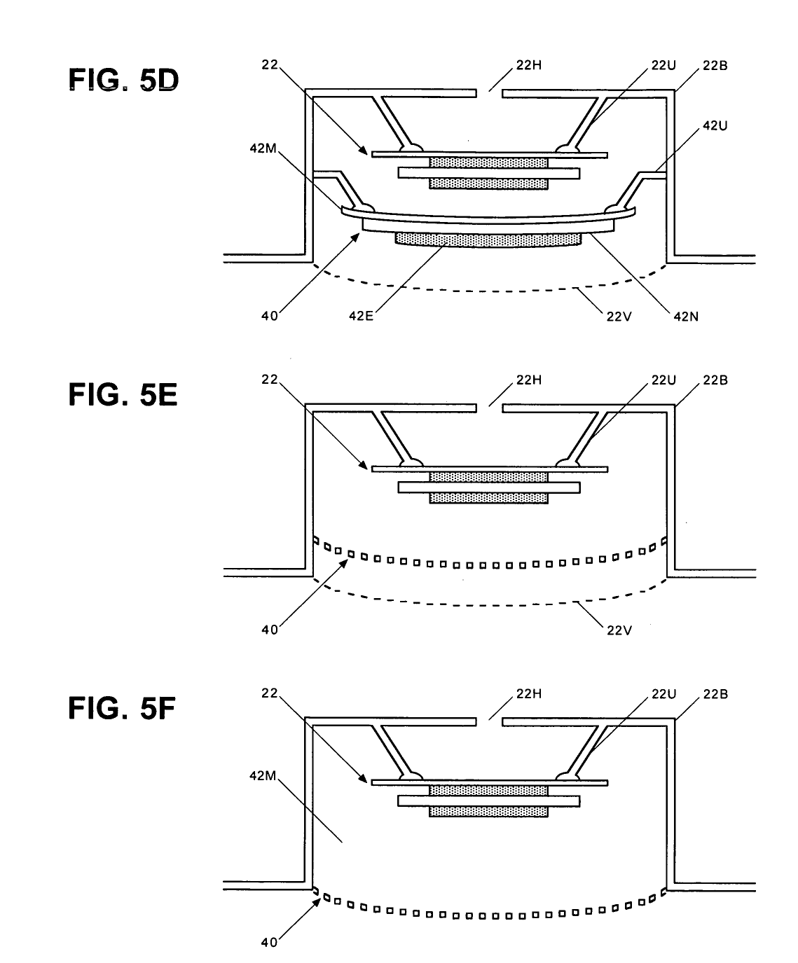

The counter units of the present invention may be incorporated into the EMC speaker systems in various arrangements, orientations, and dispositions with respect to various base units of the piezo speakers. As described above, the piezo speaker is generally disposed inside the cavity of the body of the system. Accordingly, it is generally preferred to disposed the counter unit inside such a cavity as well. When desirable, however, such a counter unit may also be exposed through the body in the front and/or rear arrangements. FIGS. 5A to 5F represent schematic perspective views of exemplary counter units incorporated into a piezoelectric speaker based on source or wave matching according to the present invention.

In one example of FIG. 5A, a counter unit 40 may be formed as a 3-D analog of an assembly of multiple base units of a piezoelectric speaker 22 such as, e.g., a piezo plate 22P, a pair of electrodes 22E, and a metal plate 22M. The speaker 22 is disposed inside a cavity formed inside a body 5 of the system and affixed therein by multiple couplers 22U. The counter unit 40 is similarly disposed inside the cavity and affixed therein by multiple couplers 42U as well. The counter unit 40 is disposed in the front arrangement and also interposed between the piezo speaker 22 and a cover 22V of the body 22B. Because the counter unit 40 is disposed in the front arrangement, the counter unit 40 is provided to be bigger or wider than the assembly such that the wavefronts of the counter waves define radii of curvature similar to those of the wavefronts of such harmful waves irradiated by the assembly of the base units disposed farther away from the target space which is defined under the body 22B. It is understood that the counter unit 40 in the front arrangement may hinder sound waves generated by the speaker 22 from propagating out of the body 22B through the cover 22V. To this end, the counter unit 40 may include multiple portions between which the sound waves may travel to the target space, may also define openings through which the sound waves travel to the target space, and the like. As described above, such a counter unit 40 may instead be arranged to serve as another piezo speaker which, however, emits the counter waves capable of countering the harmful waves irradiated by the piezo speaker 22. In another example of FIG. 5B, a piezo speaker 22 is identical to that shown in FIG. 5A, while a counter unit 40 may also be formed as a 3-D analog of the assembly of multiple base units of the speaker 22 and similarly disposed inside the cavity and affixed therein by multiple couplers 42U as well. The counter unit 40 is disposed in the rear arrangement and interposed between the speaker 22 and a rear of the body 22B. Because the counter unit 40 is disposed in the rear arrangement, the counter unit 40 is provided to be smaller or narrower than the assembly so that the wavefronts of the counter waves generally define radii of curvature similar to those of the wavefronts of such harmful waves irradiated by the assembly of the base units disposed closer to the target space to be defined under the body 22B. It is appreciated that the counter unit 40 in this rear arrangement may not hinder sound waves generated by the speaker 22 from propagating out of the body 22B through the cover 22V. As described hereinabove, such a counter unit 40 may instead be arranged to serve as another piezo speaker which, however, emits such counter waves capable of countering the harmful waves irradiated from the piezo speaker 22. Other configurational and/or operational characteristics of the counter unit 40 of FIG. 5B may be similar or identical to those of the counter unit of FIG. 5A. In another example of FIG. 5C, a piezo speaker is identical to those of FIGS. 5A and 5B, while a counter unit 40 is similar to that shown in FIG. 5A. However, each layer of the counter unit 40 is arranged to be convex toward the speaker 22 such that the counter unit 40 as a whole is also convex to such a speaker 22. Accordingly, the counter unit 40 emits the counter waves of which wavefronts better match those of the harmful waves. Other configurational and/or operational characteristics of the counter unit 40 of FIG. 5C are similar or identical to those of the counter units of FIGS. 5A and 5B. In another example of FIG. 5D, a piezo speaker 22 is identical to those of FIGS. 5A to 5C, while a counter unit 40 is similar to that of FIG. 5C. However, this counter unit 40 is the approximation or simplification of the assembly of the base units of such a speaker 22 in that the former includes a less number of layers than the latter. Other configurational and/or operational characteristics of the counter unit 40 of FIG. 5D are similar or identical to those of the counter units of FIGS. 5A to 5C.

In another example of FIG. 5E, a piezo speaker 22 is also identical to those of FIGS. 5A to 5D. A counter unit 40, however, is formed as an array of wires or strips or as a mesh thereof as shown in FIGS. 4A to 4D and operates in the wave matching. The counter unit 40 is similarly disposed inside the cavity and affixed therein by extending onto and abutting opposing sides of the body 22B. Such a counter unit 40 is disposed in the front arrangement and also interposed between the speaker 22 and cover 22V of the body 22B. Because such a counter unit 40 is disposed in the front arrangement, the counter unit 40 is formed to be wider than the assembly so that the wavefronts of the counter waves define radii of curvature similar to those of the wavefronts of such harmful waves irradiated from the assembly of the base units disposed farther away from the target space which is defined under the body 22B. It is appreciated that the counter unit 40 define multiple openings therethrough and may not hinder the sound waves generated by the piezo speaker 22 from propagating out of such a body 22B. Other configurational and/or operational characteristics of the counter unit 40 of FIG. 5E are similar or identical to those of the counter units of FIGS. 5A through 5D. In another example of FIG. 5F, a piezo speaker 22 is also identical to those of FIGS. 5A to 5E, while a counter unit 40 is similar to that of FIG. 5E. However, the counter unit 40 is further arranged to serve as the cover of the body 22B, thereby forming an exterior of the system while being exposed to the target space. When the counter unit 40 is to be supplied with the electric energy of relatively high amplitudes, the counter unit 40 is preferably insulated to prevent the user from such energy. When the electric energy supplied to the counter unit is of low amplitudes, however, the counter unit 40 may not have to be insulated. Other configurational and/or operational characteristics of the counter unit 40 of FIG. 5F may be similar or identical to those of the counter units of FIGS. 5A to 5E.

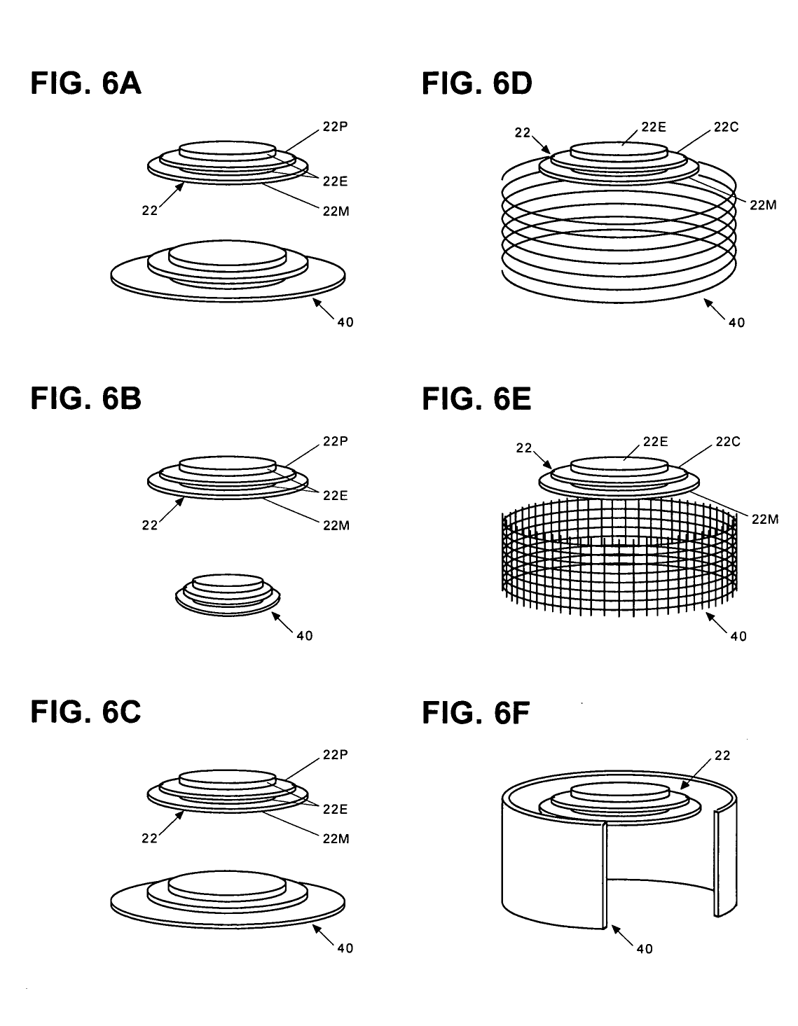

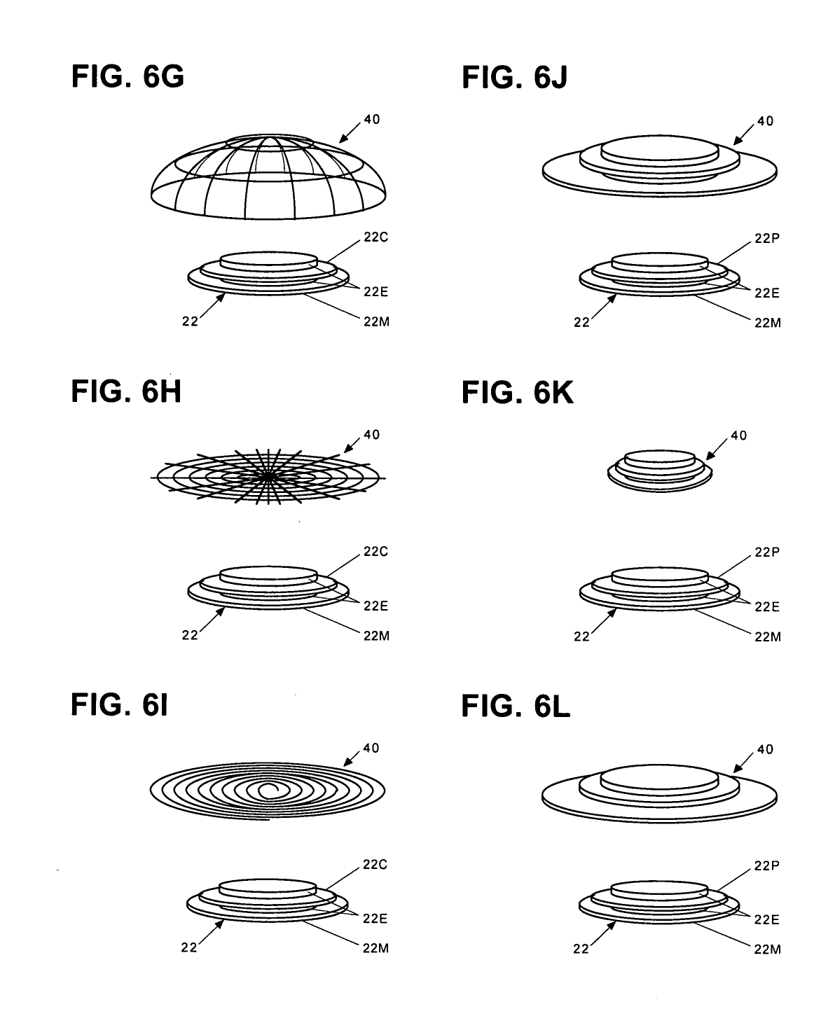

In addition to the foregoing, other counter units may further be provided to counter the harmful waves irradiated by various base units of the piezoelectric speaker through the source and/or wave matching. FIGS. 6A to 6L show schematic perspective views of exemplary counter units countering various base units of the piezoelectric speaker based upon the source or wave matching according to the present invention. It is appreciated in FIGS. 6A to 6L that the piezoelectric plate, metal plate, and electrodes are selected as the representative base units of the speaker. It is accordingly appreciated that other conductive, semiconductive, and/or insulative parts of the piezoelectric speaker which may emit the harmful waves are to be omitted from the figures and that, when necessary, such parts may be properly countered by resorting to any of the counter units as described hereinabove. It is further appreciated in FIGS. 6A to 6L that various speakers and their counter units are oriented to define the target spaces on top of each figures.

In one example of FIG. 6A, a piezoelectric speaker 22 is identical to those of FIGS. 5 to 5F and also includes various base units such as, e.g., a piezoelectric plate 22P, a pair of electrodes 22E, and a metal plate 22M. Therefore, such a speaker 22 generates audible sounds in response to the electric energy which is supplied thereto while irradiating the harmful waves by its base units 22P, 22E, 22M. A counter unit 40 is preferably disposed in a preset relation to the base units 22P, 22E of the speaker 22. In this example, the counter unit 40 is similar to that of FIG. 5A and provided as the 3-D analog of the base units 22P, 22E, 22M. In other words, the counter unit 40 similarly includes a middle layer of an insulative or piezoelectric material, two electrodes attached to opposing sides of the middle layer, and a metal plate electrically coupling with one of the electrodes. In this context, this counter unit 40 is to operate on the source matching (or the shape matching). The counter unit 40 may be arranged to not generate any sound waves as described above or, alternatively, may generate the sound waves which augment those generated by the speaker 22. In addition, the counter unit 40 is disposed below the speaker 22 in the rear arrangement so that the counter unit 40 preferably emits the counter waves of amplitudes greater than those of such harmful waves due to a greater distance to the target space than such base units 22P, 22E, 22M. The counter unit 40 is also aligned with a longitudinal axis of the speaker 22 so that centers of the wavefronts of the counter waves coincide with centers of those of the harmful waves. To ensure the counter waves to have the phase angles at least partially opposite to those of the harmful waves, the electric energy may be supplied to the counter unit 40 in a direction opposite to that of the energy supplied to the speaker 22. Therefore, the counter unit 40 may emit the counter waves which are aligned with the harmful waves and also define the phase angles opposite to those of the harmful waves, thereby matching and then countering the harmful waves in the target space. As mentioned above, the counter unit 40 may be viewed as the 3-D analog of the speaker 22 with a similar shape but a configuration which is larger or wider than that of the speaker 22. When desirable, the counter unit 40 may be disposed at a preset distance from the speaker 22 in which the wavefronts of the counter waves from the counter unit 40 may match those of the harmful waves by the base units 22E, 22P, 22M as have been mentioned in the wave matching. Thus, the speaker 22 is converted into the EMC speaker system of this invention by including such a counter unit 40 therein.

In another example of FIG. 6B, a piezo speaker 22 is identical to that of FIG. 6A, while another counter unit 40 is preferably disposed in a preset relation to such base units 22P, 22E of the speaker 22. The counter unit 40 is also similar to that of FIG. 6A so that it the counter unit 40 is the 3-D analog of the base units 22P, 22E, 22M, that the counter unit similarly includes such electrodes, middle layer, and metal plate, that the counter unit 40 operates on the source matching (or the shape matching), and that such a unit 40 is disposed below the speaker 22 in the rear arrangement. Such a counter unit 40 is also arranged to emit the counter waves of the phase angles at least partially opposite to those of the harmful waves and to counter the harmful waves in the target space. The counter unit 40 may be viewed as the 3-D analog of the speaker 22 with a similar shape but a configuration which is smaller or narrower than that of the speaker 22. When desirable, such a counter unit 40 may be disposed at a preset distance from the speaker 22 in which the wavefronts of the counter waves by the counter unit 40 may match those of the harmful waves by the base units 22E, 22P, 22M as mentioned in the wave matching. Thus, the speaker 22 is converted into the EMC speaker system of this invention by including the counter unit 40 therein. Other configurational and/or operational characteristics of such a counter unit 40 of FIG. 6B are similar or identical to those of the counter unit of FIG. 6A.

In another example of FIG. 6C, a piezo speaker 22 is identical to that of FIG. 6A, while another counter unit 40 is similarly disposed in a preset relation to the base units 22P, 22E, 22M of the speaker 22. Such a counter unit 40 is similar to that of FIG. 6A but defines a simplified 3-D analog of the base units 22P, 22E, 22M in that the counter unit 40 has the middle layer, an upper electrode, and a lower electrode which collectively represents the lower electrode 22E and metal plate 22M of the speaker 22. Other configurational and/or operational characteristics of the counter unit 40 of FIG. 6C may be similar or identical to those of the counter units of FIGS. 6A and 6B.

The counter units of FIGS. 6A to 6C may be modified into different configurations, may also be incorporated into other dispositions, and/or may counter the harmful waves in other mechanisms. For example, the counter unit may have a different radius and/or height while maintaining an aspect ratio of the speaker or varying such. In another example, the counter unit may define a shape of the similar aspect ratio but include the layer and electrodes of thicknesses which are different from those of the speaker. In another example, the counter unit may also be disposed in the front arrangement in which an upper article of the figure may be viewed as the counter unit and a lower article may be interpreted as the speaker. In another example, two or more similarly or differently shaped counter units may be disposed in various arrangements for the local or global countering. It is appreciated that the counter unit may have the shape similar to that of the piezoelectric speaker but may be made of and/or include different materials. For example, the counter unit may have a layer made of and/or including insulative or semiconductive materials which are not piezoelectric but define an electric resistivity similar to that of the piezo plate of the speaker. In another example, the electrodes and/or metal plate may be made of and/or include materials different from those of the speaker but cheaper. As far as the counter unit may emit the counter waves capable of countering the harmful waves in the target space, the counter unit may define various configurations and may be made of and/or include various materials.

It is also appreciated that the counter unit itself may also operate as an additional piezoelectric speaker which is supplied with the electric energy and generate the sound waves identical to those produced by the speaker. However, the counter unit speaker is arranged to emit the counter waves having the phase angles at least partially opposite to those of the harmful waves, thereby countering the harmful waves by the counter waves while generating the same sound waves as the speaker. Such a counter unit may be embodied in various arrangements. For example, the speaker and counter unit may be axially or angularly aligned with each other, while the electrical energy is supplied thereto along opposite directions. In another example, the electric energy may be supplied to both the speaker and counter unit in the same direction, but the counter unit is configured and/or oriented in the manner that the counter waves define the phase angles which are opposite to those of the harmful waves. As long as the middle layer of the counter unit vibrates along the same direction as that of the speaker and as far as the counter unit as a whole emits the counter waves which may match and counter the harmful waves, such a counter unit may define various configurations, may be disposed in various orientations or alignments, and/or may be supplied with the electric energy along various directions.

In another example of FIG. 6D, a piezo speaker 22 is identical to that of FIG. 6A, and a counter unit 40 is disposed in a preset relation to the base units 22P, 22E, 22M of the speaker 22 and provided as a coil of conductive wire. In this context, the counter unit 40 is to operate on the wave matching. The counter unit 40 is disposed below the speaker 22 in the rear arrangement and emits the counter waves of amplitudes greater than those of the harmful waves due to a greater distance to the target space than the base units 22P, 22E, 22M. Such a counter unit 40 is aligned with a longitudinal axis of the speaker 22 so that centers of the wavefronts of the counter waves also coincide with centers of those of the harmful waves. To ensure the counter waves to have the phase angles at least partially opposite to those of the harmful waves, the electric energy may be supplied to the counter unit 40 in a direction opposite to that of the electric energy flowing in the speaker 22. Therefore, the counter unit 40 may emit the counter waves aligned with the harmful waves and having the phase angles opposite to those of the harmful waves, thereby matching and then countering the harmful waves in the target space. When desirable, such a counter unit 40 is disposed at a preset distance from the speaker 22 in which the wavefronts of the counter waves by the counter unit 40 may match those of the harmful waves by the speaker 22 as have been mentioned in the wave matching. Therefore, the piezoelectric speaker 22 is converted into the EMC speaker system of this invention by including the counter unit 40 therein. Other configurational and/or operational characteristics of the counter unit 40 of FIG. 6D may be similar or identical to those of the counter units of FIGS. 6A to 6C.

The counter unit of FIG. 6D may be modified into other configurations, may be implemented into other dispositions, and/or may counter the harmful waves in other mechanisms. For example, such a counter unit may be disposed in a different distance from the base units or may enclose one or more of the base units therein. In another example, the counter unit may define a radius of curvature which may be smaller than that of the speaker. In another example, such a counter unit may have the radius which may be constant or may change along its longitudinal axis. In another example, multiple similar or different counter units may be disposed in various arrangements for the local or global countering.

In another example of FIG. 6E, a speaker 22 is similar to that of FIG. 6A, while a counter unit 40 is disposed in a preset relation to the base units 22P, 22E, 22M of the piezo speaker 22 and formed as a mesh of conductive wire. In such a context, the counter unit 40 is to operate on the wave matching. The counter unit 40 is disposed below the piezoelectric speaker 22 in the rear arrangement so that the counter unit 40 emits the counter waves of amplitudes greater than those of the harmful waves. The counter unit 40 is aligned with a longitudinal axis of the speaker 22 so that centers of the wavefronts of the counter waves coincide with those of the wavefronts of the harmful waves. To ensure such counter waves to have the phase angles at least partially opposite to those of the harmful waves, the source current or its analog may be supplied to the counter unit 40 in a direction opposite to that of the source current flowing in the speaker 22. Therefore, the counter unit 40 may emit the counter waves aligned with the harmful waves and having the phase angles opposite to those of the harmful waves, thereby matching and countering the harmful waves in the target space. When desirable, the counter unit 40 is disposed at a preset distance from the speaker 22 in which the wavefronts of such counter waves by the counter unit 40 may match those of the harmful waves by the speaker 22 as have been mentioned in the wave matching hereinabove. Accordingly, the piezoelectric speaker 22 is converted into the EMC speaker of this invention by the counter unit 40. Other configurational and/or operational characteristics of the counter unit 40 of FIG. 6E are similar or identical to those of the counter units of FIGS. 6A to 6D.

The counter unit of FIG. 6E may be modified into other configurations, may be implemented into other dispositions, and/or may counter the harmful waves in other mechanisms. For example, such a counter unit may be formed as a solid annular tube of other shapes without any openings, an annular porous tube of other shapes, and the like. In another example, the counter unit may define a different radius of curvature which may be smaller than those of the base units and may be disposed therein, which may be constant or may vary along its longitudinal axis, and the like. In another example, such a counter unit may be disposed to enclose therein at least a portion or entire portion of the base units while having a radius of curvature which is greater than, similar to or less than that of the base units. In another example, multiple similarly or differently shaped counter units may be disposed in various arrangements for such local or global countering.

In another example of FIG. 6F, a piezo speaker 22 is similar to that of FIG. 6A, while a counter unit 40 is disposed in a preset relation to the base units 22P, 22E, 22M of the speaker 22 and defined as an annular tube. In this context, such a counter unit 40 is to operate on the source matching. The counter unit 40 is disposed around the speaker 22 in the flush or concentric arrangement so that such a counter unit 40 emits the counter waves of amplitudes similar to those of the harmful waves due to a distance to the target space similar to that from the base units 22P, 22E, 22M. The counter unit 40 is aligned with a longitudinal axis of such a speaker 22 and emits the counter waves defining the phase angles at least partially opposite to those of the harmful waves, thereby matching and countering the harmful waves in the target space. When desirable, the counter unit 40 may be disposed at a preset distance from the speaker 22 in which the wavefronts of such counter waves by the counter unit 40 match those of the harmful waves by the speaker 22 as have been mentioned in the wave matching. Accordingly, the piezoelectric speaker 22 is converted into the EMC speaker of this invention by the counter unit 40. Other configurational and/or operational characteristics of the counter unit 40 of FIG. 6F are similar or identical to those of the counter units of FIGS. 6A to 6E.

The counter unit of FIG. 6F may be modified into other configurations, may be implemented into other dispositions, and/or may counter the harmful waves in other mechanisms. For example, such a counter unit may be formed as a porous annular tube of other shapes, an annular solid tube of other shapes, and the like. In another example, the counter unit may define a different radius of curvature which may be smaller than that of the base units and disposed therein, which may be constant or may vary along its longitudinal axis, and the like. In another example, such a counter unit may be disposed to enclose therein a different portion of the base units while having a radius of curvature greater than, similar to or less than that of the base units. In another example, multiple similarly or differently shaped counter units may be disposed in various arrangements for the local or global countering.

In another example of FIG. 6H, a piezo speaker 22 is similar to that of FIG. 6A, while a counter unit 40 is disposed in a preset relation to such base units 22P, 22E, 22M of the speaker 22 and formed as the 3-D analog or an approximation of the base units 22P, 22E, 22M thereof. More particularly, the counter unit 40 consists of multiple concentric rings of wire interconnected with multiple radial arcuate wires. In this context, the counter unit 40 is to operate based upon the source matching. In another context, however, the counter unit 40 may be deemed to define a configuration matching at least one wavefront of the harmful waves based upon the wave matching. Such a counter unit 40 is disposed above the speaker 22 in the front arrangement so that the counter unit 40 emits the counter waves of amplitudes which are less than those of the harmful waves due to a shorter distance to such a target space. The counter unit 40 is aligned with a longitudinal axis of the speaker 22 and emits the counter waves of aligned with the harmful waves and also defining the phase angles opposite to those of the harmful waves, thereby matching and then countering the harmful waves in the target space. When desirable, the counter unit 40 may also be disposed at a preset distance from the speaker 22 in which the wavefronts of such counter waves by the counter unit 40 may match those of the harmful waves by the speaker 22 as have been mentioned above in the wave matching. Therefore, the piezoelectric speaker 22 is converted into the EMC speaker of the present invention by the counter unit 40. Further configurational and/or operational characteristics of the counter unit 40 of FIG. 6G may also be similar or identical to those of the counter units of FIGS. 6A to 6F.

In another example of FIG. 6H, a piezo speaker 22 is similar to that of FIG. 6A, while a counter unit 40 is disposed in a preset relation to such base units 22P, 22E, 22M of the speaker 22 and formed as the 3-D analog or an approximation of the base units 22P, 22E, 22M thereof. More particularly and contrary to that of FIG. 6G which is arranged to be convex to the speaker, the counter unit 40 of FIG. 6H consists of multiple concentric rings of wire interconnected with multiple radial arcuate wires in a planar configuration. Similar to that of FIG. 6G, such a counter unit 40 may also operate on the source or wave matching. The counter unit 40 is disposed above the speaker 22 in the front arrangement so that the counter unit 40 emits the counter waves of amplitudes less than those of the harmful waves. The counter unit 40 is aligned with a longitudinal axis of the speaker 22 and emits the counter waves aligned with the harmful waves and also defining the phase angles opposite to those of the harmful waves, thereby matching and countering the harmful waves in the target space. When desirable, the counter unit 40 may be disposed at a preset distance from the speaker 22 in which the wavefronts of such counter waves by the counter unit 40 may match those of the harmful waves by the speaker 22 as have been mentioned hereinabove in the wave matching. Therefore, the piezoelectric speaker 22 is converted to the EMC speaker of this invention by the counter unit 40. Other configurational and/or operational characteristics of the counter unit 40 of FIG. 6H may be similar or identical to those of the counter units of FIGS. 6A to 6G.

In another example of FIG. 6I, a piezo speaker 22 is identical to that of FIG. 6A, while a counter unit 40 is disposed in a preset relation to such base units 22P, 22E, 22M of the speaker 22 and formed as the 3-D analog or an approximation of the base units 22P, 22E, 22M thereof. More particularly, the counter unit 40 of FIG. 6H forms a spiral of a single or multiple wires formed in a planar configuration. Similar to that of FIGS. 6G and 6H, the counter unit 40 may operate on the source or wave matching. The counter unit 40 is further disposed above the speaker 22 in the front arrangement, aligned with a longitudinal axis of the speaker 22, and emits the counter waves aligned with the harmful waves and defining the phase angles opposite to those of the harmful waves, thereby matching and countering such harmful waves in the target space. When desirable, the counter unit 40 is disposed at a preset distance from the speaker 22 in which the wavefronts of such counter waves by the counter unit 40 match those of the harmful waves by the speaker 22 as have been mentioned in the wave matching. Therefore, the piezoelectric speaker 22 is converted into the EMC speaker of the present invention by the counter unit 40. Other configurational and/or operational characteristics of the counter unit 40 of FIG. 6I may be similar or identical to those of the counter units of FIGS. 6A to 6H.

The above counter units of FIGS. 6G to 6I may also be modified into other configurations, may be incorporated into other dispositions, and/or may counter such harmful waves in other mechanisms. For example, the counter unit may be provided as a solid convex sheet of other shapes without any openings, a porous sheet of other shapes, and the like, in which the counter unit may include different number of rings or arcs and define the openings of different shapes. In another example, the counter unit may consists of multiple sections each of which may be supplied with the electric energy defining different amplitudes and/or directions for better approximating the base units. Such sections may also be formed concentrically such that different voltages may be applied along a radial direction or, in the alternative, may be formed angularly so that different voltages may be applied in an angular direction. In another example, multiple similarly or differently shaped counter units may be disposed in various arrangements for such local or global countering.

In other examples of FIGS. 6J to 6L, the piezo speakers are identical to that of FIG. 6A, and the counter units 40 are identical to those of FIGS. 6A to 6C, respectively. However, the counter units 40 of these figures are also disposed above the piezo speakers 22 in the front arrangements so that the counter units 40 emit the counter waves defining the amplitudes less than those of the harmful waves due to a shorter distance to the target space than various base units 22E, 22P, 22M of such speakers 22. Further configurational and/or operational characteristics of the counter units 40 of FIGS. 6J to 6L are similar or identical to those of the counter units of FIGS. 6A to 6I.

The above counter units exemplified in FIGS. 6A to 6L as well as those described hereinabove may be disposed in any of the above arrangements and may counter the harmful waves by any of the foregoing mechanisms. Accordingly, the counter unit which may be shaped similar or identical to one or more of the base units of various speakers may be disposed lateral or side by side to one or more base units, may be axially, radially, and/or angularly aligned with one or more base units, may enclose therein one or more base units, may be enclosed by one or more base units, may wind around one or more base units, may be wound by one or more base units, and so on, when such a counter unit is to operate based on the source matching. Alternatively, the counter unit which may be shaped similar to or different from one or more of the base units may be disposed along one or more wavefronts of the harmful waves irradiated by one or more base units for the wave matching. In addition, such counter units may be employed in a proper number and/or arrangement to counter such harmful waves based on the local countering or global countering.

In another exemplary embodiment of this aspect of the invention, the counter units may also be incorporated into various microphones which are inverse examples of such speakers and which also have various base units which are similar to those of the speakers, where examples of the base units may include, but not be limited to, electromagnets, permanent magnets, any parts of such microphones through which the unsteady current flows, and any of such parts across which the unsteady voltage is applied. Therefore, any prior art devices which include such EMC microphones such as standalone microphones, wired phones, mobile phones, audio devices, audiovisual devices, and assemblies of an earphone and microphone may be converted into various EMC systems such as, e.g., EMC standalone microphones, EMC wired or mobile phones, EMC audio systems, EMC audiovisual systems, and such EMC assemblies, where various counter units of any of the above configurations may be incorporated thereinto in any of the above dispositions and/or arrangements and may counter the harmful waves in any of the above mechanisms.

In another aspect of the present invention, any of the above EMC systems may include at least one electric shield and/or magnetic shield. In one example, the electric and/or magnetic shields (will be referred to as the “ES” and “MS” hereinafter, respectively) may be implemented into, on, over or below various portions of the EMC system. In another example, such ES and/or MS may also be implemented as above and also used in conjunction with any of the above counter units. In general, the ES may be made of and/or include at least one electrically conductive material such that the electric waves of the harmful waves may be absorbed thereinto and rerouted therealong. When desirable, the ES may also be grounded so that the absorbed and rerouted electric waves may be eliminated therefrom. The MS may be made of and/or include at least one magnetically permeable path member which may be able to absorb the magnetic waves of the harmful waves thereinto and then to reroute such magnetic waves therealong. When desirable, the MS may have a magnet member which may be magnetically coupled to the path member and terminate the absorbed and rerouted magnetic waves in at least one magnetic pole of the magnet member. The MS may include at least one optional shunt member which may also be magnetically permeable and shield its magnet member, thereby confining magnetic fields from such a magnet member closer thereto.

As described above, the EMC systems of this invention may be provided with multiple defense mechanisms against the harmful waves which are irradiated by various base units of such a system. In one example, the counter unit may be incorporated into various portions of such an EMC system as described above. Accordingly, a single or multiple counter units may be provided in any of the above configurations and incorporated in any of the above dispositions. In another example, such ES and/or MS may be incorporated into various portions of the EMC system and shield against the electric and/or magnetic waves of such harmful waves, respectively, where dispositions of the ES and/or MS have been described above. In another example, not only the counter units but also at least one of the ES and/or MS may be implemented into the EMC system so that the counter unit may counter at least a portion of such harmful waves and that the ES and/or MS may absorb and reroute the rest thereof.

The ES and/or MS may be provided to define the configuration which is identical to or similar to those of various counter units of this invention. The ES and/or MS may also be disposed in, on, over, around, and/or through the base and/or counter units. The ES and/or MS may have the configuration at least partially conforming to that of such base and/or counter units or, in the alternative, may define the configuration at least partially different from those of the ES and/or MS.

The path member of the MS may define the relative magnetic permeability greater than 1,000 or 10,000, 100,000 or 1,000,000. The shunt member may be arranged to directly or indirectly contact the magnet member and to define a relative magnetic permeability greater than 1,000, 10,000, 100,000 or 1,000,000. The ES and/or MS described hereinabove may further be incorporated into any of the prior art devices with or without any of the above counter units and define such EMC systems of this invention. The ES and/or MS may define the configuration which may be maintained to be uniform along the longitudinal or short axis of the base and/or counter units or which may vary therealong. Such configurations of the ES and/or MS may be identical to, similar to or different from those of the base and/or counters. The EMC system may include multiple ES and/or MS, where at least two of the MS and/or ES may shield against the magnetic waves and/or electric waves of the same or different frequencies in same or different extents. The ES and/or MS may be disposed over at least a portion (or entire portion) of the base and/or counter units. The EMC system may also include therein one or more of any of the above counter units as well as the ES and/or MS, where the base and/or counter units may operate on AC or DC.

Whether alone or in combination with the ES and/or MS, the EMC system of this invention may include multiple counter units which may be arranged in layers with respect to various base units of the piezo speaker. For example, similar, identical or different counter units may be disposed above or below at least one of the base units, between such base units, and the like. In another example, at least one counter unit may be disposed over at least one of such base units, while at least another of the base units may be disposed below such a base unit, where such base units may also be similar or different from each other. When the counter units are disposed in layers, each of the counter units may also be configured and/or disposed as described hereinabove.

It is appreciated that any of the above counter units are provided while using the least amount of such electrically conductive, semiconductive, and/or insulative materials, while minimizing a volume, a size, and/or a mass of such counter units. Accordingly, such counter units may be fabricated with less materials at lower costs and may be easily implemented into various locations of the EMC system. It is also appreciated that any of the above counter units are provided to emit the counter waves while using the least amount of electrical energy, e.g., by drawing the least amount of the electric current or voltage. Therefore, such counter units are not only energy-efficient but also least affecting operation of other parts of the EMC systems and their intended functions. In addition, these requirements of this paragraph may minimize electric resistances of the counter units and, therefore, minimize voltage drop across the counter units.

Unless otherwise specified, various features of one embodiment of one aspect of the present invention may apply interchangeably to other embodiments of the same aspect of this invention and/or embodiments of one or more of other aspects of this invention. Therefore, any of the counter units of FIGS. 2A to 2L may be incorporated into various EMC speaker systems of FIGS. 5A to 5F, into various counter units of FIGS. 6A to 6L, and other EMC systems disclosed herein without any accompanying figures. In addition, any of the counter units which operate on the source matching may be converted to operate on the wave matching or vice versa, where the source-matched counter units may then be disposed along one or more wavefronts of the harmful waves from the base unit or where the wave-matched counter units may be disposed in the preset relation to the base unit or may be incorporated in the arrangement similar to that of the base unit.

Various EMC systems of the present invention may operate on the AC power while countering the harmful EM waves with their counter units. When desirable, such EMC systems may also operate on the DC power while similarly countering the harmful waves. It is to be understood that the systems may also use any conventional modalities capable of shielding and/or canceling such harmful waves. Accordingly, it is preferable that any extra wires, strips, plates, sheets, and other parts of such EMC systems may be braided, bundled, concentrically fabricated or otherwise treated in order to minimize irradiation of the harmful waves.

It is to be understood that, while various aspects and/or embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims as well.

What is claimed is:

1. A speaker system capable of countering harmful electromagnetic waves which are irradiated by a plurality of base units of at least one wave source through at least one of canceling said harmful waves in a target space and suppressing said harmful waves from propagating to said target space, wherein said base units are configured to refer to only portions of said wave source responsible for irradiating said harmful waves and affecting paths of said harmful waves therethrough, wherein said target space is defined between said system and at least one body part of an user, and wherein said harmful waves have frequencies less than about 1 kHz comprising:
at least one piezoelectric plate which is configured to convert electric energy supplied thereto to mechanical vibration thereof and to generate audible sounds while emitting said harmful waves and serving as one of said base units;
at least two electrodes which are configured to be electrically coupled to at least two different portions of said piezoelectric plate and to provide said electric energy across said piezoelectric plate while emitting said harmful waves and serving as another of said base units;
at least one metal plate which is configured to be coupled to one of said electrodes, to receive said energy, and then to supply said energy to said one of said electrodes while emitting said harmful waves and serving as yet another of said base units; and
at least one counter unit which is configured to define a configuration at least partially similar to a configuration of at least one of said base units and to emit counter electromagnetic waves which are in turn configured to have phase angles at least partially opposite to those of said harmful waves, to define wave characteristics at least partially similar to those of said harmful waves primarily due to said configurations and, accordingly, to counter said harmful waves in said target space primarily due to said phase angles.

2. The system of claim 1, wherein said counter unit defines a shape which is configured to be at least substantially similar to at least two of said base units.

3. The system of claim 1, wherein said counter unit defines a shape which is configured to be at least substantially similar to an assembly of said piezoelectric plate, electrodes, and metal plate.

4. The system of claim 3, wherein said counter unit is configured to define a simplified analog of at least one of said base units.

5. The system of claim 3, wherein said counter unit is configured to define a simplified analog of an assembly of said piezoelectric plate, electrodes, and metal plate.

6. The system of claim 5, wherein said counter unit is configured to approximate said assembly into one of a spherical wave source, an elongated wave source, and a plate-shaped wave source, and then to define its shape accordingly.

7. The system of claim 1 further comprising a plurality of said counter units at least two of which are configured to be incorporated in an arrangement at least substantially similar to an arrangement of an assembly of said piezoelectric plate, electrodes, and metal plate.

8. The system of claim 1, wherein said counter unit is configured to be incorporated between at least one of said base units and target space and then to emit said counter waves of amplitudes less than amplitudes of said harmful waves for countering said harmful waves in said target space.

9. The system of claim 8, wherein said configuration of said counter unit has a dimension which is configured to be longer than a dimension of each of said base units and to match radii of curvature of said counter waves with those of said harmful waves in said target space.

10. The system of claim 1, wherein said counter unit is configured to be disposed on an opposite side of said target space with respect to at least one of said base units and then to emit said counter waves of amplitudes greater than amplitudes of said harmful waves in order to counter said harmful waves in said target space.

11. The system of claim 10, wherein said configuration of said counter unit has a dimension which is configured to be shorter than a dimension of each of said base units and to match radii of curvature of said counter waves with those of said harmful waves in said target space.

12. The system of claim 1 further comprising at least one case member which includes an exterior surface and an interior surface and which is configured to define an exterior of said system, wherein said counter unit is configured to be one of coupled to said exterior surface, coupled to said interior surface, and embedded between said interior and exterior surfaces.

13. The system of claim 1 which is configured to be incorporated into one of a wired telephone, a wireless phone, an earphone, a headphone, and an assembly of said speaker and a microphone.

14. A speaker system capable of countering harmful electromagnetic waves which are irradiated by a plurality of base units of at least one wave source through at least one of canceling said harmful waves in a target space and suppressing said harmful waves from propagating to said target space, wherein said base units are configured to refer to only portions of said wave source responsible for irradiating said harmful waves and affecting paths of said harmful waves therethrough, wherein said target space is defined between said system and at least one body part of an user, and wherein said harmful waves have frequencies less than about 1 kHz comprising:
at least one piezoelectric plate which is configured to convert electric energy supplied thereto to mechanical vibration thereof and to generate audible sounds while emitting said harmful waves and serving as one of said base units;
at least two electrodes which are configured to be electrically coupled to at least two different portions of said piezoelectric plate and to provide said electric energy across said piezoelectric plate while emitting said harmful waves and serving as another of said base units;
at least one metal plate which is configured to be coupled to one of said electrodes, to receive said energy, and then to supply said energy to said one of said electrodes while emitting said harmful waves and serving as yet another of said base units; and
at least one counter unit which is configured to have a shape different from a shape of each of said base units, to emit counter electromagnetic waves, and to be also disposed in an arrangement rendering said counter waves define phase angles at least partially opposite to those of said harmful waves, have wave characteristics at least partially similar to those of said harmful waves due to said arrangement and, accordingly, counter said harmful waves in said target space primarily due to said phase angles.

15. A speaker system for irradiating harmful electromagnetic waves by a plurality of base units of at least one wave source of said system and for countering said harmful waves by emitting counter electromagnetic waves, wherein said counter waves propagate by defining a plurality of wavefronts, wherein said harmful waves propagate while defining another plurality of wavefronts, wherein said system also counters said harmful waves by at least one of canceling said harmful waves in a target space and suppressing said harmful waves from propagating toward said target space, wherein said base units are configured to include only portions of said wave source responsible for irradiating said harmful waves and also affecting paths of said harmful waves therethrough, and wherein said target space is defined between said system and at least one body part of an user thereof comprising:
at least one piezoelectric plate which is configured to convert electric energy supplied thereto to mechanical vibration thereof and to generate audible sounds while emitting said harmful waves and serving as one of said base units;
at least two electrodes which are configured to be electrically coupled to at least two different portions of said piezoelectric plate and to provide said electric energy across said piezoelectric plate while emitting said harmful waves and serving as another of said base units;
at least one metal plate which is configured to be coupled to one of said electrodes, to receive said energy, and then to supply said energy to said one of said electrodes while emitting said harmful waves and serving as yet another of said base units; and
at least one counter unit which is configured to define a preset configuration, to be disposed in a preset arrangement defining a preset relation with respect to at least one of said wavefronts of said harmful waves, and to emit said counter waves which are configured to define phase angles which are at least partially opposite to those of said harmful waves, to at least partially match at least one of said wavefronts of said harmful waves with at least one of said wavefronts thereof primarily due to said arrangement, and to counter said harmful waves in said target space primarily due to said phase angles in said target space.

16. The system of claim 15, wherein said counter unit is configured to be incorporated between at least one of said base units and target space and to be disposed in said arrangement which is at least partially similar to a shape of at least one of said wavefronts of said harmful waves, thereby matching and countering said harmful waves by said counter waves in said target space.

17. The system of claim 15, wherein said counter unit is configured to be disposed on an opposite side of said target space with respect to at least one of said base units and to be incorporated in said arrangement which is at least partially inverse to a shape of at least one of said wavefronts of said harmful waves, thereby matching and countering said harmful waves by said counter waves in said target space.

18. The system of claim 15, wherein said counter unit is configured to manipulate said wavefronts of said counter waves to define shapes at least partially similar to a shape of said counter unit and to be aligned with at least a portion of at least one of said wavefronts of said harmful waves, thereby matching and countering said harmful waves by said counter waves.

19. The system of claim 18, wherein said counter unit is configured to form at least one of a mesh, a spiral, a coil, an array of a wire, an array of a plurality of wires, an array of a plurality of strips, an array of a plurality of spirals, and an array of a plurality of coils, and then to define a contour which is configured to at least partially conform to a contour of at least one of said wavefronts of said harmful waves.

20. The system of claim 19 further comprising at least one case member which forms an exterior surface and an interior surface and which is configured to define an exterior of said system, wherein said counter unit is configured to be one of coupled to said exterior surface, coupling with said interior surface, and embedded between said interior and exterior surfaces.
